(19) United States
(12) Patent Application Publication
(10) Pub. No.: US 2023/0102379 A1
(43) Pub. Date: Mar. 30, 2023

(54) CITRUS HUANGLONGBING THERAPEUTIC COMPOUNDS

(71) Applicants: M. Caroline ROPER, Riverside, CA (US); Philippe ROLSHAUSEN, Riverside, CA (US); Jonathan LOCKNER, San Diego, CA (US); Katherine MALONEY, San Diego, CA (US); THE REGENTS OF THE UNIVERSITY OF CALIFORNIA, Califomia, CA (US); POINT LOMA NAZARENE UNIVERSITY, San Diego, CA (US)

(72) Inventors: M. Caroline ROPER, Riverside, CA (US); Philippe ROLSHAUSEN, Riverside, CA (US); Jonathan LOCKNER, San Diego, CA (US); Katherine MALONEY, San Diego, CA (US)

(21) Appl. No.: 17/794,527

(22) PCT Filed: Jan. 22, 2021
(86) PCT No.: PCT/US2021/014705

§ 371 Date: Jul. 21, 2022

Related U.S. Application Data
(60) Provisional application No. 62/965,625, filed on Jan. 24, 2020.

(51) Int. Cl. A01N 43/90; A01N 43/36; A01N 43/20; A01N 35/06; A01P 1/00

(52) U.S. Cl. CPC A01N 43/90; A01N 43/36; A01N 43/20; A01N 35/06; A01P 1/00

(57) ABSTRACT

Certain embodiments of the invention provide a method of inhibiting Candidatus Liberibacter asiaticus (CLas) growth and/or treating a CLas infection (e.g., Huanglongbing) in a plant, comprising introducing to the plant at least one compound selected from the group consisting of: a cladosporol compound, a radicinin compound (e.g., a compound of formula (I)), and an epicoccamide compound, or a salt thereof. This present invention also provides methods of screening or identifying CLas inhibitory compounds.

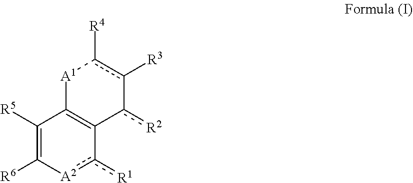

### RELATED APPLICATION

This application claims the benefit of priority of U.S. Provisional Application Ser. No. 62/965,625 filed on Jan. 24, 2020, which application is incorporated by reference herein.

### GOVERNMENT FUNDING

This invention was made with government support under 2017-70016-2605, 1002710, 1018010, 233883 and 233744 awarded by the National Institute of Food and Agriculture, USDA and under DGE-1326120 awarded by the National Science Foundation. The government has certain rights in the invention.

### BACKGROUND OF THE INVENTION

Citrus Huanglongbing (HLB), is a serious disease of citrus and is the major threat to citriculture worldwide. In the United States, HLB is associated with a gram-negative, phloem-limited, alphaproteobacteria: Candidatus Liberibacter asiaticus (CLas) and several different strains of CLas have been reported in association with citrus (Chen et al., 2010. Phytopathology 100:567-572; Kunta et al. 2017. Genome Announc 5(15):e00170-17; Zheng et al. 2017. Phytopathology 107:662-668). This bacterium is vectored by insect psyllid vectors and the primary psyllid in the United States of America (USA) is the Asian Citrus Psyllid (ACP), Diaphorina citri. Both the vector and the bacterium are invasive species to the USA. Symptoms of the disease include leaf chlorosis, limb dieback, root loss, and phloem plugging (Bové J M. 2006. J Plant Pathol 88:7-37; da Graga et al., 2016. J Integr Plant Biol 58:373-387). Diseased trees produce small, bitter, hard, green and misshapen fruit. These fruits are unmarketable for juicing because the disease results in acidic, salty and off-flavor juice. In addition to unpalatable flavor, fruit borne of trees with severe HLB symptoms, exhibit severe morphological distortions and seed discoloration rendering them unsuitable for fresh market sale (Bassanezi et al., 2009.

European Journal of Plant Pathology, 125:565-572; Dagulo et al., 2010. Journal of Food Science, 75(2):C199-207). Infected trees decline rapidly and die within 3-5 years of becoming infected and HLB can spread throughout an orchard in under seven years (Narouei-Khandan et al., 2016. Eur J Plant Pathol 144:655-670). All cultivated citrus varieties are susceptible to HLB (Folimonova et al., 2009. Phytopathology 99:1346-1354; Gottwald et al., 2012. Crop Prot 36:73-82). Current management of HLB relies heavily on vector control through the use of insecticides (Blaustein et al., 2018. Phytopathology 108:424-435; Editorial, 2019. Nature 567:283). However, there are currently no sustainable control measures for Huanglongbing that target the associated pathogenic bacterium itself (Candidatus Liberibacter asiaticus).

Thus, there is a need for new therapies for the treatment of HLB in citrus.

### SUMMARY OF THE INVENTION

Certain embodiments of the invention provide a method of inhibiting Candidatus Liberibacter asiaticus (CLas) growth, treating a CLas infection and/or treating Huanglongbing (HLB) in a plant, comprising introducing to the plant at least one compound selected from the group consisting of: a compound of formula I,

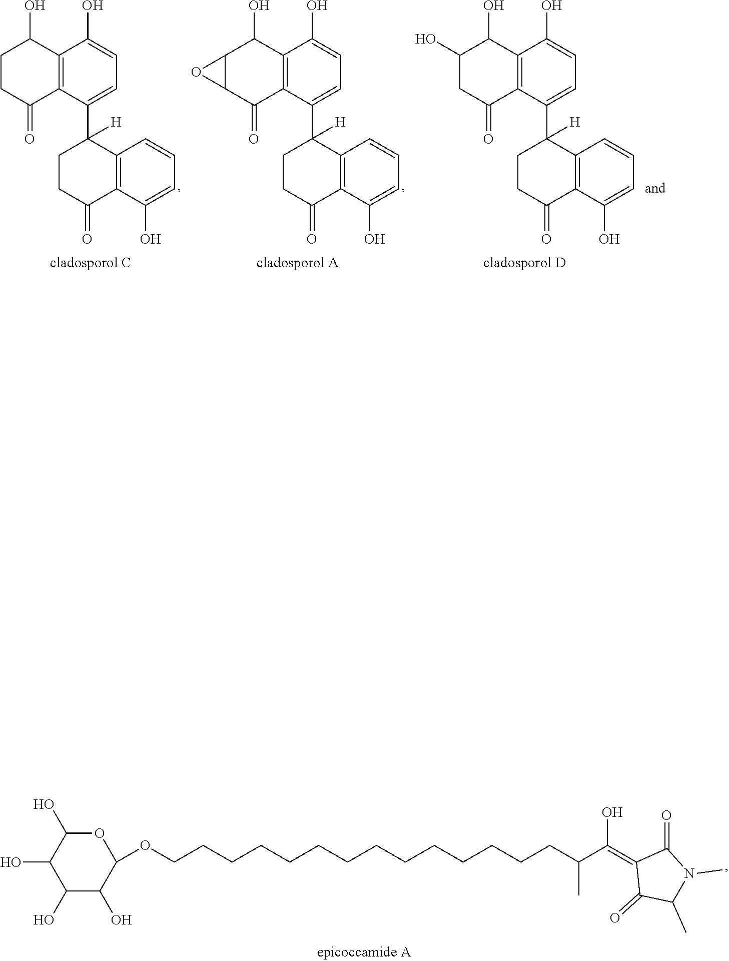 [SMILES: O=C1CCC(c2ccc(O)c3c2C(=O)CCC3O)c2cccc(O)c21 ; O=C1CCC(c2ccc(O)c3c2C(=O)C2OC2C3O)c2cccc(O)c21 ; O=C1CCC(c2ccc(O)c3c2C(=O)CC(O)C3O)c2cccc(O)c21 ; CC(CCCCCCCCCCCCCCOC1OC(O)C(O)C(O)C1O)/C(O)=C1\C(=O)C(C)N(C)C1=O]

or a salt thereof,

wherein the compound of formula I is:

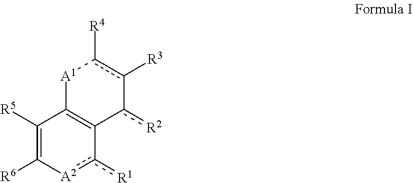

wherein,

A¹ is O, S, NH, OH, SH or NH₂;

A² is CH, O, S, or NH;

R¹ and R² are each individually selected from the group consisting of halo, CN, O, OH, NH, NH₂, S, SH, and CH₂,

R₃-R⁵ are each individually selected from the group consisting of H, halo, hydroxyl, cyano, thiol, amino, aryl, (C₁-C₆)alkyl, and (C₁-C₆)alkenyl, wherein each hydroxyl, thiol, amino, aryl, alky and alkenyl are optionally and independently substituted; and

R⁶ is selected from the group consisting of H, hydroxyl, (C₁-Cₜ)alkyl, (C₂-C₆)alkenyl and heterocycle, wherein each hydroxyl, alkyl, alkenyl and heterocycle are optionally substituted.

Certain embodiments of the invention provide a method of inhibiting Candidatus Liberibacter asiaticus (CLas) growth, treating a CLas infection, and/or treating Huanglongbing (HLB) in a plant, comprising introducing to the plant at least one microbial isolate(s) selected from the group consisting of Cladosporium cladosporioides, Epicoccum nigrum, Pantoea agglomerans, Pantoea vagans, Bacillus sp., Curtobacterium sp., Alternaria radicina and Cochliobolus sp., or an extract thereof.

Certain embodiments of the invention provide a kit comprising:

1) at least one compound selected from the group consisting of: a compound of formula

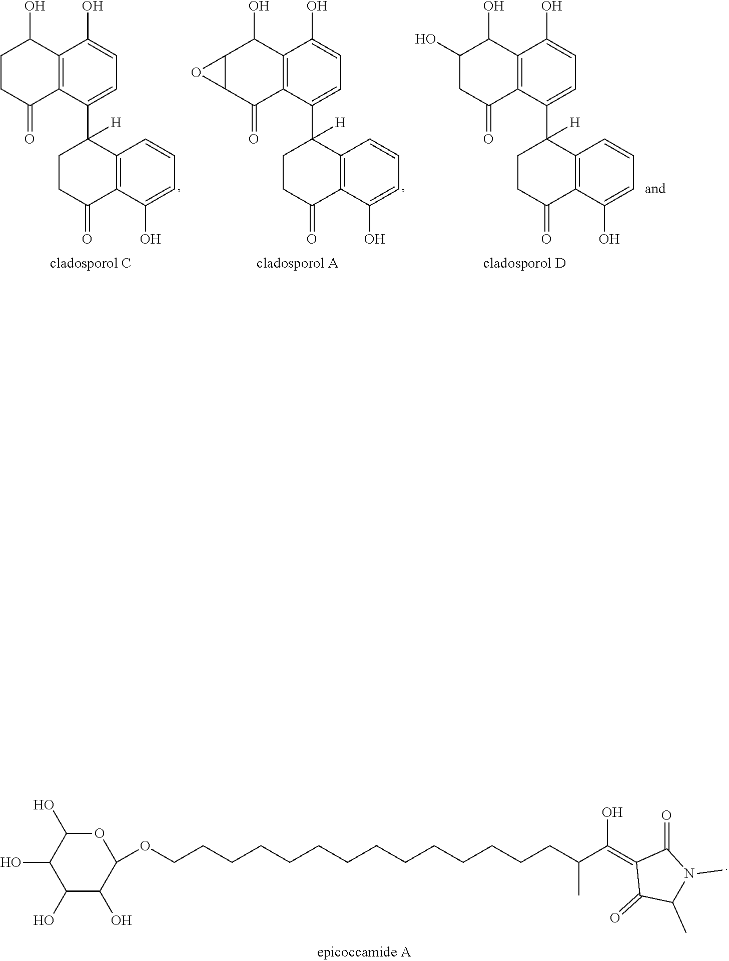 [SMILES: O=C1CCC(c2ccc(O)c3c2C(=O)CCC3O)c2cccc(O)c21 ; O=C1CCC(c2ccc(O)c3c2C(=O)C2OC2C3O)c2cccc(O)c21 ; O=C1CCC(c2ccc(O)c3c2C(=O)CC(O)C3O)c2cccc(O)c21 ; CC(CCCCCCCCCCCCCCOC1OC(O)C(O)C(O)C1O)/C(O)=C1\C(=O)C(C)N(C)C1=O]

or a salt thereof;

wherein the compound of formula I is:

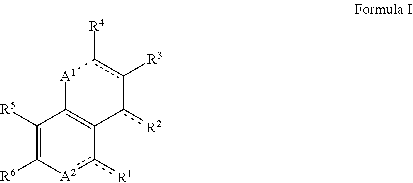

wherein

A² is O, S, NH, OH, SH or NH₂;

A² is CH, OS, or NH;

R¹ and R² are each individually selected from the group consisting of halo, CN, O, OH, NH, NH₂, S, SH, and CH₂;

R³-R⁵ are each individually selected from the group consisting of H, halo, hydroxyl, cyano, thiol, amino, aryl, (C₁-C₆)alkyl, and (C₂-C₆)alkenyl, wherein each hydroxyl, thiol, amino, aryl, alkyl and alkenyl are optionally and independently, substituted; and

R⁶ is selected from the group consisting of H, hydroxyl, (C₁-C₆)alkyl, (C₂-C₆)alkenyl and heterocycle, wherein each hydroxyl, alkyl, alkenyl and heterocycle are optionally substituted;

2) packaging material; and

3) instructions to introduce to a plant the compound to treat a Candidatus Liberibacter asiaticus (CLas) infection in the plant and/or to treat Huanglongbing (HLB) in the plant.

Certain embodiments of the invention provide a kit comprising:

1) a microbial isolate, or an extract thereof, wherein the microbial isolate comprises Cladosporium cladosporioides, Epicoccum nigrum, Pantoea agglomerans, Pantoea vagans, Bacillus sp., Curtobacterium sp., Alternaria radicina and/or Cochliobolus sp, or an extract thereof;

2) packaging material; and

3) instructions to introduce to a plant the microbial isolate/extract to treat a Candidatus Liberibacter asiaticus (CLas) infection in the plant and/or to treat Huanglongbing (HLB) in the plant.

Certain embodiments of the invention provide a method of identifying an agent that inhibits Candidatus Liberibacter asiaticus (CLas), comprising:
1) culturing Liberibacter crescens bacteria;
2) contacting the cultured Liberibacter crescens bacteria with a test agent to provide a test culture sample, wherein the test agent is derived from a plant microbiome;
3) measuring the amount of Liberibacter crescens growth in the test culture sample;
4) identifying the test agent as inhibitory when the amount of Liberibacter crescens growth is less than the growth of a corresponding control Liberibacter crescens culture sample that was not contacted with the test agent.

Certain embodiments of the invention provide a method of preparing compound 16, comprising: converting 2,2,6-trimethyl-4H-1,3-dioxin-4-one (compound 7) to 2,2-dimethyl-6-[(3E)-2-oxopent-3-en-1-yl]-2,4-dihydro-1,3-dioxin-4-one (compound 16) in a one-step reaction.

Certain embodiments of the invention provide a method of treating HLB or inhibiting Candidatus Liberibacter asiaticus (CLas) growth in a plant, comprising introducing to the plant at least one compound, microbial isolate, or microbial isolate preparation (e.g., fungal or bacterial extract) described herein.

Certain embodiments of the invention provide a compound described herein (e.g., a compound of formula I such as radicinin, radicinin analogs, and compound 4), as well as compositions thereof. The invention also provides processes and intermediates disclosed herein that are useful for preparing a compound as described herein.

Certain embodiments provide a composition as described herein. In certain embodiments, the composition further comprises at least one additional therapeutic agent.

### BRIEF DESCRIPTION OF THE FIGURES

FIG. 1. High throughput bulk culturing pipeline for construction of the citrus cultured microbiome repository. Fungi and bacteria were cultured from citrus leaves, stems and roots onto TSA and PDA medium at 28° C. for 4 days. Bulk cultures were harvested from the plates and archived as a mixture in 25% glycerol and stored at −80° C. in cryovials. Aliquots of the archived microbial mixtures were assessed via ITS sequencing to determine the diversity captured through culturing. Microbial diversity was also assessed using culture-independent methods from the same citrus tissues that were used for the culture-dependent analyses. Individual isolates were obtained via subculturing from the mixed cultures and were stored as part of the citrus microbiome repository and screened in the bioassay against L. crescens BT-1.

FIG. 2. Microbial diversity across the total and culturable fraction of the bacteriome and mycobiome of citrus leaves. Sunburst plots illustrating microbial communities across citrus tissues and their cultured microbiome counterparts. Each radial layer corresponds to taxonomic levels, starting with Kingdom and ending with Species. Shading denotes different taxa per layer, with the five most abundant Orders and ten most abundant Genera labeled on each plot. The five most abundant orders are abbreviated. E, Enterobacteriales; St, Streptomycetales; C, Cytophagales; Ba, Bacillales; R, Rhizobiales; P, Pseudomonadales. Cy, Cystobasidiomycetes incertae sedis; S, Sporidiobolales; Ca, Capnodiales; Pl, Pleosporales; Ch, Chaetothyriales; T, Tremellales; G, Glomerellales; H, Hypocreales.

FIG. 3. Microbial diversity across the total and culturable fraction of the bacteriome and mycobiome of citrus stems. Sunburst plots illustrating microbial communities across citrus tissues and their cultured microbiome counterparts. Each radial layer corresponds to taxonomic levels, starting with Kingdom and ending with Species. Shading denotes different taxa per layer, with the five most abundant Orders and ten most abundant Genera labeled on each plot. The five most abundant orders are abbreviated. R, Rhizobiales; E, Enterobacterales; M, Micrococcales; C, Cytophagales; Ba, Bacillales; P, Pseudomonadales. Cy, Cystobasidiomycetes incertae sedis; S, Sporidiobolales; Ca, Capnodiales; Pl, Pleosporales; Ch, Chaetothyriales; T, Tremellales; B; Botryosphaeriales; G, Glomerellales; H, Hypocreales.

FIG. 4. Microbial diversity across the total and culturable fraction of the bacteriome and mycobiome of citrus roots. Sunburst plots illustrating microbial communities across citrus tissues and their cultured microbiome counterparts. Each radial layer corresponds to taxonomic levels, starting with Kingdom and ending with Species. Shading denotes different taxa per layer, with the five most abundant Orders and ten most abundant Genera labeled on each plot. The five most abundant orders are abbreviated. R, Rhizobiales; E, Enterobacterales; M, Micrococcales; C, Cytophagales; Ba, Bacillales; P, Pseudomonadales. Cy, Cystobasidiomycetes incertae sedis; S, Sporidiobolales; Ca, Capnodiales; Pl, Pleosporales; Ch, Chaetothyriales; T, Tremellales; B; Botryosphaeriales; G, Glomerellales; H, Hypocreales.

FIGS. 5A-5B. Passage through culture media produces diversity shifts in citrus-associated microbiota. Violin plots illustrating Shannon's alpha diversity index scores of the (FIG. 5A) citrus bacteriome and its cultured counterparts, per tissue and (FIG. 5B) citrus mycobiome and its cultured counterparts, per tissue. Arrows point to medians of each sample group. The cultured portion of the bacteriome represents 3.65% of the culture-independent taxa in the leaves, 5.32% of the culture-independent taxa in the stems and 7.05% of the culture-independent taxa in the roots. The cultured mycobiome represents 16.52% of the culture-independent taxa in the leaves, 19.23% of the culture-independent taxa in the stems and 8.26% of the culture-independent taxa in the roots. p-values indicate significance of difference in alpha diversity between culture independent and culture dependent samples per tissue, obtained via Kruskal Wallis with post hoc Dunn test, using Bonferroni correction. Percent values indicate the proportion of culture-independent OTUs found in cultured microbiome samples.

FIGS. 6A-6C. Liberibacter crescens agar-diffusion inhibition assay. Images of assay plates from the in vitro diffusion assay, showing: (FIG. 6A) Uninhibited L. crescens BT-1 growth on a negative control plate, (FIG. 6B) Halo of L. crescens BT-1 growth inhibition around a disc containing supernatant from Pantoea sp. isolate CB0072, (FIG. 6C) Halo of L. crescens BT-1 growth inhibition around a disc containing supernatant from E. nigrum. 50 μl of MeOH was applied and evaporated off of the disc prior to placing on the top agar.

FIG. 7. Structures of cladosporols A (21), C (22) and D (23) and epicoccamide A (24).

FIG. 8. Compounds 1-9 selected for bioassay against X fastidiosa and L. crescens (a culturable surrogate for CLas).

FIGS. 9A-9B. Heat map showing inhibition of X fastidiosa (FIG. 9A) and L. crescens (FIG. 9B) by compounds 1-9. In some cases, a compound showed little-to-no activity at a high dose, and was not tested at lower doses, as indicated with --.

FIGS. 10A-10B. Dose-dependent inhibitory activity of 1-5 against X. fastidiosa (FIG. 10A) and L. crescens (FIG. 10B). Potencies of 1 and 2 are comparable.

### DETAILED DESCRIPTION

Globally, citrus is threatened by Huanglongbing and the lack of effective control measures is a major concern of the industry. There is compelling evidence that plant health is a function of the activities of its associated microbiome. As described in the Examples, Liberibacter crescens, a culturable surrogate for the unculturable HLB-associated bacterium, Candidatus Liberibacter asiaticus (CLas), was used to test the hypothesis that members of the citrus microbiome produce potential anti-CLas natural product metabolites. A sub-set of isolates obtained from the microbiome inhibited L. crescens growth in an agar-diffusion inhibition assay developed as part of this study. The inhibitory activities of two fungi, Cladosporium cladosporioides and Epicoccum nigrum were further resolved into fractions enriched in antimicrobial cladosporols A, C and D (from C. cladosporioides) and epicoccamide A (from E. nigrum). Radicinin (e.g., from Alternaria radicina or Cochliobolus sp) and radicinin analogs (e.g., deoxyradicinin, and dihydrodeoxyradicinin, etc) were also found to inhibit L. crescens growth. Thus, the methods described herein may be used to treat HLB or to identify anti-CLas compounds, compositions thereof, and sustainable bioinoculants in citrus.

### CLas Inhibitory Compounds and Methods of Use Thereof

Described herein are certain compounds and compositions that inhibit CLas growth, treat CLas infections, such as Huanglongbing (HLB). For example, Cladosporium cladosporioides, Epicoccum nigrum, Pantoea agglomerans, Pantoea vagans, Bacillus sp., Curtobacterium sp., Alternaria radicina and/or Cochliobolus sp may be used to inhibit CLas growth and/or treat a CLas infection. In certain embodiments, these organisms may be present in a composition, such as a bioinoculant composition. In certain embodiments, one or more of the microbial isolates are inactivated or present in an inactivated form or culture (e.g., a composition comprising an inactivated culture, such as heat-killed whole culture broth). Additionally, extracts from these organisms or compounds derived from these organisms (e.g., radicinin compounds, epcioccamide or cladosporol compounds, such as compounds of formula I as described herein, epicoccamide A, cladosporol A, cladosporol C or cladosporol D) may be used to inhibit CLas growth and/or treat CLas infections. In certain embodiments, the CLas inhibitory agent is provided as a total synthesis product.

In certain embodiments, the radicinin compound(s), epcioccamide or cladosporol compound(s) is derived from a microbial isolate(s) (e.g., a grapevine or a citrus microbiome microbial isolate). In certain embodiments, the invention provides a method of introducing to a plant microbial isolate(s) comprising the radicinin compound(s), epcioccamide or cladosporol compound(s).

In certain embodiments, the microbial isolate(s) is selected from a group consisting of Cladosporium cladosporioides, Epicoccum nigrum, Pantoea agglomerans, Pantoea vagans, Bacillus sp., Curtobacterium sp., Alternaria radicina and Cochliobolus sp.

In certain embodiments, the microbial isolate(s) producing or comprising epcioccamide or cladosporol compound(s) is selected from a group consisting of Cladosporium cladosporioides and Epicoccum nigrum.

In certain embodiments, the microbial isolate(s) producing or comprising a radicinin compound(s) is selected from a group consisting of Alternaria radicina and Cochliobolus sp.

In certain embodiments, the microbial isolate is Cladosporium cladosporioides. In certain embodiments, the microbial isolate is Epicoccum nigrum. In certain embodiments, the microbial isolate is Pantoea agglomerans. In certain embodiments, the microbial isolate is Pantoea vagans. In certain embodiments, the microbial isolate is Curtobacterium sp. In certain embodiments, the microbial isolate is Bacillus sp. In certain embodiments, the microbial isolate is Cochliobolus sp. In certain embodiments, the microbial isolate is Alternaria radicina.

Accordingly, certain embodiments of the invention provide a method of inhibiting CLas growth, treating a CLas infection or treating HLB in a plant, comprising:
1) introducing to the plant at least one compound selected from the group consisting of: a compound of formula I,

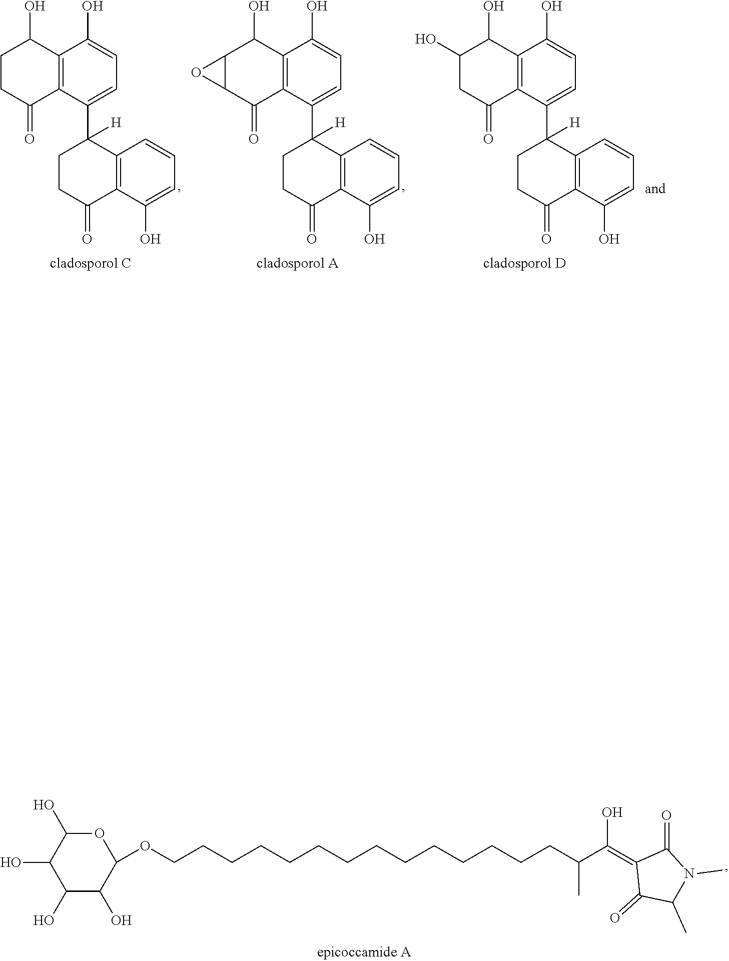 [SMILES: O=C1CCC(c2ccc(O)c3c2C(=O)CCC3O)c2cccc(O)c21 ; O=C1CCC(c2ccc(O)c3c2C(=O)C2OC2C3O)c2cccc(O)c21 ; O=C1CCC(c2ccc(O)c3c2C(=O)CC(O)C3O)c2cccc(O)c21 ; CC(CCCCCCCCCCCCCCOC1OC(O)C(O)C(O)C1O)/C(O)=C1\C(=O)C(C)N(C)C1=O]

or a salt thereof,
wherein the formula I is:

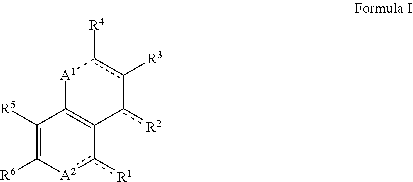

wherein,

A¹ is O, S, NH, OH, SH or NH₂;

A² is CH, O, S, or NH;

R¹ and R² are each individually selected from the group consisting of halo, CN, O, OH, NH, NH₂, S, SH, and CH₂;

R³-R⁵ are each individually selected from the group consisting of H-, halo, hydroxyl, cyano, thiol, amino, aryl, (C₁-C₆)alkyl, and (C₂-C₆)alkenyl, wherein each hydroxyl, thiol, amino aryl, alkyl and alkenyl are optionally and independently substituted; and

R⁶ is selected from the group consisting of H, hydroxyl, (C₁-C₆)alkyl, (C₂-C₆alkenyl and heterocycle, wherein each hydroxyl, alkyl, alkenyl and heterocycle are optionally substituted; and/or
2) introducing to the plant Cladosporium cladosporioides, Epicoccum nigrum, Pantoea agglomerans, Pantoea vagans, Bacillus sp., Curtobacterium sp, Alternaria radicina, and/or Cochliobolus sp., or an extract thereof.

Certain embodiments also provide a method of inhibiting CLas growth, treating a CLas infection or treating HLB in a plant comprising:
1) introducing to the plant at least one compound selected from the group consisting of epicoccamide A, cladosporol A, cladosporol C, and cladosporol D, or a salt thereof; and/or
2) introducing to the plant Cladosporium cladosporioides, and/or Epicoccum nigrum, or an extract thereof.

Certain embodiments of the invention provide a method of inhibiting CLas growth, treating a CLas infection or treating HLB in a plant comprising:
1) introducing to the plant a compound of formula I, or a salt thereof, wherein the compound of formula I is:

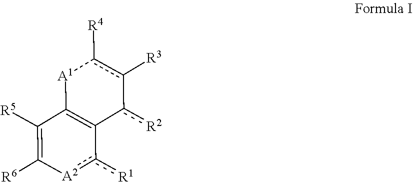

wherein.

A¹ is O, S, NH, OH, SH or NH₂;

A² is CH, O, S, or NH;

R¹ and R² are each individually selected from the group consisting of halo, CN, O, OH, NH, NH₂, S, SH, and CH₂;

R³-R⁵ are each individually selected from the group consisting of H, halo, hydroxyl, cyano, thiol, amino, anyl, (C₁-C₆)alkyl, and (C₂-C₆)alkenyl, wherein each hydroxyl, thiol, amino, aryl, alkyl and alkenyl are optionally and independently substituted; and

R⁶ is selected from the group consisting of H, hydroxyl, (C₁-C₆)alkyl, (C₂-C₆)alkenyl and heterocycle, wherein each hydroxyl, alkyl, alkenyl and heterocycle are optionally substituted; and/or
2) introducing to the plant Alternaria radicina, and/or Cochliobolus sp., or an extract thereof.

In certain embodiments, CLas growth is inhibited by at least about 20%, 25%, 30%, 35%, 40%, 45%, 50%, 55%, 60%, 65%, 70%, 75%, 80%, 85%, 90%, 95%, 96%, 97%, 98%, 99% or 100%.

In certain embodiments, the plant is a citrus plant. In certain embodiments, the citrus plant is an orange, lemon, grapefruit, pomelo or lime tree/shrub. In certain embodiments, the citrus plant is an orange tree. In certain embodiments, the plant is a grapevine (Vitis vinifera).

In certain embodiments at least one compound selected from the group consisting of a compound of formula I as described herein, epicoccamide A, cladosporol A, cladosporol C, and cladosporol D, or a salt thereof, is introduced to the plant.

In certain embodiments, the at least one compound is epicoccamide A, or a salt thereof. In certain embodiments, the at least one compound is cladosporol A, or a salt thereof. In certain embodiments, the at least one compound is cladosporol C, or a salt thereof. In certain embodiments, the at least one compound is cladosporol D, or a salt thereof.

In certain embodiments, the compound is:

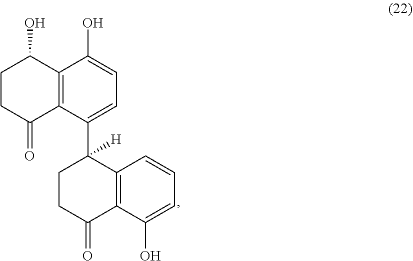 [SMILES: O=C1CC[C@@H](c2ccc(O)c3c2C(=O)CC[C@@H]3O)c2cccc(O)c21]

or a salt thereof.

In certain embodiments, the compound is:

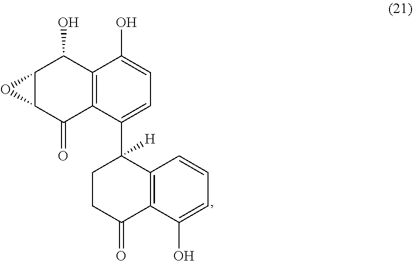 [SMILES: O=C1CC[C@@H](c2ccc(O)c3c2C(=O)[C@@H]2O[C@@H]2[C@@H]3O)c2cccc(O)c21]

or a salt thereof.

In certain embodiments, the compound is:

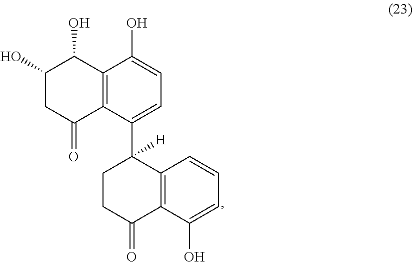 [SMILES: O=C1CC[C@@H](c2ccc(O)c3c2C(=O)C[C@H](O)[C@@H]3O)c2cccc(O)c21]

or a salt thereof.

In certain embodiments the compound is:

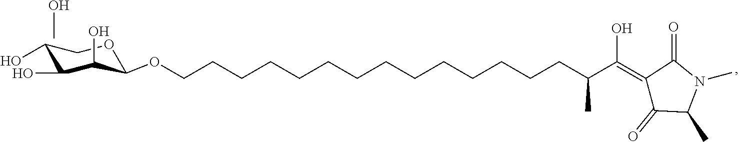

or a salt thereof.

In certain embodiments, the at least one compound is a radicinin compound(s) (e.g., a compound as described in WO/2018/144478, which is incorporated herein by reference in its entirety for all purposes), or a salt thereof.

In certain embodiments, the at least one compound is a compound of Formula I:

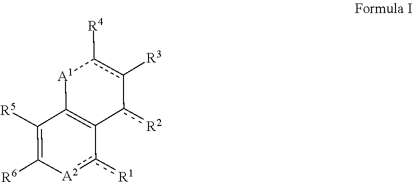

wherein,

A¹ is O, S, NH, OH, SH or NH₂,

A² is CH, O, S, or NH;

R¹ and R² are each individually selected from the group consisting of halo, CN, O, OH, NH, NH₂, S, SH, and CH₂;

R₃-R₅ are each individually selected from the group consisting of H, halo, hydroxyl, cyano, thiol, amino, aryl, (C₁-C₆)alkyl, and (C₂-C₆)alkenyl, wherein each hydroxyl, thiol, amino, aryl, alkyl and alkenyl are optionally and independently substituted; and

R⁶ is selected from the group consisting of H, hydroxyl, (C₁-C₆)alkyl, (C₂-C₆)alkenyl and heterocycle, wherein each hydroxyl, alkyl, alkenyl and heterocycle are optionally substituted:

or a salt thereof.

In certain embodiment, the compound of Formula I is a compound of Formula Ia:

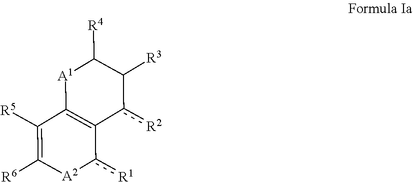

wherein,

A¹ and A² are each independently O, S, or NH;

R¹ and R are each individually selected from the group consisting of halo, CN, O, OH, NH, NH₂, S, SH, and CH₂;

R³-R⁵ are each individually selected from the group consisting of H, halo, hydroxyl, cyano, thiol, amino, aryl, (C₁-C₆)alkyl, and (C₂-C₆)alkenyl, wherein each hydroxyl, thiol, amino, aryl, alkyl and alkenyl are optionally and independently substituted; and

R⁶ is selected from the group consisting of H, hydroxyl, (C₁-C₆)alkyl, (Cr)alkenyl and heterocycle, wherein each hydroxyl, alkyl, alkenyl and heterocycle are optionally substituted;

or a salt thereof.

In certain embodiment, the compound of Formula I is a compound of Formula Ib:

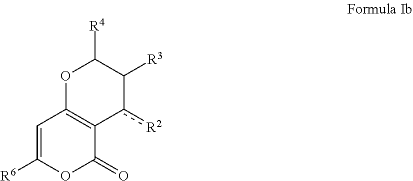

wherein,

R² is selected from the group consisting of halo, CN, O, OH, NH, NH₂, S, SH, and CH₂;

R³-R⁴ are each individually selected from the group consisting of H, halo, hydroxyl, cyano, thiol, amino, aryl, (C₁-C₆)alkyl, and (C₂-C₆)alkenyl, wherein each hydroxyl, thiol, amino, aryl, alkyl and alkenyl are optionally and independently substituted; and

R⁶ is selected from the group consisting of H, hydroxyl, (C₁-C₆)alkyl, (C₂-C₆)alkenyl and heterocycle, wherein each hydroxyl, alkyl, alkenyl and heterocycle are optionally substituted;

or a salt thereof.

In certain embodiment, the compound of Formula I is a compound of Formula Ic:

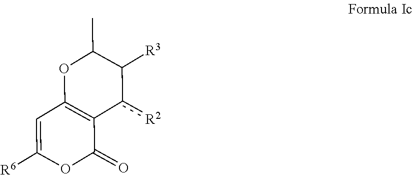

wherein,

R² is selected from the group consisting of halo, CN, O, OH, NH, NH₂, S, SH, and CH₂;

R³ is selected from the group consisting of H, halo, hydroxyl, cyano, thiol, amino, aryl, (C₁-C₆alkyl, and (C₂-C₆)alkenyl, wherein each hydroxyl, thiol, amino, aryl, alkyl and alkenyl are optionally substituted; and

R⁶ is selected from the group consisting of 1, hydroxyl, (C₁-C₆)alkyl, (C₂-C₆)alkenyl and heterocycle, wherein each hydroxyl, alkyl, alkenyl and heterocycle are optionally substituted;

or a salt thereof.

In certain embodiments, A¹ is O and/or A² is O. In certain embodiments, A¹ is OH.

In certain embodiments, A¹ is O.

In certain embodiments, A² is CH.

In certain embodiments, R¹ is O or OH. In certain embodiments, R¹ is O. In certain embodiments, R¹ is OH.

In certain embodiments, R² is O or OH. In certain embodiments, R² is O. In certain embodiments, R² is OH.

In certain embodiments, R¹ and R² are each O.

In certain embodiments, R³-R⁵ are each individually selected from the group consisting of H, halo, hydroxyl, cyano, thiol, amino, aryl, (C₁-C₆)alkyl, and (C₂-C₆)alkenyl, wherein each hydroxyl, thiol, amino, aryl, alkyl and alkenyl are optionally and independently substituted.

In certain embodiments, R³-R⁵ are each individually selected from the group consisting of H, halo, hydroxyl, cyano, thiol, amino, aryl, (C₁-C₆)alkyl, and (C₂-C₆)alkenyl, wherein each hydroxyl, thiol, amino and alkenyl are optionally and independently substituted with one or more groups independently selected from the group consisting of halo, —CN and (C₂-C₄)alkanoyl; wherein aryl is optionally and independently substituted with one or more group independently selected from the group consisting of hydroxyl, amino, and thiol.

In certain embodiments, R³ is H or OH that is optionally substituted with (C₂-C₄)alkanoyl. In certain embodiments, R³ is H or OH that is optionally substituted with an acetyl group. In certain embodiments, R³ is hydroxyl in certain embodiments, R³ is H.

In certain embodiments, R⁴ is (C₁-C₃)alkyl or hydroxyl. In certain embodiments, R⁴ is methyl.

In certain embodiments, R⁴ is optionally substituted aryl. In certain embodiments, R⁴ is hydroxylphenyl or aminophenyl. In certain embodiments, R⁴ is 4-hydroxylphenyl.

In certain embodiments, R⁵ is H.

In certain embodiments, R⁶ is selected from the group consisting of H, hydroxyl, (C₁-C₆alkyl, (C₂-C₆)alkenyl and heterocycle, wherein each hydroxyl, alkyl, alkenyl and heterocycle are optionally substituted.

In certain embodiments, R⁶ is selected from the group consisting of H, (C₁-C₆)alkyl, (C₂-C₆)alkenyl and heterocycle, wherein each alkyl, alkenyl and heterocycle are optionally substituted.

In certain embodiments, R⁶ is selected from the group consisting of H hydroxyl, (C₁-C₆)alkyl, (C₂-C₆)alkenyl and heterocycle, wherein each alkyl, alkenyl and heterocycle are optionally substituted with one or more groups independently selected from the group consisting of F, Cl, —CN and epoxy; wherein hydroxyl is optionally substituted with (CCI)alkanoyl.

In certain embodiments, Rc is selected from the group consisting of optionally substituted (C₁-C₄) alkyl and optionally substituted (C₂-C₄) alkenyl. In certain embodiments, R⁶ is selected from the group consisting of optionally substituted (C₂-C₃) alkyl and optionally substituted (C₂-C₃) alkenyl. In certain embodiments, R⁶ is selected from the group consisting of optionally substituted propyl and optionally substituted propenyl. In certain embodiments, R⁶ is epoxypropyl (e.g., 1,2-epoxylpropyl).

In certain embodiment, R⁶ is hydroxyl
In certain embodiments, the at least one compound is selected from the group consisting of:

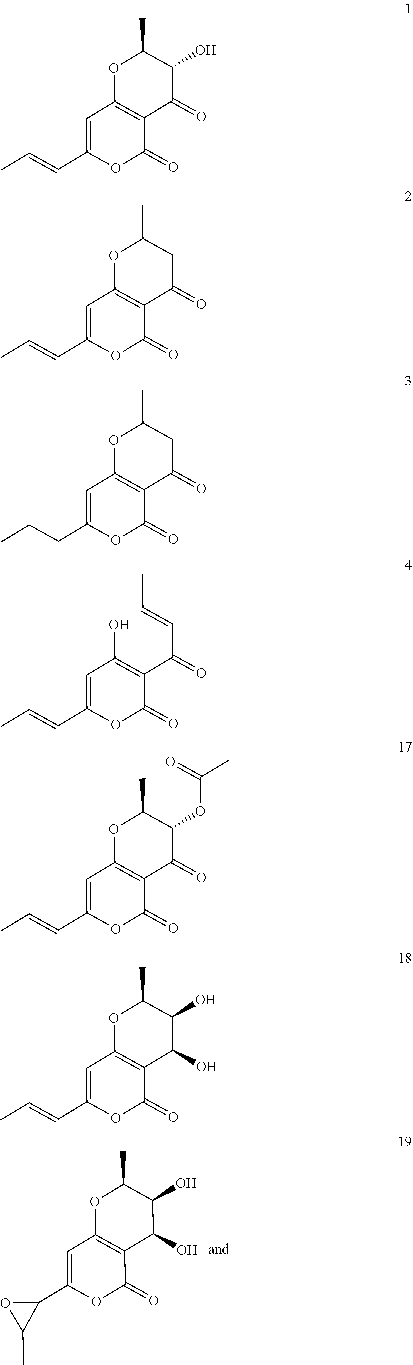

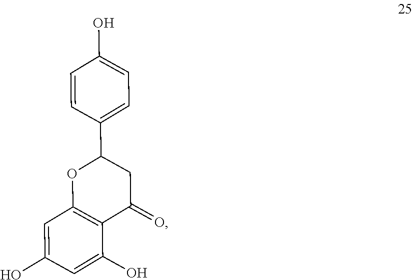 [SMILES: O=C1CC(c2ccc(O)cc2)Oc2cc(O)cc(O)c21]

or a salt thereof.
In certain embodiments, the at least one compound is selected from the group consisting of:

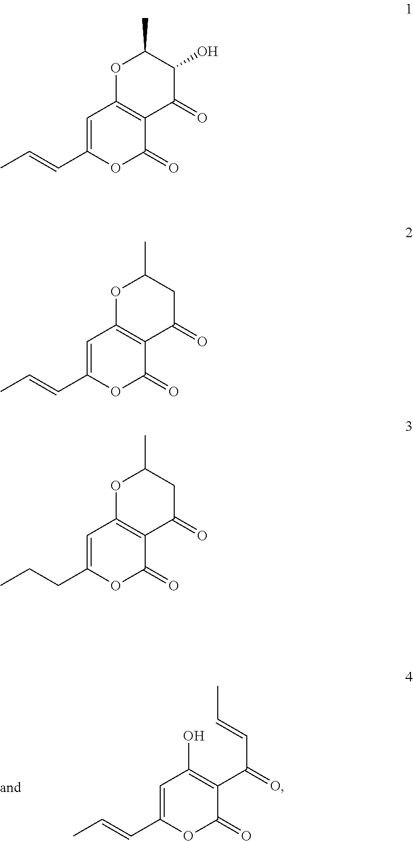 [SMILES: C/C=C/c1cc2c(c(=O)o1)C(=O)[C@@H](O)[C@H](C)O2 ; C/C=C/c1cc2c(c(=O)o1)C(=O)CC(C)O2 ; CCCc1cc2c(c(=O)o1)C(=O)CC(C)O2 ; C/C=C/C(=O)c1c(O)cc(/C=C/C)oc1=O]

or a salt thereof.
In certain embodiments, the at least one compound is selected from the group consisting of:

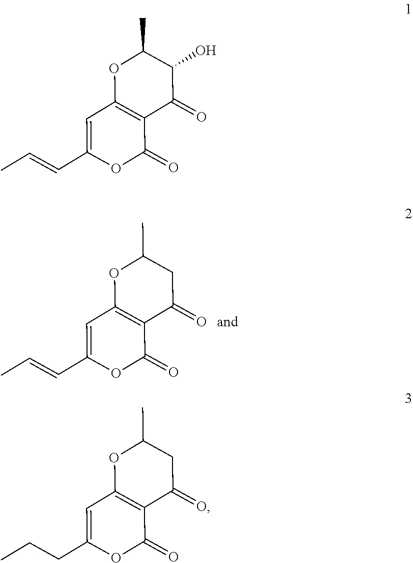

or a salt thereof.
In certain embodiments, the at least one compound is selected from the group consisting of:

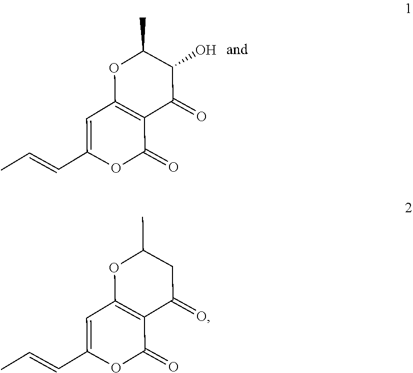 [SMILES: C/C=C/c1cc2c(c(=O)o1)C(=O)[C@@H](O)[C@H](C)O2 ; C/C=C/c1cc2c(c(=O)o1)C(=O)CC(C)O2]

or salt thereof.

In certain embodiments, the at least one compound is radicinin (compound 1):

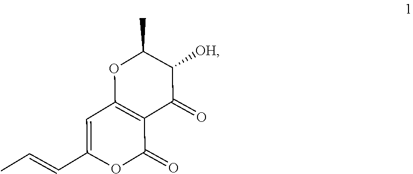 [SMILES: C/C=C/c1cc2c(c(=O)o1)C(=O)[C@@H](O)[C@H](C)O2]

or a salt thereof.

In certain embodiments, the at least one compound is compound 20:

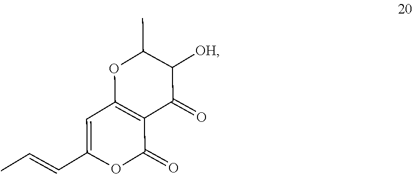 [SMILES: C/C=C/c1cc2c(c(=O)o1)C(=O)C(O)C(C)O2]

or a salt thereof.

In certain embodiments, the at least one compound is deoxyradicinin (compound 2):

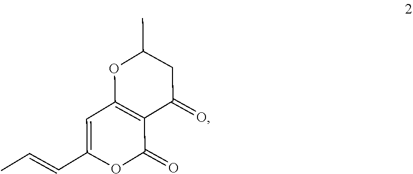 [SMILES: C/C=C/c1cc2c(c(=O)o1)C(=O)CC(C)O2]

or a salt thereof.

In certain embodiments, the at least one compound is (+)-deoxyradicinin, or a salt thereof.

In certain embodiments, the at least one compound is (−)-deoxyradicinin, or a salt thereof.

In certain embodiments, the at least one compound is dihydrodeoxyradicinin (compound 3):

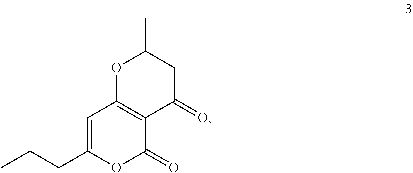 [SMILES: CCCc1cc2c(c(=O)o1)C(=O)CC(C)O2]

or a salt thereof.

In certain embodiments, the at least one compound is compound 4:

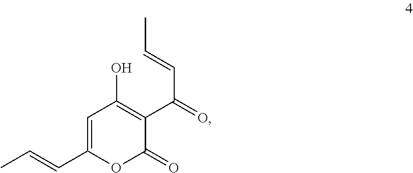 [SMILES: C/C=C/C(=O)c1c(O)cc(/C=C/C)oc1=O]

or a salt thereof.

In certain embodiments, the at least one compound is acetylradicinin (compound 17):

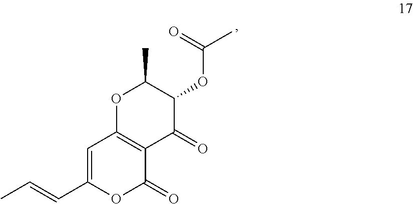 [SMILES: C/C=C/c1cc2c(c(=O)o1)C(=O)[C@@H](OC(C)=O)[C@H](C)O2]

or a salt thereof.

In certain embodiments, the at least one compound is 2 s, 3 s, 4 s-radicinol (compound

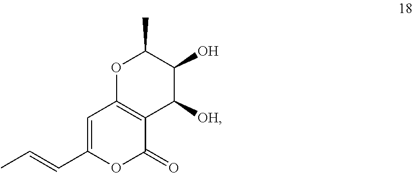 [SMILES: C/C=C/c1cc2c(c(=O)o1)[C@H](O)[C@H](O)[C@H](C)O2]

or a salt thereof.

In certain embodiments, the at least one compound is 2 s, 3 s, 4 s-epi-radicinol (compound

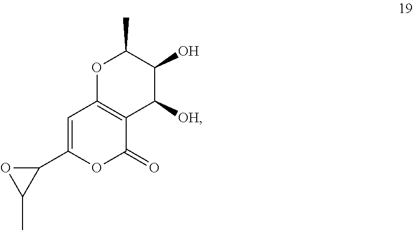 [SMILES: CC1OC1c1cc2c(c(=O)o1)[C@H](O)[C@H](O)[C@H](C)O2]

or a salt thereof.

In certain embodiments, the at least one compound is compound 25:

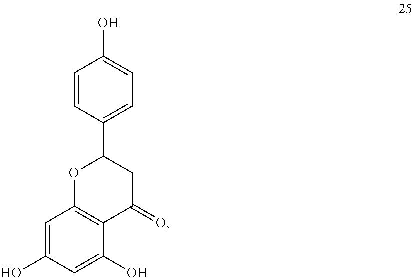 [SMILES: O=C1CC(c2ccc(O)cc2)Oc2cc(O)cc(O)c21]

or a salt thereof.

In certain embodiments, the at least one compound is compound 26:

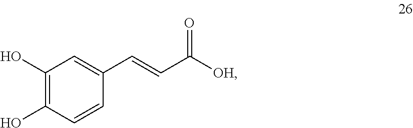 [SMILES: O=C(O)/C=C/c1ccc(O)c(O)c1]

or a salt thereof.

In certain embodiments, the at least one compound is compound 27:

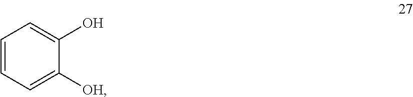

or a salt thereof.

In certain embodiments, the at least one compound is compound 28:

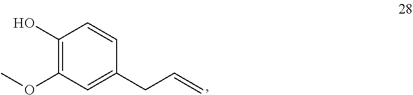

or a salt thereof.

In certain embodiments at least two compounds selected from the group consisting of a compound of formula I as described herein, epicoccamide A, cladosporol A, cladosporol C, and cladosporol D, or a salt thereof, are introduced to the plant. In certain embodiments, at least three compounds selected from the group consisting of a compound of formula I as described herein, epicoccamide A, cladosporol A, cladosporol C, and cladosporol D, or a salt thereof, are introduced to the plant. In certain embodiments, epicoccamide A, cladosporol A, cladosporol C, and cladosporol D, or a salt thereof, are introduced to the plant. In certain embodiments, cladosporol A, cladosporol C, and cladosporol D, or a salt thereof, are introduced to the plant.

When more than one compound is introduced, the compounds may be introduced either simultaneously or sequentially. In certain embodiments, the compounds may be introduced simultaneously. In certain embodiments, a composition comprising two or more compounds are introduced. In certain embodiments, two or more compounds are administered sequentially.

In certain embodiments, at least one additional agent is introduced (e.g., an agent capable of inhibiting CLas growth and/or treating a CLas infection). In certain embodiments, the at least one additional agent is an antibiotic.

In certain embodiments, one or more of the compounds are chemically synthesized. In certain other embodiments, one or more of the compounds are isolated or purified from a natural product source (e.g., from a preparation derived from microbial culturing or fermentation). For example, a cladosporol compound(s) may be derived from Cladosporium cladosporioides, an epicoccamide compound may be derived from Epicoccum nigrum, or a radicinin compounds(s) may be derived from Alternaria radicina or Cochliobolus sp.

Certain embodiments also provide a composition comprising one or more of the compounds (e.g., for use in method described herein). In certain embodiments, the composition further comprises a carrier. In one example, the composition comprises at least one compound selected from the group consisting of a radicinin compound (e.g., a compound of formula I as described herein), a cladosporol compound and an epicoccamide compound. In one example, the composition comprises at least one compound selected from the group consisting of radicinin, deoxyradicinin, dihydrodeoxyradicinin, cladosporol A, cladosporol C, cladosporol D and epicoccamide A, or a salt thereof. In one example, the composition comprises at least one compound selected from the group consisting of radicinin, deoxyradicinin and dihydrodeoxyradicinin, or a salt thereof. In one example, the composition comprises at least one compound selected from the group consisting of cladosporol A, cladosporol C, cladosporol D and epicoccamide A, or a salt thereof.

In one example, the composition comprises at least two compounds selected from the group consisting of a radicinin compound(s) (e.g., a compound of formula I as described herein), a cladosporol compound(s) and an epicoccamide compound(s). In one example, the composition comprises at least two compounds selected from the group consisting of radicinin, deoxyradicinin, dihydrodeoxyradicinin, cladosporol A, cladosporol C, cladosporol D and epicoccamide A, or a salt thereof. In one example, the composition comprises at least two compounds selected from the group consisting of radicinin, deoxyradicinin and dihydrodeoxyradicinin, or a salt thereof. In one example, the composition comprises at least three compounds selected from the group consisting of cladosporol A, cladosporol C, cladosporol D and epicoccamide A, or a salt thereof.

In one example, the composition comprises cladosporol A, cladosporol C, cladosporol D and epicoccamide A, or a salt thereof. In one example, the composition comprises cladosporol A, cladosporol C, and cladosporol D, or a salt thereof. In one example, the composition comprises cladosporol A (21), cladosporol C (22), cladosporol D (23), and/or epicoccamide A (24), or a salt thereof. In certain embodiments, the composition further comprises one or more additional agents (e.g., an antibiotic agent).

In one example, the composition comprises cladosporol A and compound 4. In one example, the composition comprises radicinin and compound 4. In one example, the composition comprises radicinin and cladosporol B. In one example, the composition comprises deoxyradicinin and cladosporol C. In one example, the composition comprises dihydrodeoxyradicinin and epicoccamide A.

In certain embodiments, the radicinin, cladosporol and/or epicoccamide compounds, compositions and/or microbial extracts comprising anti-CLas compounds may be formulated for plant application/introduction. Common agrochemical formulations are well known in the field, and include liquid and solid formulations. Exemplary formulations comprising active compounds include gel, aqueous or oil-based solutions, dispersions, suspensions or emulsions, such as those described in U.S. Pat. Nos. 5,139,152; 6,403,529; 6,878,674; 7,094,831; 7,109,267 and 9,706,771. In certain embodiments, the compound(s) may be present in a liquid formulation, which may be administered or sprayed onto a plant or agricultural medium using, e.g., ground/aerial spraying. In other examples, the compounds may be formulated in pellet or tablet formulations. Such formulations may be capable of rapid break-up in water using minimal or no agitation while providing fine dispersions of the active ingredient (see, e.g., U.S. Pat. Nos. 5,180,587 and 7,550,156). Suitable additives or excipients which may be present in the formulations include organic solvents, solubilizers, emulsifiers, surfactants, dispersants, preservatives, colorants, fillers, diluents, binders, glidants, lubricants, disintegrants, antiadherents, lubricants, sorbents, coatings, wetting agents, penetrants and vehicles. Well known additives, excipients and agrochemical formulations are described in U.S. Pat. No. 6,602,823 and the aforementioned US patents.

In certain embodiments, microbes described herein may act as a biocontrol agent to control plant disease by secreting compounds that act to inhibit or kill the disease-causing organism (i.e., CLas), and/or by occupying the ecological niche that would otherwise be available to the disease-causing organism. Certain embodiments of the present invention provide exemplary isolates of bacterial strains and fungal strains associated with a plant microbiome as described herein. The microbial strains can be isolated from rhizosphere, phyllosphere or endosphere of a healthy or diseased (e.g., CLas infected) plant (e.g., a citrus tree, such as an orange tree).

Thus, in certain embodiments, Cladosporium cladosporioides, Epicoccum nigrum, Pantoea agglomerans, Pantoea vagans, Bacillus sp., Curtobacterium sp., Alternaria radicina and/or Cochliobolus sp or an extract thereof, may be introduced to the plant to inhibit CLas growth and/or treat a CLas infection. In certain embodiments, Cladosporium cladosporioides, or an extract thereof, is introduced to the plant. In certain embodiments, Epicoccum nigrum, or an extract thereof, is introduced to the plant. In certain embodiments, Pantoea agglomerans, or an extract thereof, is introduced to the plant. In certain embodiments, Pantoea vagans, or an extract thereof, is introduced to the plant. In certain embodiments, Bacillus sp, or an extract thereof, is introduced to the plant. In certain embodiments, Curtobacterium sp, or an extract thereof, is introduced to the plant.

In certain embodiments, Alternaria radicina, and/or Cochliobolus sp., or an extract thereof, may be introduced to the plant to inhibit CLas growth and/or treat a CLas infection. In certain embodiments, an inactivated form or culture of Alternaria radicina, or an extract thereof, is introduced to the plant. In certain embodiments, an inactivated form or culture of Cochliobolus sp., or an extract thereof, is introduced to the plant.

In certain embodiments, a combination of two or more types of microbes selected from Cladosporium cladosporioides, Epicoccum nigrum, Pantoea agglomerans, Pantoea vagans, Bacillus sp., Curtobacterium sp., Alternaria radicina and Cochliobolus sp, or an extract thereof, is introduced to the plant.

In certain embodiments, a combination of two or more types of microbes selected from Cladosporium cladosporioides, Epicoccum nigrum, Pantoea agglomerans, Pantoea vagans, Bacillus sp., and Curtobacterium sp., or an extract thereof, is introduced to the plant. In certain embodiments, Cladosporium cladosporioides, and Epicoccum nigrum, or an extract thereof, are introduced to the plant. In certain embodiments, Cladosporium cladosporioides, Epicoccum nigrum, Pantoea agglomerans, and Curtobacterium sp., or an extract thereof, are introduced to the plant. In certain embodiments, Cladosporium cladosporioides, Epicoccum nigrum, Pantoea agglomerans, Pantoea vagans, Bacillus sp., and Curtobacterium sp., or an extract thereof, are introduced to the plant.

In certain embodiments, a combination of Alternaria radicina, and Cochliobolus sp., or an extract thereof, are introduced to the plant.

In certain embodiments, the microbe or mixture of microbes is inactivated (e.g., heat-killed). In certain embodiments, the microbe or mixture of microbes is present in an inactivated culture (e.g., a heat-killed whole culture broth).

When more than one type of microbe/extract is introduced, the microbes/extracts may be introduced either simultaneously or sequentially. In certain embodiments, the microbes/extracts may be introduced simultaneously. In certain embodiments, a composition comprising two or more types of microbes/extracts are introduced. In certain embodiments, two or more types of microbes/extracts are introduced sequentially.

In certain embodiments, at least one additional agent is introduced (e.g., an agent capable of inhibiting CLas growth and/or treating a CLas infection). In certain embodiments, the at least one additional agent is an antibiotic.

In certain embodiments, a microbe(s) described herein (e.g., Cladosporium cladosporioides, Epicoccum nigrum, Pantoea agglomerans, Pantoea vagans, Bacillus sp., Curtobacterium sp., Alternaria radicina and/or Cochliobolus sp.) or an extract from such a microbe(s) is present in a composition. In certain embodiments, the composition further comprises a carrier. In certain embodiments, the composition comprises Cladosporium cladosporioides, or an extract thereof. In certain embodiments, the composition comprises Epicoccum nigrum, or an extract thereof. In certain embodiments, the composition comprises Pantoea agglomerans, or an extract thereof. In certain embodiments, the composition comprises Pantoea vagans, or an extract thereof. In certain embodiments, the composition comprises Bacillus sp., or an extract thereof. In certain embodiments, the composition comprises Curtobacterium sp, or an extract thereof. In certain embodiments, the composition comprises Alternaria radicina, or an extract thereof. In certain embodiments, the composition comprises Cochliobolus sp., or an extract thereof.

In certain embodiments, the composition comprises two or more types of microbes selected from Cladosporium cladosporioides, Epicoccum nigrum, Pantoea agglomerans, Pantoea vagans, Bacillus sp., Curtobacterium sp., Alternaria radicina and Cochliobolus sp, or an extract thereof. In certain embodiments, the composition comprises two or more types of microbes selected from Cladosporium cladosporioides, Epicoccum nigrum, Pantoea agglomerans, Pantoea vagans, Bacillus sp., and Curtobacterium sp., or an extract thereof. In certain embodiments, the composition comprises Cladosporium cladosporioides, Epicoccum nigrum, Pantoea agglomerans, Pantoea vagans, Bacillus sp., and Curtobacterium sp, or an extract thereof. In certain embodiments, the composition comprises Alternaria radicina, and Cochliobolus sp., or an extract thereof. In certain embodiments, the composition comprises an inactivated form or culture of a microbe described herein or mixture of microbes described herein, such as heat-killed whole culture broth. In certain embodiments, the composition further comprises one or more additional agents (e.g., an antibiotic agent).

In certain embodiments, the composition is a bioinoculant composition, optionally comprising a carrier. For example, fungi or bacteria may be cultured and then mixed with carrier(s). In certain embodiments, the carriers act to support the viability of bioinoculant isolates. In certain embodiments, the carriers act as bulking materials to allow easy handling. Carriers commonly used for bioinoculation to disperse the microbial isolates are described in, e.g., U.S. Pat. Nos. 5,068,105; 7,097,830; 7,141,395 and 9,068,189. Some exemplary carriers include peat, perlite, vermiculite, charcoal, powdered sorghum grain, fermented press mud, sulphinated press mud, carbonation press mud, grain, maize meal, maize cob, compost, soil, rice husk, rice bran, wheat bran, cow dung and talc. Many other non-toxic and biologically inert substances of dried or granular nature are also capable of serving as carriers for a biocontrol agent. In certain embodiments, a bioinoculant composition may further comprise gums or sugars to improve adhesion.

In certain embodiments, a microbial extract or a combination of microbial extracts are introduced to a plant. In certain embodiments, the extract(s) is present in a composition, such as a composition described herein. In certain embodiments, the extract is a crude extract or a fraction of an extract. The extract may be fractionated by chromatography as described herein or by using other preparative liquid chromatography methods known in the art. The crude extract or fractionated extract may be processed at any stage of the composition preparation to undergo any appropriate extraction, separation or purification step(s).

In one embodiment, the composition comprises a fungal extract comprising radicinin compound(s) (e.g., a compound of formula I as described herein), cladosporol compound(s) and/or epicoccamide A. In certain embodiments, the fungal extract is a Cladosporium cladosporioides extract and/or an Epicoccum nigrum extract. In certain embodiments, the fungal extract is an Alternaria radicina extract and/or a Cochliobolus sp extract. In certain embodiments, the extract is prepared from a fungal culture. In certain embodiments, the fungal extract is a crude extract or a fraction of a fungal extract (e.g., Cladosporium cladosporioides extract or Epicoccum nigrum extract). For example, the fungal extract may comprise fraction 8 from E. nigrum, fraction 3 from C. cladosporioides, or any active fraction(s) as described herein.

In another embodiment, the composition comprises a bacterial extract (e.g., a bacterial supernatant filtrate or lysate filtrate). A bacterial extract or filtrate can be prepared from a bacterial culture. In certain embodiments, the bacterial extract is a crude extract or a fraction of a bacterial extract. In certain embodiments, the bacterial extract is a Pantoea agglomerans extract (e.g., a Pantoea agglomerans culture supernatant filtrate or lysate filtrate). In certain embodiments, the bacterial extract is a Pantoea Vagans extract (e.g., a Pantoea Vagans culture supernatant filtrate or lysate filtrate). In certain embodiments, the bacterial extract is a Bacillus sp extract (e.g., a Bacillus sp. culture supernatant filtrate or lysate filtrate). In certain embodiments, the bacterial extract is a Curtobacterium sp extract (e.g., a Curtobacterium sp culture supernatant filtrate or lysate filtrate).

Fungal and bacterial extracts can be formulated into a liquid or solid form described herein. In one example, the extract(s) is formulated into a concentrated solution or dispersion for easy distribution and can be diluted in the field prior to use. Alternatively, the extract(s) is formulated into a ready-to-use solution or dispersion.

The inhibitory compounds, microbes and compositions described herein may also be used in combination with each other to enhance anti-CLas efficacy. In one embodiment, the compounds or compositions described herein can be introduced to a plant as a mixture. In certain embodiments, a composition comprising a compound described herein and a microbial isolate/extract is provided. In one embodiment, the compounds or compositions described herein can be introduced to a plant concurrently or sequentially.

Certain embodiments of the invention also provide a kit comprising:

1) at least one compound selected from the group consisting of a compound of formula I as described herein, epicoccamide A, cladosporol A, cladosporol C, and cladosporol D, or a salt thereof,

2) packaging material; and

3) instructions to introduce to a plant the compound to treat a Candidatus Liberibacter asiaticus (CLas) infection in the plant or to treat Huanglongbing (HLB) in the plant.

Certain embodiments of the invention also provide a kit comprising:

1) at least one compound selected from the group consisting of a compound of formula I as described herein, epicoccamide A, cladosporol A, cladosporol C, and cladosporol D, or a salt thereof,

2) packaging material; and

3) instructions to introduce to a plant the compound to inhibit Candidatus Liberibacter asiaticus (CLas) growth in the plant.

Certain embodiments of the invention provide a kit comprising:

1) a microbial isolate, or an extract thereof, wherein the microbial isolate comprises Cladosporium cladosporioides, Epicoccum nigrum, Pantoea agglomerans, Pantoea vagans, Bacillus sp., Curtobacterium sp., Alternaria radicina and/or Cochliobolus sp, or an extract thereof,

2) packaging material; and

3) instructions to introduce to a plant the microbial isolate/extract to treat a Candidatus Liberibacter asiaticus (CLas) infection in the plant or to treat Huanglongbing (HLB) in the plant. In certain embodiments, the microbial isolate is inactivated, or present in an inactivated form or culture (e.g., a heat killed whole culture broth).

Certain embodiments of the invention provide a kit comprising:

1) a microbial isolate, or an extract thereof, wherein the microbial isolate comprises Cladosporium cladosporioides, Epicoccum nigrum, Pantoea agglomerans, Pantoea vagans, Bacillus sp., Curtobacterium sp., Alternaria radicina and/or Cochliobolus sp, or an extract thereof,

2) packaging material; and

3) instructions to introduce to a plant the microbial isolate/extract to inhibit Candidatus Liberibacter asiaticus (CLas) growth in the plant. In certain embodiments, the microbial isolate is inactivated, or present in an inactivated form or culture (e.g., a heat killed whole culture broth).

### Methods of Identifying CLas Inhibitory Compounds

Certain embodiments provide a method of identifying an agent that inhibits Candidatus Liberibacter asiaticus (CLas), comprising 1) culturing a CLas surrogate bacterium; 2) contacting the cultured surrogate bacterium with a test agent to provide a test culture sample; 3) measuring the amount of surrogate bacterium growth in the test culture sample; and 4) identifying the test agent as inhibitory based on the amount of bacterial growth compared to a control (e.g., when the amount of surrogate bacteria growth is less than the growth of a corresponding control surrogate bacterium culture sample that was not contacted with the test agent).

In certain embodiments, the CLas surrogate bacterium is Liberibacter crescens (L. crescens). Thus, certain embodiments provide a method of identifying an agent that inhibits Candidatus Liberibacter asiaticus (CLas), comprising: 1) culturing L. crescens bacteria; 2) contacting the cultured L. crescens bacteria with a test agent to provide a test culture sample, wherein the test agent is derived from a plant microbiome; 3) measuring the amount of L. crescens growth in the test culture sample; and 4) identifying the test agent as inhibitory based on the amount of L. crescens growth compared to a control (e.g., when the amount of L. crescens growth is less than the growth of a corresponding control L. crescens culture sample that was not contacted with the test agent). In certain embodiments, the L. crescens is L. crescens BT-1.

The L. crescens bacteria may be cultured in any solid support and under any conditions that promote growth. For example, the L. crescens bacteria may be cultured under conditions described herein. In certain embodiments, the bacteria is cultured in a well plate (e.g., a 96-well or 384- well plate), a petri dish or in a culture tube using LB. In certain embodiments, the culturing may comprise an agar-based culturing system in a dish or plate, such as plating an agar layer comprising the bacteria (e.g., L. crescens BT-1). In one example, the agar layer can be amended 10% v/v with a L. crescens liquid culture so that L. crescens can grow in the agar layer. In one example, the culturing can be a liquid-based culturing system in a container (e.g., test tube or flask).

In certain embodiments, the bacteria are cultured for about 0 to about 48 hours, or about 0 to about 36 hours, or about 0 to about 24 hours, or about 6 to about 24 hours, or about 6 to about 12 hours prior to contact with the test agent. In certain embodiments, the bacteria are cultured for about 0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47 or 48 hours prior to contact with the test agent.

In certain embodiments, the test agent is derived from a plant microbiome. For example, in certain embodiments, the test agent is a microbe, such as a fungus or bacteria. In certain embodiments, the test agent is a microbial extract, such as a fungal or bacterial extract (e.g., a bacterial supernatant filtrate). In certain embodiments, the test agent is a compound derived from a microbe or microbial extract (e.g., an antimicrobial secondary metabolite). In certain embodiments, the microbe is a member of a microbial repository derived from a plant microbiome (e.g., bacteriome and/or mycobiome). The plant microbiome can be sampled from the root, stem and/or leaf of the plant. In one example, the plant microbiome is a citrus microbiome obtained from a healthy or diseased citrus plant.

In certain embodiments, the cultured bacteria are contacted with the test agent for a period of time ranging from about 1 hour to about 1 week. For example, in certain embodiments, the cultured bacteria are contacted with the test agent for about 0.5 to 2.5 days, 1 to 3 days, 2 to 4 days, 3 to 5 days, 4 to 6 days, 5 to 7 days, or 6 to 8 days. In certain embodiments, the cultured bacteria are contacted with the test agent for about 6 days.

In certain embodiments, bacterial growth is decreased by at least about 15%, 20%, 25%, 30%, 35%, 40%, 45%, 50%, 55%, 60%, 65%, 70%, 75%, 80%, 85%, 90%, 95%, or more as compared to a reference or control value (e.g., a negative control or reference value, such as a control or reference sample that was not contacted with the test agent). In certain other embodiments, bacterial growth is compared to a positive control or reference value (e.g., a control or reference sample that was contacted with an agent known to have inhibitory activity).

In certain embodiments, inhibition of the test agent is determined by measuring a zone of bacterium growth inhibition around the test agent. For example, in certain embodiments, a test agent is comprised in an overlayer, which can be prepared by applying a test agent (e.g., a microbial extract) to an absorptive material, such as a sterile filter paper disc. An agar layer comprising the bacteria (e.g., L. crescens) may then be contacted with the test agent loaded overlayer (e.g., filter paper). Accordingly, in certain embodiments, the culturing step 1) as described above comprises culturing Liberibacter crescens bacteria on an agar layer. In certain embodiments, a test agent is loaded on an overlayer, and the contacting step 2) as described above comprises placing the overlayer above (e.g., on top of) the agar layer. After culturing for a period of time, a zone of inhibition may be measured and compared to a control to determine whether the test agent is inhibitory (e.g., compared to the growth of bacteria not contacted with a test agent under corresponding conditions). In certain other embodiments, a test agent may be directly placed onto an agar layer comprising the bacteria (e.g., L. crescens) or added directly into a liquid culture comprising the bacteria. In such situations, inhibition of the test agent may be determined by comparing the bacterial growth to a control, such as a negative control (e.g., compared to the growth of the bacteria not contacted with a test agent under corresponding conditions).

### Methods of Synthesizing Radicinin Compounds

Certain embodiments of the invention provide a more efficient and economical method for the total synthesis of a radicinin compound (e.g., deoxyradicinin or dihydrodeoxyradicinin).

In certain embodiments, deoxyradicinin or dihydrodeoxyradicinin can be synthesized in three steps with commercially available starting material (e.g., see scheme 2 in Example 2 and FIG. 8).

### Methods of Synthesizing Intermediate Compound 16 and Deoxyradicinin

Certain embodiment of the invention provides a method of preparing 2,2-dimethyl-6-[(3E)-2-oxopent-3-en-1-yl]-2,4-dihydro-1,3-dioxin-4-one (compound 16), comprising converting compound 7 to compound 16 directly or in a one-step reaction (e.g., C-acylation of compound 7 or a metal enolate of compound 7).

In certain embodiments, the method of preparing compound 16 comprises C-acylation of compound 7. In certain embodiments, the method of preparing compound 16 comprises C-acylation of a metal enolate of compound 7 (e.g., lithium enolate of compound 7 or zinc enolate of compound 7).

Certain embodiments of the invention provide a method of reacting compound 7 or a metal enolate of compound 7 with an optionally substituted C₃ alkenoyl (CH₂CHC(═O)) donor compound or an optionally substituted C₄ alkenoyl (CH₃CHCHC(═O)) donor compound.

In certain embodiments, the method of preparing compound 16 comprises reacting compound 7 or a metal enolate of compound 7 with a C₄ alkenoyl (CH₃CHCHC(═O)) donor compound under conditions suitable to provide compound 16.

In certain embodiments, the C₄ alkenoyl (CH₃CHCHC(═O)) donor compound is selected from the group consisting of:

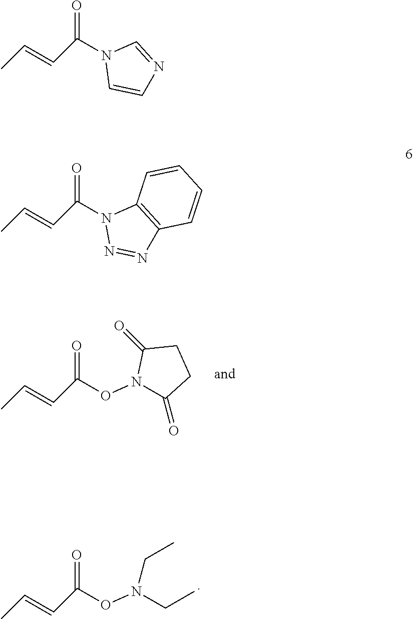

In certain embodiments, the C₄ alkenoyl (CH₃CHCHC(═O)) donor compound is (E)-1-(1H-benzo[d][1,2,3]triazol-1-yl)but-2-en-1-one (compound 6). Thus, in certain embodiments, the method of preparing compound 16 comprises reacting compound 7 or a metal enolate of compound 7 with compound 6.

In certain embodiments, the method of preparing compound 16 comprises converting compound 7 to compound 16 in the presence of metal (e.g., lithium or zinc). In certain embodiments, the metal is lithium and/or zinc.

In certain embodiments, the converting proceeds in the presence of lithium. In certain embodiments, the converting proceeds in the presence of lithium bis(trimethylsilyl)amide (LiHMDS).

In certain embodiments, the method of preparing compound 16 comprises converting compound 7 to compound 16 in the presence of a non-nucleophilic base (e.g., a strong non-nucleophilic base such as Zn(HMDS)₂, Zn(TMP)₂, alkylzinc or lithium agent including, but not limited to, LDA, LiHMDS, LiTMP with or without the aid of alkylzinc).

In certain embodiments, the non-nucleophilic base is LDA, LiHMDS, or LiTMP. In certain embodiments, the non-nucleophilic base is lithium bis(trimethylsilyl)amide (LiHMDS). In certain embodiments, hexamethyldisilazane and n-Butyllithium are added to provide the non-nucleophilic base. In certain embodiment, the non-nucleophilic base (LiHMDS) is provided to compound 7 and/or a metal enolate of compound 7 (e.g., lithium enolate of compound 7) is formed in a temperature range of about −95° C. to −65° C. In certain embodiments, the temperature is about −90° C. to −70° C. In certain embodiments, the temperature is about −85° C. to −75° C. In certain embodiments, the temperature is about −90° C., −85° C., −80° C., −75° C. or −70° C. In certain embodiments, the temperature is about −78° C.

In certain embodiments, a metal enolate of compound 7 (e.g., lithium enolate of compound 7) is formed in a time range of about 0.2 h to 4 h. In certain embodiments, the reaction time is about 0.5 h to 3 h. In certain embodiments, the temperature is about 1 h to 2 h. In certain embodiments, the reaction time is about 0.5 h, 1 h, 1.5 h, 2 h, 3 h or 4 h. In certain embodiments, the reaction time is about 1 h.

In certain embodiments, the converting of compound 7 to compound 16 proceeds in the presence of zinc. In certain embodiments, the converting of compound 7 to compound 16 proceeds in the presence of alkylzinc. In certain embodiments, lithium enolate of compound 7 is converted to zinc enolate or zincate species prior to introduction of the alkenoyl donor compound.

Thus, in certain embodiments, the method of preparing compound 16 comprises zinc mediated C-acylation of compound 7. In certain embodiments, the method of preparing compound 16 comprises C-acylation of zinc enolate of compound 7. In certain embodiments, the C-acylation of compound 7 is mediated via a zinc compound, such as Zn(TMP)₂, Zn(HMDS)₂ or an alkylzinc. In certain embodiments, the alkylzinc is dimethylzinc, diethylzinc or dipropylzinc. In certain embodiments, the alkylzinc is diethylzinc.

In certain embodiments, lithium enolate of compound 7 is converted to zinc enolate or zincate species in a temperature range of about −35° C. to −5° C. In certain embodiments, the temperature is about −30° C. to −10° C. In certain embodiments, the temperature is about −25° C. to −15° C. In certain embodiments, the temperature is about −30° C., −25° C., −20° C., −15° C. or −10° C. In certain embodiments, the temperature is about −20° C.

In certain embodiments, compound 7 or metal enolate of compound 7 (e.g., zinc enolate of compound 7) reacts with compound 6 in a temperature range of about −35° C. to −5° C. In certain embodiments, the temperature is about −30° C. to −10° C. In certain embodiments, the temperature is about −25° C. to −15° C. In certain embodiments, the temperature is about −30° C., −25° C., −20° C., −15° C. or −10° C. In certain embodiments, the temperature is about −20° C.

In certain embodiments, compound 7 or a metal enolate of compound 7 (e.g., zinc enolate of compound 7) reacts with compound 6 in a time range of about 0.5 h to 12 h. In certain embodiments, the reaction time is about 1 h to 6 h. In certain embodiments, the reaction time is about 1.5 h to 5 h. In certain embodiments, the reaction time is about 1 h, 2 h, 3 h or 4 h. In certain embodiments, the reaction time is about 2 h. In certain embodiments, the reaction of compound 6 and 7 is stopped by an acid (e.g., a strong acid). In certain embodiments, the acid is HCl.

In certain embodiments, the method or reaction of preparing compound 16 proceeds in a polar solvent. In certain embodiments, the solvent is a polar aprotic solvent. In certain embodiments, the solvent is tetrahydrofuran (THF). In certain embodiments, the solvent further comprises a nonpolar solvent component. In certain embodiments, the nonpolar solvent component is hexane, diethyl ether (Et₂O) or dimethoxyethane (DME).

Certain embodiments of the invention also provide a method of preparing deoxyradicinin. Certain embodiments of the invention provide a method of preparing compound 16 as described above, further comprising (b) converting compound 16 to (E)-4-hydroxy-6-(prop-1-en-1-yl)-2H-pyran-2-one (compound 5) and (c) converting compound 5 to deoxyradicinin (compound 2).

In certain embodiments, step (b) proceeds in a non-polar solvent (e.g., toluene) under reflux.

In certain embodiments, step (c) comprises reacting compound 5 with a C₄ alkenoyl (CH₃CHCHC(═O)) donor compound. In certain embodiments, the C₄ alkenoyl (CH₃CHCHC(═O)) donor compound is crotonic acid or a crotonoyl halide (e.g., crotonoyl chloride). In certain embodiments, step (c) proceeds in the presence of a salt (e.g., metal chloride such as ZnCl₂ or TiCl₄) and/or phosphoryl chloride (POCl₃).

### Methods of Synthesizing Compound 14 and Dihydrodeoxyradicinin

Certain embodiments of the invention provide a method of preparing 2,2-dimethyl-6-(2-oxopentyl)-4H-1,3-dioxin-4-one (compound 14), comprising converting compound 7 to compound 14 directly or in a one-step reaction (e.g., C-acylation of compound 7 or a metal enolate of compound 7).

In certain embodiments, the method of preparing compound 14 comprises C-acylation of compound 7. In certain embodiments, the method of preparing compound 14 comprises C-acylation of a metal enolate of compound 7 (e.g., lithium enolate of compound 7). In certain embodiments, the method of preparing compound 14 comprises reacting compound 7 or a metal enolate of compound 7 with a C₄ alkanoyl (CH₃CH₂CH₂C(═O)) donor compound under conditions suitable to provide compound 14.

In certain embodiments, the C₄ alkanoyl (CH₃CH₂CH₂C(═O)) donor compound is selected from the group consisting of:

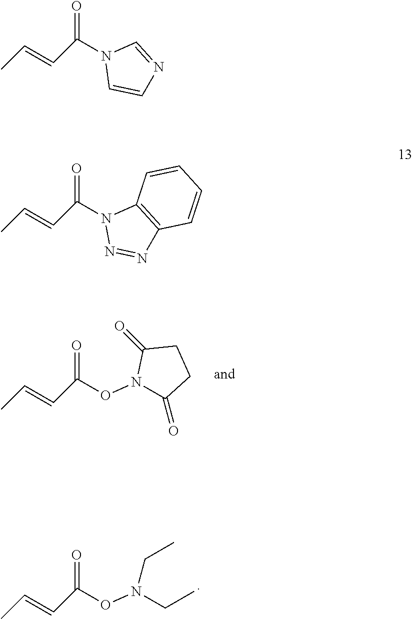

In certain embodiments, the C₄ alkanoyl (CH₃CH₂CH₂C(═O)) donor compound is 1-(1H-benzo[d][1,2,3]triazol-1-yl)butan-1-one (compound 13). Thus, in certain embodiments, the method of preparing compound 14 comprises reacting compound 7 or a metal enolate of compound 7 with compound 13.

In certain embodiments, the method of preparing compound 14 comprises converting compound 7 to compound 14 in the presence of a metal. In certain embodiments, the metal is lithium. In certain embodiments, the method of preparing compound 14 comprises converting compound 7 to compound 14 in the presence of Lithium diisopropylamide (LDA). In certain embodiments, the method of preparing compound 14 comprises lithium mediated C-acylation of compound 7. In certain embodiments, the method of preparing compound 14 comprises C-acylation of lithium enolate of compound 7.

In certain embodiments, the method of preparing compound 14 comprises converting compound 7 to compound 14 in the presence of a non-nucleophilic base (e.g., a strong non-nucleophilic base such as Zn(HMDS)₂, Zn(TMP)₂, alkyl zinc, or lithium agent including, but not limited to, LDA, LiHMDS, LiTMP with or without the aid of alkylzinc). In certain embodiments, the non-nucleophilic base is Lithium diisopropylamide (LDA). In certain embodiments, N, N-diisopropylamine and n-Butyllithium are added to provide the non-nucleophilic base. In certain embodiment, the non-nucleophilic base (e.g., LDA) is provided in a temperature range of about −95° C. to −65° C. In certain embodiments, the temperature is about −90° C. to −70° C. In certain embodiments, the temperature is about −85° C. to −75° C. In certain embodiments, the temperature is about −90° C., −85° C., −80° C., −75° C. or −70° C. In certain embodiments, the temperature is about −78° C.

In certain embodiments, a metal enolate of compound 7 (e.g., lithium enolate of compound 7) is formed by reacting the provided LDA with compound 7 in a time range of about 0.2 h to 6 h. In certain embodiments, the reaction time is about 0.5 h to 4 h. In certain embodiments, the reaction time is about 1 h to 3 h. In certain embodiments, the reaction time is about 0.5 h, 1 h, 1.5 h, 2 h, 3 h, 4 h or 5 h. In certain embodiments, the reaction time is about 1.5 h.

In certain embodiments, compound 7 or a metal enolate of compound 7 (e.g., lithium enolate of compound 7) reacts with compound 13 in a temperature range of about −35° C. to 35° C. In certain embodiments, the temperature is about 10° C. to 30° C. In certain embodiments, the temperature is about 15° C. to 25° C. In certain embodiments, the temperature is about 30° C., 25° C., 20° C., 15° C. or 10° C. In certain embodiments, the temperature is about 25° C.

In certain embodiments, compound 7 or a metal enolate of compound 7 (e.g., lithium enolate of compound 7) reacts with compound 13 in a temperature range of about −35° C. to −5° C. In certain embodiments, the temperature is about −30° C. to −10° C. In certain embodiments, the temperature is about −25° C. to −15° C. In certain embodiments, the temperature is about −30° C., −25° C., −20° C., −15° C. or −10° C. In certain embodiments, the temperature is about −20° C.

In certain embodiments, compound 7 or a metal enolate of compound 7 (e.g., lithium enolate of compound 7) reacts with compound 13 in a time range of about 0.5 h to 16 h. In certain embodiments, the reaction time is about 8 h to 14 h. In certain embodiments, the reaction time is about 10 h to 12 h. In certain embodiments, the reaction time is about 8 h, 9 h, 10 h, 1 1 h, 12 h, 13 h or 14 h. In certain embodiments, the reaction time is about 12 h. In certain embodiments, the reaction of compound 7 or metal enolate of compound 7 with compound 13 is stopped by a salt or weak acid. In certain embodiments, the salt or weak acid is NH₄Cl (e.g., saturated aqueous NH₄C₁).

In certain embodiments, the method or reaction of preparing compound 14 proceeds in a polar solvent. In certain embodiments, the solvent is a polar aprotic solvent. In certain embodiments, the solvent is tetrahydrofuran (THF). In certain embodiments, the solvent further comprises a nonpolar solvent component. In certain embodiments, the nonpolar solvent component is hexane.

Certain embodiments of the invention also provide a method of preparing dihydrodeoxyradicinin. Certain embodiments of the invention provide a method of preparing compound 14 as described above, further comprising (b′) converting compound 14 to 4-hydroxy-6-propyl-2H-pyran-2-one (compound 15) and (c′) converting compound 15 to dihydrodeoxyradicinin (compound 3).

In certain embodiments, step (b′) proceeds in a non-polar solvent (e.g., toluene) under reflux.

In certain embodiments, step (c′) comprises reacting compound 15 with a C₄ alkenoyl (CH₃CHCHC(═O)) donor compound. In certain embodiments, the C₄ alkenoyl (CH₃CHCHC(═O)) donor compound is crotonic acid or a crotonoyl halide (e.g., crotonoyl chloride). In certain embodiments, step (c′) proceeds in the presence of a salt (e.g., metal chloride such as ZnCl₂ or TiCl₄) and/or phosphoryl chloride (POCl₃).

### Certain Compounds of the Invention

Certain embodiments of the invention also provide a compound as described herein. For example, certain embodiments of the invention provide a compound of formula (4):

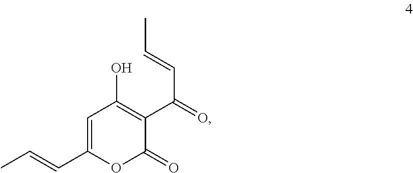 [SMILES: C/C=C/C(=O)c1c(O)cc(/C=C/C)oc1=O]

or a salt thereof.

Certain embodiments of the invention also provide a composition comprising a compound of formula (4) or a salt thereof, and a carrier. In certain embodiments, the composition further comprises at least one additional compound selected from the group consisting of radicinin, deoxyradicinin, dihydrodeoxyradicinin, cladosporol A, cladosporol C, cladosporol D and epicoccamide A, or a salt thereof. In certain embodiments, the composition further comprises at least one additional compound selected from the group consisting of cladosporol A, cladosporol C, cladosporol D, and/or epicoccamide A, or a salt thereof. In certain embodiments, the composition further comprises an additional therapeutic agent, such as a compound described herein or an antibiotic agent.

### Certain Definitions

The following definitions are used, unless otherwise described: halo or halogen is fluoro, chloro, bromo, or iodo. Alkyl, alkoxy, alkenyl, alkynyl, etc. denote both straight and branched groups; but reference to an individual radical such as propyl embraces only the straight chain radical, a branched chain isomer such as isopropyl being specifically referred to.

The term “alkyl”, by itself or as part of another substituent, means, unless otherwise stated, a straight or branched chain hydrocarbon radical, having the number of carbon atoms designated (i.e., C₁₋₈ means one to eight carbons). Examples include (C₁-C₈)alkyl, (C₂-C₈)alkyl, (C₁-C₆)alkyl, (C₂-C₆)alkyl and (C₃-C₆)alkyl. Examples of alkyl groups include methyl, ethyl, n-propyl, iso-propyl, n-butyl, t-butyl, iso-butyl, sec-butyl, n-pentyl, n-hexyl, n-heptyl, n-octyl, and and higher homologs and isomers.

The term “alkenyl” refers to an unsaturated alkyl radical having one or more double bonds. Examples of such unsaturated alkyl groups include vinyl, 2-propenyl, crotyl, 2-isopentenyl, 2-(butadienyl), 2,4-pentadienyl, 3-(1,4-pentadienyl) and the higher homologs and isomers.

As described herein, (C₂-C₄)alkanoyl is ((C₁-C₃)alkyl)-C(═O)—. For example, (C₂-C₄)alkanoyl can be acetyl, propanoyl or butanoyl.

The term “aryl” as used herein refers to a single all carbon aromatic ring or a multiple condensed all carbon ring system wherein at least one of the rings is aromatic. For example, in certain embodiments, an aryl group has 6 to 20 carbon atoms, 6 to 14 carbon atoms, 6 to 12 carbon atoms, or 6 to 10 carbon atoms. Aryl includes a phenyl radical. Aryl also includes multiple condensed carbon ring systems (e.g., ring systems comprising 2, 3 or 4 rings) having about 9 to 20 carbon atoms in which at least one ring is aromatic and wherein the other rings may be aromatic or not aromatic (i.e., cycloalkyl. The rings of the multiple condensed ring system can be connected to each other via fused, spiro and bridged bonds when allowed by valency requirements. It is to be understood that the point of attachment of a multiple condensed ring system, as defined above, can be at any position of the ring system including an aromatic or a carbocycle portion of the ring. Non-limiting examples of aryl groups include, but are not limited to, phenyl, indenyl, indanyl, naphthyl, 1, 2, 3, 4-tetrahydronaphthyl, anthracenyl, and the like.

The term “heterocycle” refers to a single saturated or partially unsaturated ring that has at least one atom other than carbon in the ring, wherein the atom is selected from the group consisting of oxygen, nitrogen and sulfur; the term also includes multiple condensed ring systems that have at least one such saturated or partially unsaturated ring, which multiple condensed ring systems are further described below. Thus, the term includes single saturated or partially unsaturated rings (e.g., 3, 4, 5, 6 or 7-membered rings) from about 1 to 6 carbon atoms and from about 1 to 3 heteroatoms selected from the group consisting of oxygen, nitrogen and sulfur in the ring. The sulfur and nitrogen atoms may also be present in their oxidized forms. Exemplary heterocycles include but are not limited to azetidinyl, tetrahydrofuranyl and piperidinyl. The term “heterocycle” also includes multiple condensed ring systems (e.g., ring systems comprising 2, 3 or 4 rings) wherein a single heterocycle ring (as defined above) can be condensed with one or more groups selected from cycloalkyl, aryl, and heterocycle to form the multiple condensed ring system. The rings of the multiple condensed ring system can be connected to each other via fused, spiro and bridged bonds when allowed by valency requirements. It is to be understood that the individual rings of the multiple condensed ring system may be connected in any order relative to one another. It is also to be understood that the point of attachment of a multiple condensed ring system (as defined above for a heterocycle) can be at any position of the multiple condensed ring system including a heterocycle, aryl and carbocycle portion of the ring. In one embodiment the term heterocycle includes a 3-15 membered heterocycle. In one embodiment the term heterocycle includes a 3-10 membered heterocycle. In one embodiment the term heterocycle includes a 3-8 membered heterocycle. In one embodiment the term heterocycle includes a 3-7 membered heterocycle. In one embodiment the term heterocycle includes a 3-6 membered heterocycle. In one embodiment the term heterocycle includes a 4-6 membered heterocycle. In one embodiment the term heterocycle includes a 3-10 membered monocyclic or bicyclic heterocycle comprising 1 to 4 heteroatoms. In one embodiment the term heterocycle includes a 3-8 membered monocyclic or bicyclic heterocycle heterocycle comprising 1 to 3 heteroatoms. In one embodiment the term heterocycle includes a 3-6 membered monocyclic heterocycle comprising 1 to 2 heteroatoms. In one embodiment the term heterocycle includes a 4-6 membered monocyclic heterocycle comprising 1 to 2 heteroatoms. Exemplary heterocycles include, but are not limited to aziridinyl, azetidinyl, pyrrolidinyl, piperidinyl, homopiperidinyl, morpholinyl, thiomorpholinyl, piperazinyl, tetrahydrofuranyl, dihydrooxazolyl, tetrahydropyranyl, tetrahydrothiopyranyl, 1,2,3,4- tetrahydroquinolyl, benzoxazinyl, dihydrooxazolyl, chromanyl, 1,2-dihydropyridinyl, 2,3-dihydrobenzofuranyl, 1,3-benzodioxolyl, 1,4-benzodioxanyl, spiro[cyclopropane-1,1′-isoindolinyl]-3′-one, isoindolinyl-1-one, 2-oxa-6-azaspiro[3.3]heptanyl, imidazolidin-2-one imidazolidine, pyrazolidine, butyrolactam, valerolactam, imidazolidinone, hydantoin, dioxolane, phthalimide, and 1,4-dioxane

As used herein, the term “heteroatom” is meant to include oxygen (O), nitrogen (N), sulfur (S) and silicon (Si).

The terms “inhibit” and “inhibition” may refer to, e.g., a reduction in the growth rate of bacteria (e.g., CLas or L. crescens), reduced or limited expansion/growth of a bacterial colony, reduced bacterial viability, or cell or organism death.

The terms “introduce” and “introduction” refers to contacting a plant, or a portion thereof, either directly or indirectly with an agent (e.g., a compound, microbe or composition described herein). For example, an agent may be directly applied to the plant, or a portion thereof (e.g., seed, seedling, leaf, stem or root) and/or indirectly applied to the surrounding ecosystem adjacent to the plant (e.g., water, air or soil, such as a planting bed). In certain embodiments, the plant or the surrounding ecosystem is sprayed with the agent. In certain embodiments, the plant or a portion thereof is coated with the agent (e.g., a rootstock is dipped in the agent). In certain embodiments, the agent is administered or delivered to the plant or the surrounding ecosystem (e.g., via injection). In certain embodiments, an agent may be applied to a plant or seed through the use of a suitable coating mechanism or binder prior to the seeds or plants being sold into commerce for planting. The process of coating seeds and plants is also generally well known to those skilled in the art. For example, the agent may be mixed with a porous, chemically inert granular carrier as described by U.S. Pat. No. 4,875,921. In certain embodiments, the agent is introduced to the plant or its surroundings to increase its present concentration (e.g., to increase the concentration of the agent to be higher than a preexisting naturally occurring level or concentration of the agent, if any, in the plant or its surrounding that previously failed to be inhibitory).

The term “bioinoculant” refers to a population of live cells of single or multiple organisms present in a viable form, which can be introduced to a plant to inhibit microbe growth (e.g., bacterial growth) or promote plant growth/productivity.

The terms “treat” and “treatment” refer to both therapeutic treatment and prophylactic or preventative measures, wherein the object is to prevent or slow down (lessen) an undesired physiological change or disorder in a plant. For purposes of this invention, beneficial or desired results include, but are not limited to, alleviation of symptoms, diminishment of extent of disease, stabilized (i.e., not worsening) state of disease, delay or slowing of disease progression, amelioration or palliation of the disease state, and remission (whether partial or total), whether detectable or undetectable. “Treatment” can also mean prolonging survival of the plant as compared to expected survival if not receiving treatment. Plants in need of treatment include those already with the condition or disorder as well as those prone to have the condition or disorder or those in which the condition or disorder is to be prevented.

The phrase “therapeutically effective amount” means an amount of a compound of the present invention that (i) treats the particular disease, condition, or disorder, (ii) attenuates, ameliorates, or eliminates one or more symptoms of the particular disease, condition, or disorder, or (iii) prevents or delays the onset of one or more symptoms of the particular disease, condition, or disorder described herein.

Each one of straight dashed lines in structural formula are independently present or absent. For non-limiting examples, formula I can be formula Ia, formula Ib, formula Ic, formula Id or formula Ie, etc.

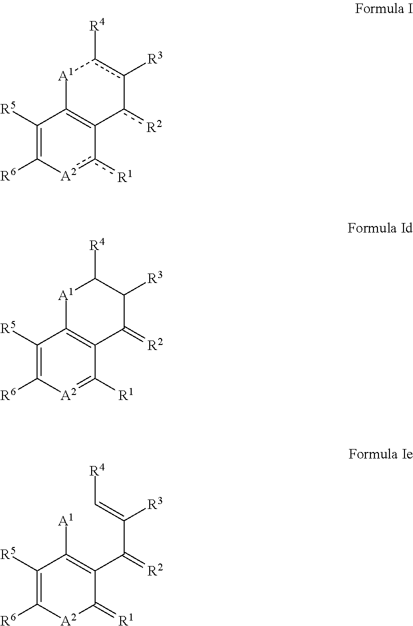

Stereochemical definitions and conventions used herein generally follow S. P. Parker, Ed., McGraw-Hill Dictionary of Chemical Terms (1984) McGraw-Hill Book Company, New York; and Eliel, E. and Wilen, S., “Stereochemistry of Organic Compounds”, John Wiley & Sons, Inc., New York, 1994. The compounds of the invention can contain asymmetric or chiral centers, and therefore exist in different stereoisomeric forms. It is intended that all stereoisomeric forms of the compounds of the invention, including but not limited to, diastereomers, enantiomers and atropisomers, as well as mixtures thereof such as racemic mixtures, form part of the present invention. Many organic compounds exist in optically active forms, i.e., they have the ability to rotate the plane of plane-polarized light. In describing an optically active compound, the prefixes D and L, or R and S, are used to denote the absolute configuration of the molecule about its chiral center(s). The prefixes d and 1 or (+) and (−) are employed to designate the sign of rotation of plane-polarized light by the compound, with (−) or 1 meaning that the compound is levorotatory. A compound prefixed with (+) or d is dextrorotatory. For a given chemical structure, these stereoisomers are identical except that they are mirror images of one another. A specific stereoisomer can also be referred to as an enantiomer, and a mixture of such isomers is often called an enantiomeric mixture. A 50:50 mixture of enantiomers is referred to as a racemic mixture or a racemate, which can occur where there has been no stereoselection or stereospecificity in a chemical reaction or process. The terms “racemic mixture” and “racemate” refer to an equimolar mixture of two enantiomeric species, devoid of optical activity.

It will be appreciated by those skilled in the art that certain compounds described herein have a chiral center may exist in and be isolated in optically active and racemic forms. Some compounds may exhibit polymorphism. It is to be understood that the present invention encompasses any racemic, optically-active, polymorphic, or stereoisomeric form, or mixtures thereof, of a compound of the invention, which possess the useful properties described herein, it being well known in the art how to prepare optically active forms (for example, by resolution of the racemic form by recrystallization techniques, by synthesis from optically-active starting materials, by chiral synthesis, or by chromatographic separation using a chiral stationary phase).

When a bond in a compound formula herein is drawn in a non-stereochemical manner (e.g. flat), the atom to which the bond is attached includes all stereochemical possibilities. For example, in certain embodiments, all stereochemical possibilities are included for the following compounds:

| Compound | Structure |
|---|---|
| Cladosporol C | 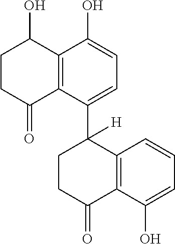 [SMILES: O=C1CCC(c2ccc(O)c3c2C(=O)CCC3O)c2cccc(O)c21] |
| Cladosporol A | 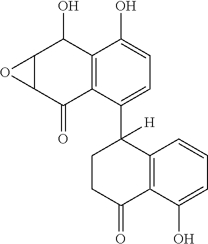 [SMILES: O=C1CCC(c2ccc(O)c3c2C(=O)C2OC2C3O)c2cccc(O)c21] |
| Cladosporol D | 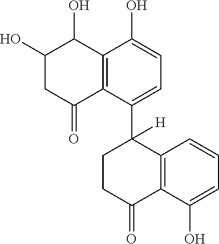 [SMILES: O=C1CCC(c2ccc(O)c3c2C(=O)CC(O)C3O)c2cccc(O)c21] |
| Epicoccamide A | 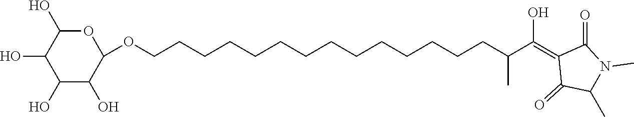 [SMILES: CC(CCCCCCCCCCCCCCOC1OC(O)C(O)C(O)C1O)/C(O)=C1\C(=O)C(C)N(C)C1=O] |
| Radicinin | 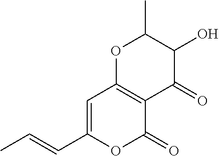 [SMILES: C/C=C/c1cc2c(c(=O)o1)C(=O)C(O)C(C)O2] |
| acetylradicinin | 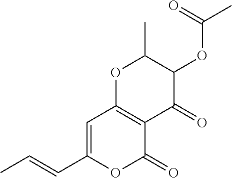 [SMILES: C/C=C/c1cc2c(c(=O)o1)C(=O)C(OC(C)=O)C(C)O2] |
| 2s,3s,4s-radicinol | 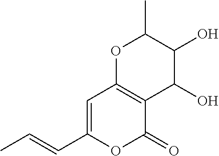 [SMILES: C/C=C/c1cc2c(c(=O)o1)C(O)C(O)C(C)O2] |
| 2s,3s,4s-epi-radicinol | 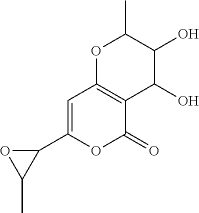 [SMILES: CC1OC1c1cc2c(c(=O)o1)C(O)C(O)C(C)O2] |

When a bond in a compound formula herein is drawn in a defined stereochemical manner (e.g. bold, bold-wedge, dashed or dashed-wedge), it is to be understood that the atom to which the stereochemical bond is attached is enriched in the absolute stereoisomer depicted unless otherwise noted. In one embodiment, the compound may be at least 5100 the absolute stereoisomer depicted. In another embodiment, the compound may be at least 60% o the absolute stereoisomer depicted. In another embodiment, the compound may be at least 80% o the absolute stereoisomer depicted. In another embodiment, the compound may be at least 90% o the absolute stereoisomer depicted. In another embodiment, the compound may be at least 95 the absolute stereoisomer depicted. In another embodiment, the compound may be at least 9900 the absolute stereoisomer depicted. For example, in certain embodiments, the atom to which the stereochemical bond is attached is enriched in the absolute stereoisomer depicted for the following compounds:

| Compound | Structure |
|---|---|
| (22) (cladosporol C embodiment) | 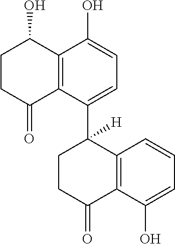 [SMILES: O=C1CC[C@@H](c2ccc(O)c3c2C(=O)CC[C@@H]3O)c2cccc(O)c21] |
| (21) (cladosporol A embodiment) | 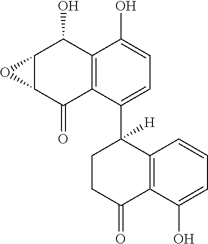 [SMILES: O=C1CC[C@@H](c2ccc(O)c3c2C(=O)[C@@H]2O[C@@H]2[C@@H]3O)c2cccc(O)c21] |
| (23) (cladosporol D embodiment) | 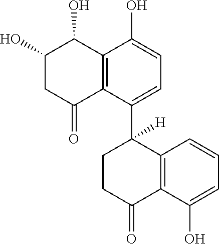 [SMILES: O=C1CC[C@@H](c2ccc(O)c3c2C(=O)C[C@H](O)[C@@H]3O)c2cccc(O)c21] |
| (24) (epicoccamide A embodiment) | 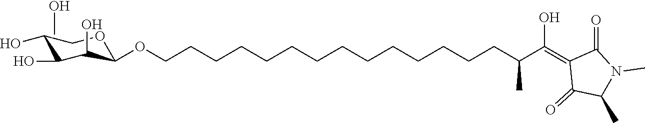 |
| (1) (radicinin embodiment) | 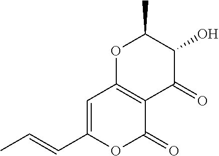 [SMILES: C/C=C/c1cc2c(c(=O)o1)C(=O)[C@@H](O)[C@H](C)O2] |
| (17) (acetylradicinin embodiment) | 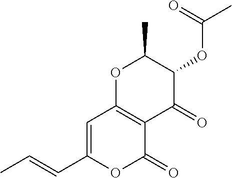 [SMILES: C/C=C/c1cc2c(c(=O)o1)C(=O)[C@@H](OC(C)=O)[C@H](C)O2] |
| (18) (2s,3s,4s-radicinol embodiment) | 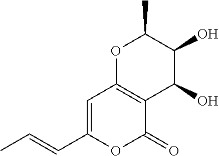 [SMILES: C/C=C/c1cc2c(c(=O)o1)[C@H](O)[C@H](O)[C@H](C)O2] |
| (19) (2s,3s,4s-epi- radicinol embodiment) | 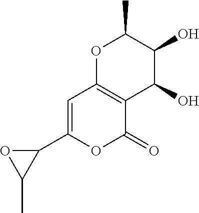 [SMILES: CC1OC1c1cc2c(c(=O)o1)[C@H](O)[C@H](O)[C@H](C)O2] |

The invention will now be illustrated by the following non-limiting Examples.

### Example 1. Development of an In Vitro Pipeline to Screen and Select Citrus-Associated Microbiota with Potential Anti-Candidatus Liberibacter asiaticus Properties

### Abstract

Huanglongbing (HLB) is a destructive citrus disease that is lethal to all citrus varieties making it the most serious citrus disease and one of the most serious plant diseases. Because of the severity of HLB and the paucity of effective chemical control measures, we structured this study to encompass the entirety of the citrus microbiome and the chemistries associated with that microbial community. The objective was to describe the spatial niche diversity of bacteria and fungi associated with citrus roots, stems and leaves using traditional microbial culturing methods integrated with culture-independent methods. Using the culturable sector of the citrus microbiome, we created a microbial repository using a high-throughput bulk culturing and microbial identification pipeline. We developed an in vitro agar-diffusion inhibition bioassay that queried the repository for antimicrobial activity against Liberibacter crescens, a culturable surrogate for the non-culturable Candidatus Liberibacter asiaticus bacterium associated with HLB. We identified microbes with robust inhibitory activity against L. crescens that include the bacteria Pantoea agglomerans and the fungi Cladosporium cladosporioides and Epicoccum nigrum. Bioassay-guided fractionation of organic extracts of C. cladosporioides and E. nigrum yielded the natural products cladosporols A (21), C (22) and D (23) (from C. cladosporioides) and epicoccamide A (24) (from E. nigrum) as the major compounds in fractions active against L. crescens. This work serves as a foundation for unraveling the complex chemistries associated with the citrus microbiome to begin to understand functional roles of members of the microbiome with the long-term goal of developing anti-CLas bioinoculants that thrive in the citrus holosystem.

### Introduction

A diverse community of microorganisms are associated with plants, collectively referred to as a plant's microbiome, and includes the collection of microbes associated with the rhizosphere (the soil-root interface), the phyllosphere (epiphytic, aerial surfaces) and the endosphere (internal tissues) (Turner T R, et al. 2013. Genome Biol 14:209). Spatial and environmental factors as well as host immunity and microbe-microbe interactions can shape the community structure of the microbiomes in these plant compartments (Lebeis S L, et al. 2015. Science 349:860-864; Durán P, et al. 2018. Cell 175:973-983.e14; Coleman-Derr D, et al. 2016. New Phytol 209:798-811; and Naylor D, et al. 2017. Front Plant Sci 8:2223). Moreover, in any given diseased plant environment, microbial pathogens directly or indirectly interact with the collection of other microbes dwelling on or within that particular eukaryotic host as well as with the host itself. Because of the serious nature of the HLB epidemic and the lack of effective control measures, there is a renewed focus on the citrus microbiome and how it relates to the HLB disease phenotype that includes, but extends beyond CLas to encompass the entirety of the citrus microbial community and the chemistries associated with that microbial community (Ginnan N A, et al. 2018. Phytobiomes 2:64-70; Xu J, et al. 2018. Nat Commun 9:4894). Next generation sequencing (NGS) technologies have significantly increased our knowledge regarding the members of plant-associated microbiomes, including those of citrus. However, besides pathogens and some well-studied symbionts, the vast majority of the function of the plant microbiome is unknown, colloquially referred to as microbial “dark matter” (Dickson I. 2016. Nat Rev Gastroenterol Hepatol 14:3). Their intimate host associations suggest these microbes may possess enormous untapped potential for promoting plant health, but the inherent complexity of these communities and their associated chemistries complicate efforts to decipher their respective contributions (Schlaeppi K, et al. 2015. Mol Plant Microbe Interact 28:212-217; Lareen A, et al. 2016. Plant Mol Biol 90:575-587).

The next frontier in microbiome research is to move beyond microbial community profiling to define specific microbial contributions to phenotypes, such as plant health and disease outcomes (Phytobiomes Roadmap). These efforts are expedited by coupling big data sets derived from NGS technologies with reductionist experiments using microbial isolates in singlet or consortia that are derived from a given microbiome. Thus, establishing and maintaining culture collections alongside cognate culture-independent NGS datasets is a key component of unraveling the complexity of microbial functions within a host's microbiome and their roles in a given pathosystem. Technological advances that have enabled research in plant microbiomes have also allowed the field of microbial biocontrol to shift from single-agent control studies towards holistic, community-based investigations on the comprehensive microbiome of a given system (Berg G, et al. 2017. FEMS Microbiol Ecol 93(5)). However, the market for biocontrol agents or microbially derived natural product-based disease control applications is still heavily rooted in culture-dependent studies because the development of microbe-derived formulations for commercial purposes requires culturable isolates that can be scaled up to large scale fermentations. Thus, the integration of culture collections with culture-independent microbiome datasets is particularly relevant to the field of biocontrol and natural product-based disease control research.

The best examples of successful biocontrols are tailored to the environment in which they are being asked to perform and have the ability to thrive across healthy and diseased host environments and enduring biological control requires microbes that are adapted to changing host disease states as part of an integrated management strategy (Mazzola M, et al. 2017. Phytopathology 107:256-263). Rhizobium rhizogenes K84 (Kerr A. 1972. Journal of Applied Bacteriology 35: (3) 493-497) is the model of a successful integrated biocontrol agent and is used, along with the derived strain Rhizobium rhizogenes K1026 (Jones D A. 1989. Plant Disease 73 (1) 15-18), to combat infection of Agrobacterium tumefaciens in the rhizosphere of susceptible plants (Penyalver R, et al. 2000. Eur J Plant Pathol 106:801-810). This biocontrol agent was isolated from A. tumefaciens infested rhizospheres where these two microbes evolved to compete with one another through an elegant interaction mechanism that involves production of the antibiotic, agrocin 84, that allows R. rhizogenes to specifically inhibit virulent A. tumefaciens strains carrying specific Ti plasmids (Kerr A, et al. 1974. Physiological Plant Pathology. 4 (1), 37-40). A seemingly logical starting point for biocontrol bioprospecting efforts that mine from plant microbiomes would focus on healthy or asymptomatic hosts. However, utilizing the success of R. rhizogenes K84 and K1026 as a paradigm for development of an effective biocontrol agent, it has been proposed that bioprospecting for biocontrol candidates should also include microbiota from symptomatic hosts (Deyett E, et al. 2017. Phytobiomes Journal 1: 138-149; Ellis J G. 2017. Mol Plant Microbe Interact 30:190-193). A study in tomato also indicated that a pathogen-prevalent environment was a good source for isolating biocontrols for the vascular bacterial pathogen of solanaceous plants, Ralstonia solanacearum (Huang J, et al. 2013. Applied Soil Ecology 72: 79-84). Importantly, these conditions select for candidate biocontrol agents capable of sustaining themselves within the parameters of the diseased plant environment. Moreover, these microorganisms interface with the pathogen either directly or indirectly and are potentially under selective pressure to engage in competitive interactions with the pathogen.

The collective aims of this work were to map the spatial anatomy of the citrus microbiome in different tissue niches of the tree (leaves, stems and roots) and to mine those same niches for culturable microbiota to build a repository of citrus-associated microorganisms that dwell in the HLB-disease environment and screen this repository for potential anti-CLas bioinoculants. To accomplish this, we developed a high throughput culturing and taxonomic identification pipeline that allows rapid identification of large cohorts of culturable microbiota based on bulk culturing techniques augmented with amplicon-based NGS technologies without the initial need for laborious sub-culturing into pure culture. We then isolated a sub-set of these microbial cohorts into pure culture to create a repository of pure citrus microbial isolates. Operating under the premise that members of the citrus microbiome could be developed into HLB suppressors, we tested the hypothesis that members of the citrus microbiota can compete with CLas through antibiosis. Efforts to culture the CLas bacterium are ongoing and remain a large focus of the research community working on the HLB pathosystem (Silva M V M e., et al. Phytopathology July; 109(7):1092-1101). However, the bacterium remains unculturable making this a system that is not amenable to manipulation in vitro, which poses severe limitations on developing bioassays to screen compounds that target CLas directly. Because of this, we turned to L. crescens, the only cultivable species belonging to the Liberibacter genus that was originally isolated from papaya trees (Fagen J R, et al. 2014. Int J Syst Evol Microbiol 64:2461-2466; Jain M, et al. 2019 May. Phytopathology, doi: 10.1094/PHYTO-04-19-0129-R). L. crescens has also been detected in citrus, and several studies have established it as a suitable in vitro model organism for CLas (Naranjo E, et al. 2018. PHYTOPATHOLOGY p. 126-126; J R, et al. 2017. Candidatus Liberibacter crescens detected in citrus. Abstracts from the 5th International Research Conference on Huanglongbing Journal of Citrus Pathology 4). We developed a robust in vitro agar-diffusion inhibition bioassay that utilizes L. crescens as a target to identify citrus-associated bacteria and fungi that produce metabolites that inhibit its growth. This in vitro screening pipeline was validated by showing that the fractionated inhibitory extracts of natural products isolated from two L. crescens-antagonistic fungi maintained antimicrobial activities, thereby, providing foundational data for the development of native citrus microbiome-derived therapeutic methods with potential application in HLB management practices.

### Results

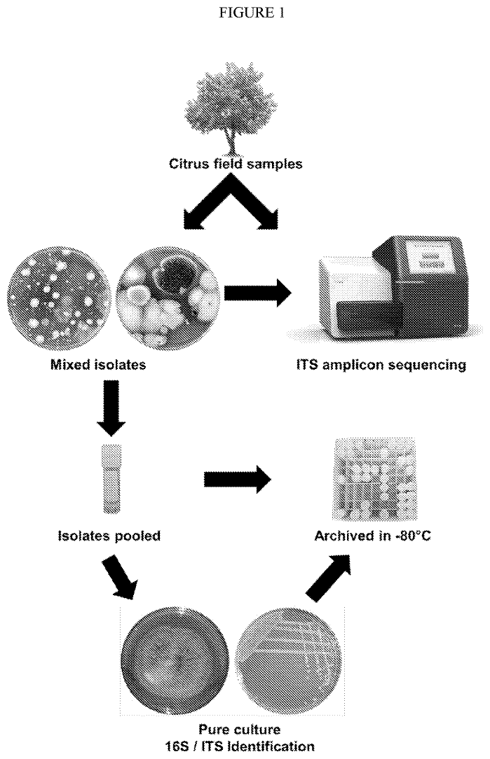

Accessing the culturable citrus microbiome using a high throughput bulk culturing pipeline. We utilized a bulk culturing pipeline to initially assign taxonomic classification to the microbes obtained from our culturing efforts before isolating them into pure culture (FIG. 1). Taxonomic assignment of the bulk cultures enabled us to obtain federal permits (P526P-18-01661 and P526P-17-04593) to import the bulk cultures that contained no known citrus pathogens as determined by the amplicon-based NGS analyses of both bacteria and fungi. We then performed the sub-culturing and isolation into pure culture in Riverside, Calif. (FIG. 1). Both the bulk cultures and individual isolates derived from the bulk cultures formed the basis of our culture repository.

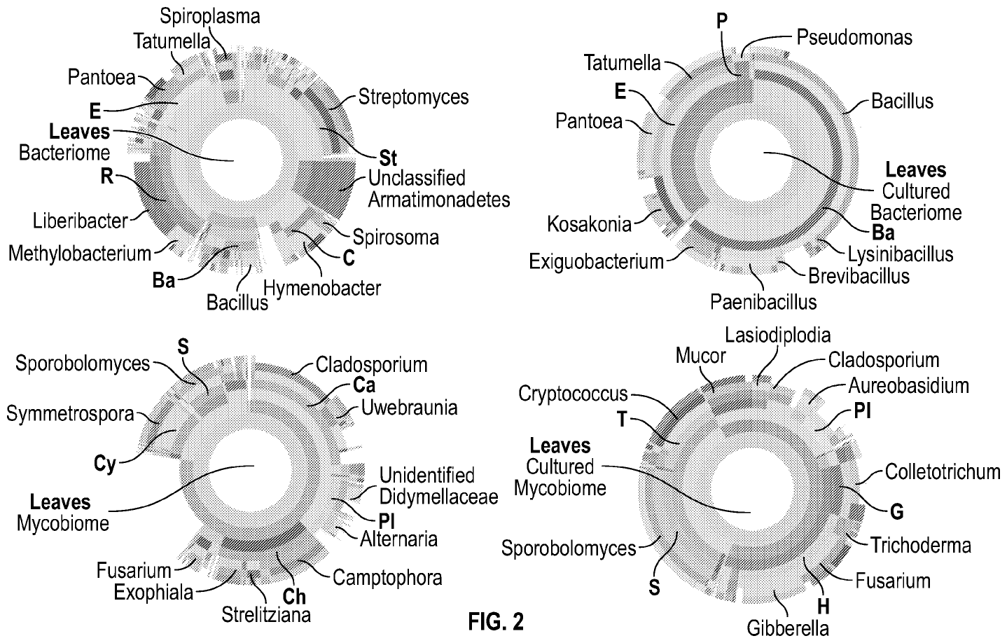

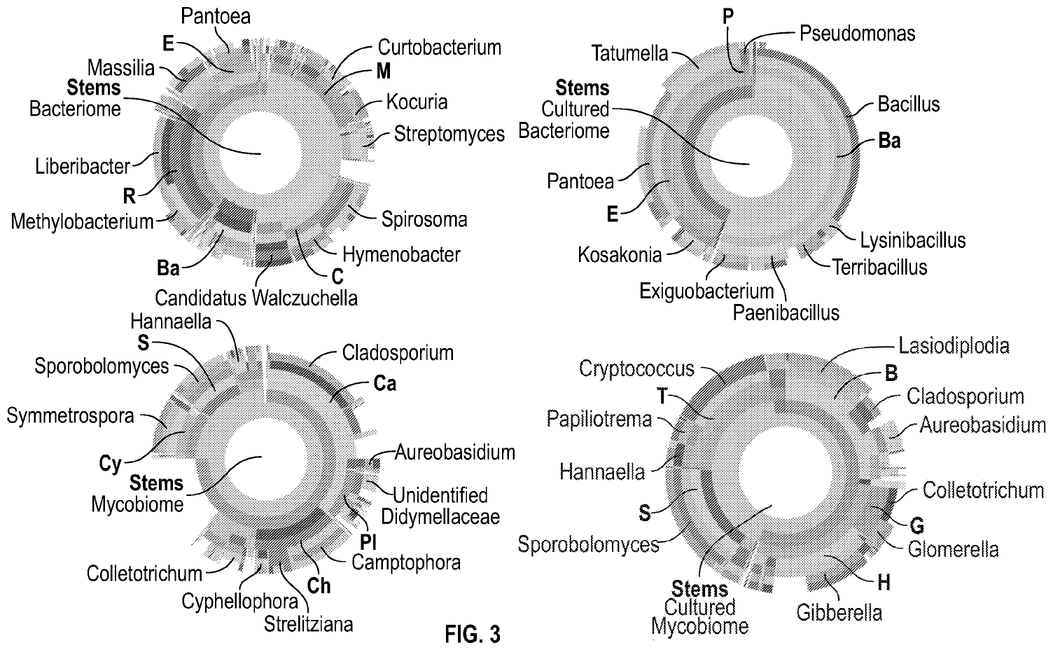

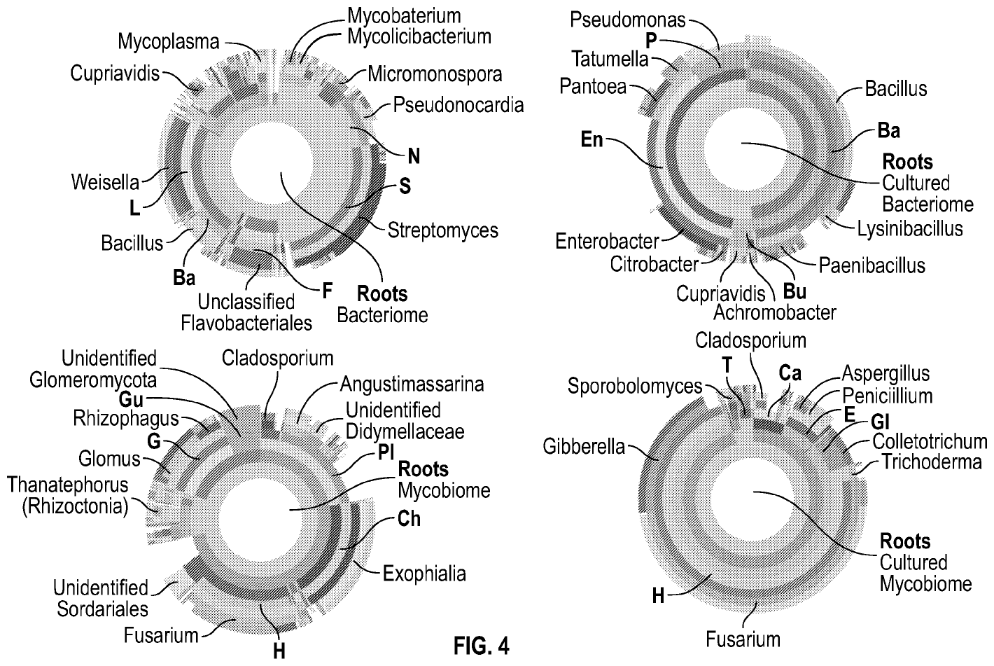

Spatial mapping of the culture-dependent and -independent citrus microbiome. Tissues were not surface sterilized prior to the culture-independent or culture-dependent protocols so taxa reported here represent epiphytic and endophytic microorganisms. After pruning low-abundance OTUs (average abundance<1 count across all samples) from amplicon-based NGS data of the bulk cultures, we obtained 863 OTUs in the cultured leaf bacteriome, 679 OTUs in the cultured stem bacteriome and 880 OTUs in the cultured root bacteriome from the archived bulk cultured samples. We obtained 467 OTUs in the cultured leaf mycobiome, 478 in the cultured stem mycobiome and 216 OTUs in the cultured root mycobiome from the archived bulk cultured samples (FIGS. 2, 3 and 4, Table 1). The five most abundant bacterial genera isolated in bulk cultures from leaves in terms of relative abundance were Bacillus (37.4%), Pantoea (12.3%), Tatumella (12.0%), Paenibacillus (8.6%) and Exiguobacterium (5.2%) (FIG. 2, Table 1). The five most abundant bacterial genera isolated in bulk cultures from the stem tissue in terms of relative abundance were Bacillus (34.7%), Pantoea (20.4%), Tatumella (12.5%), Paenibacillus (5.6%) and Exiguobacterium (5.0%) (FIG. 3, Table 1). The five most abundant bacterial genera isolated in bulk cultures from the roots in terms of relative abundance were Bacillus (28.5%), Enterobacter (11.1%), Pseudomonas (9.1%), Lysinibacillus (7.6%) and Paenibacillus (7.1%) (FIG. 4, Table 1). The five most abundant fungal genera isolated in bulk cultures from leaves in terms of relative abundance were Sporobolomyces (20.8%), Cryptococcus (10.5%), Gibberella (9.4%), Fusarium (9.2%) and Mucor (7.6%) (FIG. 2, Table 1). The five most abundant fungal genera isolated in bulk cultures from the stem tissue in terms of relative abundance were Sporobolomyces (16.0%), Cryptococcus (14.1%), Lasiodiplodia (11.8%), Gibberella (8.9%) and Colletotrichum (4.9%) (FIG. 3, Table 1). The five most abundant fungal genera isolated in bulk cultures from the roots in terms of relative abundance were Fusarium (50.9%), Gibberella (19.7%), Colletotrichum (6.0%), Penicillium (3.8%) and Aspergillus (2.3%) (FIG. 4, Table 1).

The culture-independent data was obtained from the Ginnan et. al (2018) microbiome resource announcement, where it was partially described (Ginnan N A, et al. 2018. Phytobiomes 2:64-70). Here we describe it in more depth in the context of the citrus tissues from which it was derived and use it as a foundation to compare to the culturable citrus microbiome obtained from the same samples. In brief, after trimming away low-abundance OTUs (<1 average abundance per sample), leaf tissues contained 5326 bacterial OTUs, the stem tissues contained 4319 bacterial OTUs and the root tissues contained 8681 bacterial OTUs. The five most abundant bacterial genera in leaf tissues in terms of relative abundance in the culture-independent dataset were Liberibacter (12.2%), Streptomyces (11.8%), Unidentified Armatimonadetes (9.2%), Pantoea (5.4%), and Massilia (5.3%) (FIG. 2, Table 1). The five most abundant bacterial genera in the stem tissues from the culture-independent dataset in terms of relative abundance were Liberibacter (11.0%), Spirosoma (8.73%), Methylobacterium (7.6%), Hymenobacter (6.2%), and Massilia (5.7%) (FIG. 3, Table 1). The five most abundant bacterial genera in the root tissues from the culture-independent dataset in terms of relative abundance were Streptomyces (24.4%), Weisella (15.5%), Flavobacteriales (6.7%), Pseudonocardia (6.2%) and Bacillus (5.8%) (FIG. 4, Table 1). After trimming away low-abundance OTUs (<1 average abundance per sample), leaf tissues contained 1638 fungal OTUs, the stem tissues contained 1593 fungal OTUs and the root tissues contained 1663 fungal OTUs. The five most abundant fungal genera associated with the leaves in terms of relative abundance in the culture-independent dataset were Cladosporium (13.0%), Camptophora (9.3%), Symmetrospora (7.6%), Sporobolomyces (6.9%) and Exophiala (3.7%) (FIG. 2, Table 1). The five most abundant fungal genera associated with the stems in the culture-independent dataset in terms of relative abundance were Cladosporium (15.2%), Camptophora (9.2%), Sporobolomyces (9.0%), Symmetrospora (7.7%) and Strelitziana (3.2%) (FIG. 3, Table 1). The five most abundant fungal genera associated with the roots in the culture-independent dataset in terms of relative abundance were Exophiala (17.8%), Fusarium (16.9%), Glomus (8.0%), Unidentified Glomeromycota (6.1%) and Rhizophagus (4.1%) (FIG. 4, Table 1).

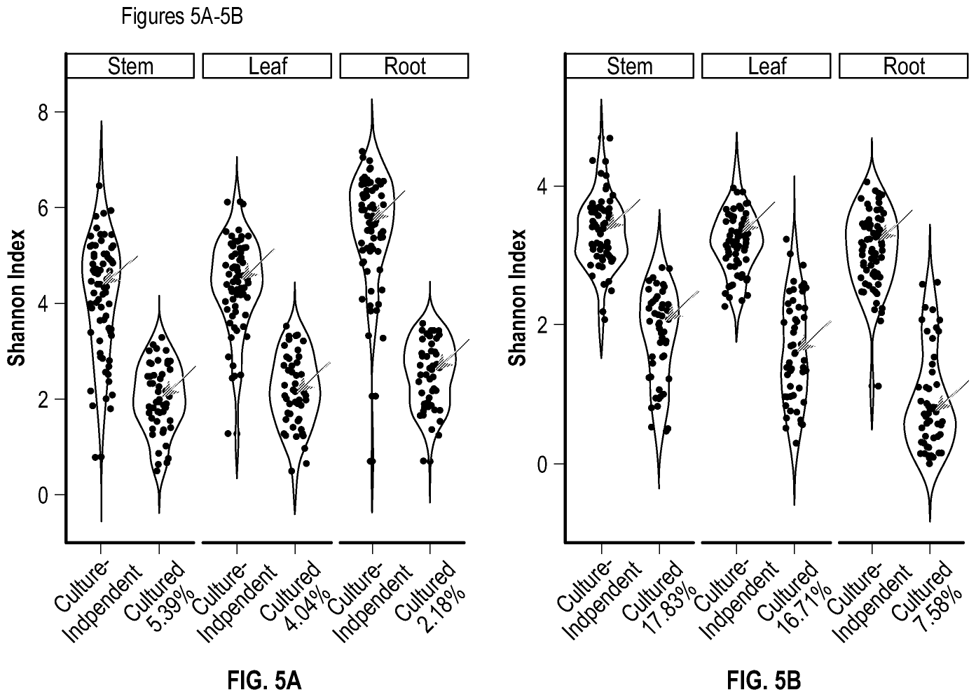

Representation of species richness in the cultured citrus microbiome. When compared to the culture-independent data from the field samples from which the cultures were derived, the cultured portion of the bacteriome represents 4.0% of the culture-independent taxa in the leaves, 5.4% of the culture-independent taxa in the stems and 2.2% of the culture-independent taxa in the roots. The cultured mycobiome captured in this study represents a higher percentage of fungal taxa present in the comprehensive microbiome than was represented for the bacterial taxa. Specifically, the cultured mycobiome represents 16.7% of the culture-independent taxa in the leaves, 17.8% of the culture-independent taxa in the stems and 7.6% of the culture-independent taxa in the roots. These data, taken together indicate that, not surprisingly, alpha diversity is significantly reduced when examining the culturable portion of the microbiome and this culture-imposed bottleneck was observed for each tissue type sampled (FIG. 5). p-values indicate significance of difference in alpha diversity between culture-independent and culture-dependent samples per tissue, obtained via Kruskal Wallis with post hoc Dunn test, using Bonferroni correction. Percent values indicate the proportion of culture-independent OTUs found in cultured microbiome samples.

Isolation and identification of individual microbial isolates. Considering that CLas is initially introduced by the Asian Citrus Psyllid into the aerial portion of the tree (in the new leaf growth (flush) of a citrus tree), we focused our sub-culturing to pure culture efforts on the aerial tissues of citrus (leaves and stems) for the identification of potential anti-CLas bioinoculants. The bacterial genera isolated into pure cultures from the leaf tissues include five Bacillus spp., eleven Pantoea spp., three Paenibacillus spp., four Erwinia spp., six Frigoribacterium spp., five Microbacterium spp., five Curtobacterium spp., one Stenotrophomonas sp. and one Pigmentiphaga sp. The individual bacterial isolates obtained from the bulk stem cultures include two Streptomyces spp., six Curtobacterium spp., five Pantoea spp. and six Microbacterium spp. All of these taxa were identified by percent homology to 16 s rDNA nucleotide sequences from specimens posted in the NCBI database. The fungal genera isolated into pure culture from leaves are three Purpureocillium spp., nine Cladosporium spp. and one Alternaria sp. The fungal genera isolated into pure culture from stems are one Colletotrichum sp., one Phoma sp., one Epicoccum sp., two Rhodotorula spp., one Cryptococcus sp. and one Pichia sp. All of these taxa were identified by percent homology to ITS rDNA nucleotide sequences from specimens posted in the NCBI database.

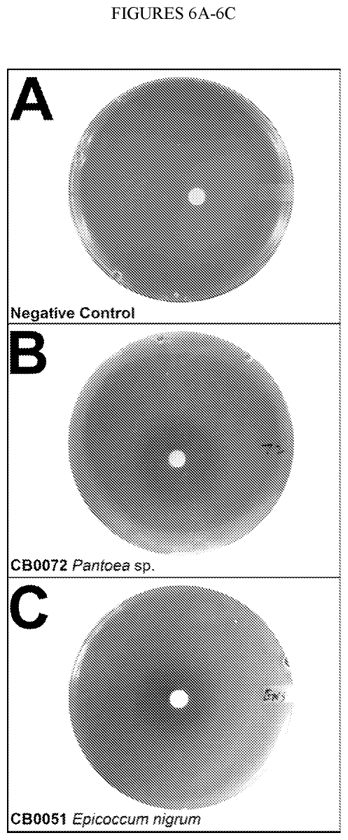

Identification of L. crescens-inhibitory microbes. Despite collective efforts to obtain CLas in axenic culture, CLas remains an unculturable microorganism (Silva M V M e., et al. Phytopathology July; 109(7):1092-1101). To screen our microbial library for competitive interactions with CLas, we utilized the culturable close relative, L. crescens, as a functional proxy for screening for microbial antagonists. We initially developed a solid agar-based bioassay using a dilution series of spectinomycin, an antibiotic known to inhibit the growth of L. crescens (Fagen J R, et al. 2014. Int J Syst Evol Microbiol 64:2461-2466). Once this assay was established, we then initiated testing crude supernatants obtained from our pure cultures in a medium throughput format. We identified supernatants from a subset of bacterial and fungal isolates that inhibit the growth of L. crescens evident by a zone of growth inhibition around the disc containing supernatants, indicating these isolates secrete antimicrobial secondary metabolites (FIG. 6). One bacterial strain possessed consistent inhibitory activity and belonged to the bacterial genera Pantoea with the highest species match to Pantoea agglomerans (leaf isolate designated CB0072 with an inhibition diameter size of 2.65±0.28 cm). The fungal inhibitory strains include isolates belonging to the genera Cladosporium and Epicoccum. Using fungal species-specific primers designed in this study, we identified two L. crescens inhibitory strains of Cladosporium to be C. cladosporioides (leaf isolates designated CF0052 and CF0053, with inhibition diameters of 3.40+0.32 cm and 2.58+0.38 cm, respectively) and one L. crescens inhibitory strain of Epicoccum to be E. nigrum (stem isolate designated CF0051 with inhibition diameter of 1.58+0.16 cm).

Bioassay-guided fractionation of bioactive organic extracts from Cladosporium cladosporioides and Epicoccum nigrum. To further define the properties of the inhibitory compounds in the crude supernatants, we focused natural product fractionation efforts on three fungi; C. cladosporioides (strains CF0052 and CF0053) and one isolate of E. nigrum. C. cladosporioides (CF0052 and CF0053) were propagated separately in Potato Dextrose broth (PDB) and the organic-soluble metabolites were extracted with ethyl acetate and designated the crude extract. The crude extract from CF0052 showed greater activity when compared to CF0053 in the L. crescens inhibition assay, so we fractionated the CF0052 extract using flash column chromatography (EtOAc: hexanes followed by dichloromethane: methanol eluent) and identified active fractions using the L. crescens inhibition assay. Fractions 3-5 all strongly inhibited L. crescens growth (at inhibition diameters of 6.0 cm, 6.4 cm and 5.7 cm, respectively). Nuclear magnetic resonance (NMR) spectroscopy and liquid chromatography-mass spectrometry (LCMS) of these fractions revealed fraction 3 to contain two major compounds, while fractions 4 and 5 appeared to be more complex mixtures. The ¹H NMR spectra of these fractions each contained one or more highly deshielded singlets (11.5-12.5 ppm) consistent with strongly hydrogen-bonded phenols. A search of the AntiMarin natural products database (Blunt, et al. 2012. AntiMarin Database. University of Canterbury: Christchurch, New Zealand, and University of Göttingen: Göttingen, Germany) for Cladosporium metabolites with phenols capable of such hydrogen bonding yielded 29 compounds; of these, cladosporols A (21, formula C₂₀H₁₆O₆) and C (22, formula C₂₀H₁₈O₅) (Nasini G, et al. 2004. Phytochemistry 65:2107-2111; Li H-L, et al. 2017. The Journal of Organic Chemistry 82, 19, 9946-9954) had molecular masses consistent with those observed in the LCMS data for fraction 3 (m z 351 [M−H]⁻ and 337 [M−H]⁻, respectively). Comparison of the ¹H and ¹³C NMR spectra for fraction 3 with the literature spectra for the cladosporols confirmed the identity of 21 and 22 as the major compounds in this fraction, in a roughly 2.5:1 ratio (FIG. 6). The NMR and LCMS data for fractions 4 and 5 suggest that these also contain 21 and 22, along with other yet-to-be-identified metabolites.

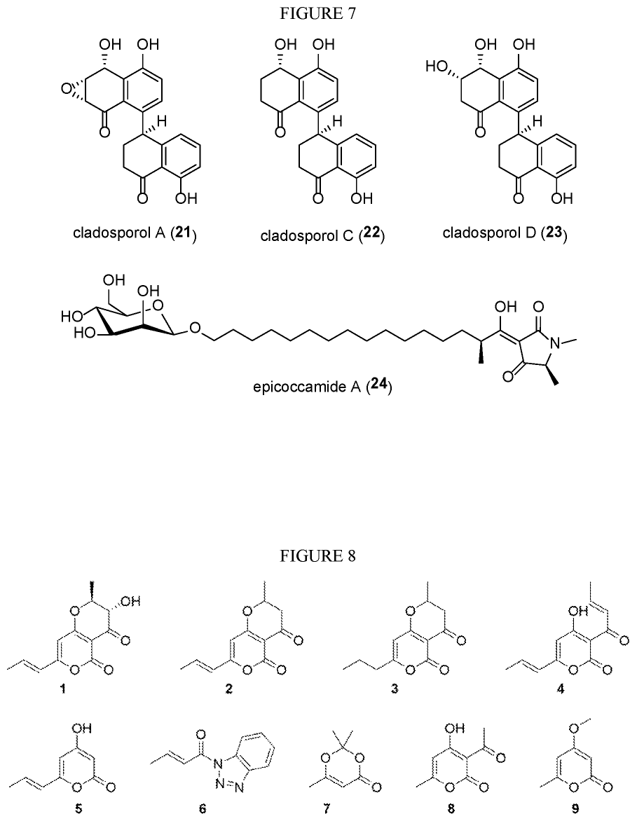

One isolate of E. nigrum was propagated in PDB and the organic-soluble metabolites were extracted with ethyl acetate. This crude extract was fractionated by flash column chromatography (EtOAc: hexanes followed by dichloromethane: methanol eluent) and the L. crescens inhibition assay was used to identify fractions 1, 2 and 8 as active (at inhibition diameters of 5.7 cm, 2.5 cm and 1.9 cm, respectively). Initial LCMS and NMR spectroscopic examination of the active fractions showed that fractions 1 and 2 still contain complex mixtures of compounds, while fraction 8 appeared to contain one major compound. The ¹H NMR spectrum of fraction 8 revealed characteristic peaks corresponding to a long acyl chain (tall, broad peak at 1.2 ppm), and a sugar moiety (cluster of multiplets from 3-4 ppm). A search of the AntiMarin natural products database (Blunt, et al. 2012. AntiMarin Database. University of Canterbury: Christchurch, New Zealand, and University of Göttingen: Göttingen, Germany) for Epicoccum metabolites containing both an acyl chain and a sugar yielded the epicoccamides as likely candidates. Of these, only epicoccamide A (24, formula C₂₀H₅₁NO₉) (Wright A D, et al. 2003. Org Biomol Chem 1:507-510) was consistent with the observed LCMS data for fraction 8 (m/z 556.28 [M−H]). Comparison of the ¹H and ¹³C NMR data for fraction 8 with literature values (Wangun H V K, et al. 2007. J Nat Prod 70:1800-1803; Wright A D, et al. 2003. Org Biomol Chem 1:507-510) permitted identification of the major compound in this fraction as 24 (FIG. 7).

### Discussion

Specific members or consortia of plant microbiomes can provide protection against plant pathogens through a variety of mechanisms ranging from niche displacement, production of antimicrobial compounds and activation of induced systemic resistance (Compant S, et al. 2010. Soil Biology and Biochemistry 42 (5) Pages 669-678; Rastogi G, et al. 2013. FEMS Microbiol Lett 348:1-10; Vorholt J A. 2012. Nat Rev Microbiol 10:828-840; Bolwerk A, et al. 2003. Mol Plant Microbe Interact 16:983-993; Gruau C, et al. 2015. Mol Plant Microbe Interact 28:1117-1129; Kloepper J W, et al. 1992. Biocontrol Science and Technology 2 (4) Pages 349-351; Pieterse C M, et al. 1996. Plant Cell 8:1225-1237). Assigning functional phenotypes, such as disease suppressive phenotypes, to members of the collective microbiome can be facilitated by reductionist experiments designed to understand the bioactive chemistries produced by an individual microbe or group of microbes that confers a functional phenotype. Because these reductionist experiments can facilitate mechanistic studies that probe questions related to the underlying biology of a system, culture collections are an important translational research tool that serve to bridge big NGS datasets with the behaviors of the biological entities described in those big datasets and enable critical inquiries into how specific microbes interact with other microbes and their eukaryotic host organisms (Huang Y-L, et al. 2018. Mycologia 110:47-62). For this study, we designed a pipeline that allowed us to assign taxonomy to bulk cultures obtained from different tissues of citrus. This conveniently expedited taxonomic assignments by initially bypassing the need to isolate into pure culture. Moreover, our methodology was also derived out of necessity to adapt to the logistics of working with citrus tissues infected with CLas in California. HLB has only recently been confirmed in California (2012) and prior to that the state was considered to be HLB-free (Kumagai L B, et al. 2013. Plant Dis 97:283). CLas is a quarantine pathogen for the state of California and, as such, scientists in California are not permitted to import citrus tissues containing live CLas. The tissue sampling and bulk culturing were performed in Florida where the bulk cultures were archived and stored while we built, sequenced and analyzed the NGS libraries in California with DNA extracted from the bulk cultures. Once taxonomy was assigned to the microorganisms archived in Florida and confirmed to contain no known pathogens of citrus, federal importation permits were obtained and the bulk cultures were imported to California and isolation to pure culture was initiated. Inherent to any culturing process, the artificial media and standard growth conditions we utilized in this study did impose a bottleneck on what was isolated from the respective tissue types and significantly reduced bacterial and fungal species richness when compared to the comprehensive microbiome. However, the citrus culture repository successfully captured many high abundance bacterial and fungal taxa that were identified in the culture independent dataset and represented a higher than expected percentage of the culture-independent data obtained from all tissue types sampled. Our citrus microbial collection has both metadata and barcode sequence available for each microbial isolate (Ginnan N A, et al. 2018. Phytobiomes 2:64-70) and we will continue to build the repository as we expand our collection sites to include other geographical regions. Future culturing expeditions will include targeted studies using a larger repertoire of culture media types to enhance species richness and diversity in the culture repository.

The second objective of this study was to develop a bioassay that could be utilized to screen microbes and their chemistries for novel anti-CLas activity. We adapted a bioassay that we developed for Xylella fastidiosa, the bacterial causal agent of Pierce's Disease of grapevine (Aldrich T J, et al. 2015. Phytochemistry 116:130-137), and used L. crescens as a surrogate to CLas to screen individual isolates for their ability to secrete metabolites that were able to curtail L. crescens growth as indicated by an inhibition zone around the disc containing extracts of spent supernatants obtained from propagating individual citrus-associated microbes in liquid cultures. This assay provides an efficient platform to pre-screen microbes, crude supernatant extracts, fractionated natural product extracts and purified natural product compounds in vitro before testing them in laborious and resource intensive in planta or insect studies that are currently necessary for screening compounds for anti-CLas activity. In addition, as the methodology is refined to successfully cultivate CLas, we will have a reservoir of natural product metabolites and microbes to put into an in vitro screening pipeline for once it sheds it ‘Candidatus’ status and is designated L. asiaticus (Merfa e Silva M V, et al. 2019. Phytopathology 109(7):1092-1101).

Among the bacteria screened in our cultured citrus microbiome, isolates from the genera Bacillus and Pantoea produced secreted compounds that inhibited L. crescens BT-1. Members of these genera are commonly plant-associated, known producers of secondary natural product metabolites, and both have shown efficacy as biological control agents in other fruit tree systems (Silimela M, et al. 2007. Crop Prot 26:1474-1481; Stockwell V O, et al. 2010. Phytopathology 100:1330-1339). Specifically, a variety of Bacillus spp. have shown efficacy in controlling pre- and post-harvest diseases of plants when applied directly as microbial bioinoculants (Bubici G, et al. 2019. Front Microbiol 10:616; Fira D, et al. 2018. J Biotechnol 285:44-55). In addition, there are B. subtilis-based commercial products that are formulations that blend the microbe and its secreted bioactive natural products (lipopeptides) produced by B. subtilis (Serenade products, Bayer Crop Science, Inc.). Bacillus spp. were one of the top five taxa in terms of relative abundance in the culture-independent citrus microbiome and owing to their rapid growth characteristics and amenability to growth in axenic culture, they appeared at high frequency as an output of our culturing pipeline and were among the most frequently isolated bacteria from all citrus tissue types. We also isolated Pantoea spp. from stems and leaves and one strain with highest taxonomic identity to P. agglomerans vagans was inhibitory to L. crescens in the agar diffusion assay. Both P. agglomerans and P. vagans are prevalent in cultivated crop systems (Walterson A M, et al. 2015. FEMS Microbiol Rev 39:968-984; Trivedi P, et al. 2011. Microb Ecol 62:324-336; Hartman K, et al. 2017. Microbiome 5:2) and have been used as biocontrol agents against plant diseases caused by bacteria, fungi and oomycetes (Walterson A M, et al. 2015. FEMS Microbiol Rev 39:968-984; Dutkiewicz J, et al. 2016. Ann Agric Environ Med 23:6-29). These two species of Pantoea have been developed into the commercial products, Bloomtime Biological FD Biopesticide (Verdesian Life Sciences) and BlightBan C9-1 (Nufarm, Inc.), respectively. P. vagans suppresses fire blight of pear and apple as a standalone treatment (Stockwell V O, et al. 2010. Phytopathology 100:1330-1339). In contrast, in other studies P. vagans was found to be ineffective at controlling fire blight in apple as a standalone treatment, but showed some efficacy when combined with streptomycin applications and reduced the number of streptomycin applications necessary to effectively suppress fire blight suggesting that they may be useful (Sundin G W, et al. 2009. Plant Dis 93:386-394). P. agglomerans strains produce antimicrobial peptides, pantocin and herbicolin that are linked to their ability to compete with pathogens (Smits T H M, et al. 2019. Arch Microbiol Volume 201, Issue 6, pp 713-722).

Confirmation of the chemical structures and identities of the bioactive molecules produced by the L. crescens-inhibitory Bacillus and Pantoea strains is ongoing, however, we validated our in vitro bioassay for screening bioactive natural compounds with fractionated inhibitory supernatants produced by the L. crescens inhibitory fungi, C. cladosporioides and E. nigrum. Fungi are known producers of a diversity of structurally distinctive compounds with antimicrobial properties and can be a key determinant to plant health (Aldrich T J, et al. 2015. Phytochemistry 116:130-137; Porras-Alfaro A, et al. 2011. Annu Rev Phytopathol 49:291-315; Pieterse C M J, et al. 2014. Annu Rev Phytopathol 52:347-375; Shoresh M, et al. 2010. Annu Rev Phytopathol 48:21-43). Individual citrus isolates of C. cladosporioides and E. nigrum curtailed the growth of L. crescens BT-1 in the agar diffusion inhibition assay. Cladosporium spp. are often identified as members of plant microbiomes can promote plant health by directly antagonizing pathogens through production of antimicrobial compounds or by producing plant growth promoting compounds (Bensch K, et al. 2012. Stud Mycol 72:1-401; Paul D, et al. 2013. Sensors 13:13969-13977). E. nigrum was also inhibitory to L. crescens and this genus includes many known plant endophytes and has been noted for its profuse secondary metabolic repertoire (Braga R M, et al. 2018. Crit Rev Microbiol 44:759-778). E. nigrum is also an effective biocontrol agent in several plant systems (Hashem M, et al. 2004. Archives of Phytopathology and Plant Protection 37:283-297). Most notably this fungus reduced symptom severity in periwinkle plants inoculated with the phloem dwelling, ‘Candidatus Phytoplasma mali’ indicating it interacts directly or indirectly with the phloem and, thus, may have some promise in combatting CLas in the phloem of citrus (Musetti R, et al. 2011. J Appl Microbiol 110:746-756). Interestingly, the genus is abundant in the citrus packing house environment (Braga R M, et al. 2018. Crit Rev Microbiol 44:759-778; Fischer I H, et al. 2008. Eur J Plant Pathol 123:449).

Many microbial natural products have been identified, purified and developed into antimicrobials, with prototypical examples of naturally derived antibiotics being penicillin produced by Penicillium and streptomycin being produced by Streptomycetes. Specific to the HLB pathosystem, the derived antimicrobial natural products, streptomycin sulfate (FireWall™ 50WP, AgroSource, Inc) and oxytetracycline hydrochloride (FireLine™ 17WP, AgroSource, Inc.) are being applied as spray applications to trees in Florida under Section 18 emergency registration in efforts to decrease pathogen titer and HLB severity. Microbial natural products can also serve as important starting points for bioactive drug discovery and synthesis pipelines. To initiate our work on anti-L. crescens natural product purification from citrus-associated microbes, we focused our efforts on the two L. crescens inhibitory fungi, C. cladosporioides and E. nigrum. Among the three most active fractions from C. cladosporioides, we found that one contained cladosporols A (21) and C (22) as major components, and that the other two (more complex) active fractions also contained 21 and 22 as minor components along with other unidentified metabolites. 21 was originally isolated from C. cladosporioides and identified as a P-glucan biosynthesis inhibitor (Sakagami Y, et al. 1995. Tetrahedron Letters Volume 36, Issue 9, Pages 1469-1472). 22 and several other cladosporols (including 21) were isolated from C. tenuissimum in an investigation of the biocontrol mechanism of this hyperparasite of rust fungus Uromyces appendiculatus (Nasini G, et al. 2004. Phytochemistry 65:2107-2111). The stereochemical configuration of 21 and 24 was revised in 2017, and each was shown to have modest antibacterial activity against the bacteria E. coli, Micrococcus luteus, Vibrio harveyi (Li H-L, et al. 2017. The Journal of Organic Chemistry 82, 19, 9946-9954), and MRSA (Yamazaki H, et al. 2018. TMPU1621. Tetrahedron Letters 59 (20) Pages 1913-1915). 21 has also attracted considerable interest as a PPARγ-mediated inhibitor of cancer cell proliferation (Yousefnia S, et al. 2018. Gene 649:14-22, and references therein). Of the most active fractions from E. nigrum, two are especially complex and require further separation before any compounds can be identified. The remaining active fraction was determined to contain epicoccamide A (24) as the major component. Originally isolated from a jellyfish-derived E. purpurascens, 24 was the first described member of an unusual family of tetramic acid natural products (Wright A D, et al. 2003. Org Biomol Chem 1:507-510; Wangun H V K, et al. 2007. J Nat Prod 70:1800-1803). Additional epicoccamides were isolated (along with 24 as the major metabolite) from an ‘endofungal’ Epicoccum sp. isolated from the fruit body of the tree fungus Pholiota squarosa (Wangun H V K, et al. 2007. J Nat Prod 70:1800-1803). The stereochemical configuration of 24 was determined by total synthesis (Yajima A, et al. 2014. Tetrahedron Letters 55(31):4350-4354). Interestingly, since its original isolation, 24 has been tested in a variety of bioassays with no observed activity. It showed no detectable antibiotic activity in agar diffusion assays against the bacteria Bacillus megaterium or E. coli. 24 also showed no antifungal, cytotoxic, nematicidal, antiplasmodial, antiproliferative, or enzyme-inhibitory activity (Wright A D, et al. 2003. Org Biomol Chem 1:507-510; Wangun H V K, et al. 2007. J Nat Prod 70:1800-1803). Given that the active fraction 8 from E. nigrum is not yet pure, it is possible that the observed antibiotic activity of this fraction may be due to 24 and/or an especially potent minor metabolite, and previous studies have shown that epicoccamides B-D are produced in much lower yield than 24 and show cytotoxicity and antiproliferative activity (Wangun H V K, et al. 2007. J Nat Prod 70:1800-1803).

Elucidating anti-pathogen chemistries produced by plant microbiome members will allow for future studies that test for enrichment of that potential disease suppressive function in a diseased plant environment. In the case of HLB, harnessing biologicals for control of HLB either through direct application of the microbe or its bioactive metabolites faces significant challenges because the pathogen is localized to the phloem, a difficult to access sector of the plant endosphere. Moreover, CLas is delivered directly to the phloem by its insect vector and has no known epiphytic phase. Thus, anti-CLas applications that require contact with the pathogen for efficacy likely require entry into the phloem. The next steps of this collective work are to assign anti-CLas activity to a single, purified natural product compound(s) produced by the inhibitory microbes identified in this study. Most importantly, assays designed to track transit pathways of those molecules in planta will identify which tissue compartments these compounds enter. It will also be pertinent to determine if the anti-CLas citrus-associated microbes identified in this study produce the anti-CLas metabolites in planta and if these microbes can be used directly as bioinoculants to mitigate HLB by acting as CLas suppressors or if their abundance in planta can be stimulated with specific cultural practices in order to curtail CLas. Our overall goal is to determine how the citrus-associated microbiome interfaces with the CLas pathogen, and eventually to understand the impact of microbial community composition on HLB outcomes. To do this, it was necessary to establish an in vitro assay to screen microbes and their natural product metabolites. In the long term, our findings will lay the foundation for exploring how we can develop new, sustainable plant disease mitigation strategies for commercial citriculture.

### Materials and Methods

Foliar, stem and root sampling. In 2016, stems, roots, and leaves from 50 trees were collected from 5 different citrus orchards in Florida. Each tree was divided into 4 quadrants (north, south, east, and west), stems with attached leaves were collected from each of the quadrants and pooled. Feeder roots were sampled from two sides of the tree. Topsoil from two sides of the tree and approximately 1.5 feet away from the base of the trunk near the irrigation line was removed and the feeder roots near this irrigation line were sampled, shaken to remove soil, and sealed in a plastic bag. Gloves were changed and clippers and shovels were sterilized with 30% household bleach between each tree that was sampled. All samples were immediately placed on ice for transit to the laboratory where they were placed at 4° C. and processed within 24 hours. DNA isolations were previously described in Ginnan et al. (2018). Briefly, 100 mg (roots, leaves) or 200 mg (stems) were pulverized via bead beating and processed using the MagMAX-96 DNA Multi-Sample Kit (Thermo Fisher Scientific), followed by DNA concentration assessment via Infinite M1000 Pro (Tecan, Männedorf, Switzerland) and SpeedVac concentration for dry storage at −20° C. prior to library construction.

Microbial Propagation for bulk culture collection. Root samples were rinsed twice with sterile water to remove surface soil. Approximately 0.3 g of feeder roots were placed into a mesh grinding bag (Agdia, Inc, Elkhart, Ind.) with 2.0 ml of 1× Phosphate Buffer Saline (PBS). The tissue was ground with a hammer and the resulting slurry was diluted 1:10 with 1×PBS. The leaves and stems (cut to 3-inch pieces) were processed in a similar manner, but with 3 ml of 1×PBS. 100 μl of the 1:10 diluted slurry was spread plated on two solid media types, Tryptic Soy Agar (TSA), and Potato Dextrose Agar with 0.1 g/L of tetracycline hydrochloride (PDA-tet). Plates were incubated at 28° C. for 4 days. The consortia of microbes on each plate had 1 ml of 1×PBS added directly to the culture plate and were subsequently scraped with a cell scraper. The suspension was stored as glycerol stocks (final glycerol concentration=25%) at −80° C. Simultaneously, 50 μL of this culture suspension in 1× PBS was used for DNA extraction using a MoBio DNeasy Powersoil Kit (Qiagen, Valencia, Calif.) with the manufacturer's recommended protocol.

Microbial taxa identification in mixed microbial cultures and plant tissue samples. NGS of the bacterial rRNA ITS region. DNAs extracted from the bulk cultures and DNAs extracted from the cognate citrus tissue samples were used to construct Illumina bacterial rRNA ITS libraries as described in Ginnan et al (2018). Bacterial NGS libraries were constructed from these DNAs as described in Ginnan et al (2018). NGS of the fungal ITS region. DNAs extracted from the bulk cultures and DNAs extracted from the cognate citrus tissue samples were used to construct Illumina fungal ITS libraries as described in Ginnan et al (2018).

NGS data analyses. Data processing for the bacterial data was performed with USEARCH v10.0 (Edgar, 2010). We used the UPARSE pipeline for de-multiplexing, length trimming, quality filtering and operational taxonomic unit (OTU) picking using default parameters or recommended guidelines that were initially described in (Edgar R C. 2013. Nat Methods 10:996-998) and which have been updated at www.drive5.com/usearch/manual10/uparse_pipeline.html. Briefly, after demultiplexing and using the recommended 1.0 expected error threshold, sequences were trimmed to a uniform length of 145 bp and then dereplicated. Dereplicated sequences were subjected to error-correction (denoised) and chimera filtering to generate zero-radius operational taxonomic units (ZOTUs) using UNOISE3 (Edgar R C. 2016. bioRxiv, doi.org/10.1101/081257). An OTU table was then generated using the otutab command. ZOTUs having non-bacterial DNA were identified and enumerated by performing a local BLAST search (Altschul S F, et al. 1990. J Mol Biol 215:403-410) of their seed sequences against the nucleotide database. ZOTUs were removed if any of their highest scoring BLAST hits contained taxonomic IDs within the citrus family, fungal kingdom, or PhiX. Taxonomic assignments to bacterial ZOTUs were made by finding the lowest common taxonomic level of the highest BLAST hits excluding unclassified designations. Data were normalized within each sample by dividing the number of reads in each OTU by the total number of reads in that sample.

Data processing for the fungal data was performed with USEARCH v10.0 (Edgar R C. 2010. Bioinformatics 26:2460-2461). We used the UPARSE pipeline for de-multiplexing, length trimming, quality filtering and operational taxonomic unit (OTU) picking using default parameters or recommended guidelines that were initially described in (Edgar R C. 2013. Nat Methods 10:996-998) and which have been updated at www.drive5.com/usearch/manual10/uparse_pipeline.html. Briefly, after demultiplexing and using the recommended 1.0 expected error threshold, sequences were trimmed to a uniform length of 249 bp and then dereplicated. Dereplicated sequences were subjected to error-correction (denoised) and chimera filtering to generate zero-radius operational taxonomic units (ZOTUs) using UNOISE3 (Edgar R C. 2016. bioRxiv doi.org/10.1101/081257). An OTU table was then generated using the otutab command. ZOTUs having non-fungal DNA were identified by performing a local BLAST search (Altschul S F, et al. 1990. J Mol Biol 215:403-410) of their seed sequences against the nucleotide database. ZOTUs were removed if any of their highest scoring BLAST hits contained taxonomic IDs within the Viridiplantae kingdom or PhiX. Taxonomic assignments to fungal ZOTUs were made using the RDP Classifier version 2.12 (Wang Q, et al. 2007. Appl Environ Microbiol 73:5261-5267), trained on the ver7_99_s_10.10.2017 release of the UNITE database (Kõljalg U, et al. 2013. Mol Ecol 22:5271-5277). Data were normalized within each sample by dividing the number of reads in each OTU by the total number of reads in that sample.

Taxonomy tables were generated using QIIME 1.9.1 (Caporaso J G, et al. 2010. Nat Methods 7:335-336) and analyzed using Prism (GraphPad, San Diego, Calif.). Alpha diversity plots were generated using the plot_diversity( ) function in the R package phyloseq. p-values indicate significance of difference in alpha diversity between culture-independent and culture-dependent samples per tissue, obtained via Kruskal Wallis with post hoc Dunn test, using Bonferroni correction. Sunburst plots for OTU abundance were generated using the R package sunburstR (McMurdie P J, et al. 2013. PLoS One 8:e61217; Mike Bostock, Kerry Rodden, et al. 2019 March. Package ‘sunburstR’). Percent values indicate the proportion of culture-independent OTUs found in cultured microbiome samples. The bacterial and fungal NGS datasets have been deposited in the National Center for Biotechnology Information (NCBI)'s Sequence Read Archive (SRA) under the SRA BioProject Accession Number PRJNA546069.

Pure cultures of single isolates. Isolates were initially recovered from individual glycerol or water collective culture tubes on both TSA and PDA plates at 28° C. for no longer than 5 days. For the bacteria, single colonies were struck onto fresh plates of TSA and sub-cultured until pure, isolated, individual colonies were obtained. For storage of pure bacterial cultures, single colonies were grown overnight in trypticase soy broth (TSB) shaken at 180 rpm and 28° C. Cultures were then stored in 15% (final concentration) sterile glycerol at −80° C. For the fungi, plugs of agar were drawn from the margin of growing colonies and sub-cultured until single fungal isolates were recovered. Individual fungal isolates were stored in 3 different ways: 1) streaked on PDA slants and grown at 28° C., 2) grown at 28° C. and harvested with sterile distilled water for water stocks stored at 4° C., and 3) grown at 28° C. and then the plates were allowed to dry out for the preparation of dry flakes for storage at −80° C.

Genus level identification. Genomic DNA of pure cultures were isolated by use of the DNeasy® Blood & Tissue Kit (Qiagen) or FastDNA™ Spin Kit for Soil (MP Biomedicals, LLC, Santa Ana, Calif.), both per manufacturer's instructions. Purified DNA was then sent for identification by Sanger Sequencing using universal primers 8F and 1492R (Turner S, et al. 1999. J Eukaryot Microbiol 46:327-338) at ID Genomics SPC (Seattle, Wash.) or underwent PCR with either 16S U1/U2 for bacteria (Barghouthi S A. 2011. Indian J Microbiol 51:430-444; Yamamoto S, et al. 1995. Appl Environ Microbiol 61:1104-1109) or ITS 1/ITS 4 for yeast and filamentous fungi (WHITE, JT. 1990. PCR Protocols: a Guide to Methods and Applications 315-322) using GXL, Prime Star DNA Polymerase (Takara). Thermal cycling parameters were 98° C. for 1 min; 30 cycles of 98° C. for 10 s, either 60° C. (for bacteria) or 55° C. (for fungi) for 15 s, and 68° C. for 2 min; followed by 68° C. for 5 minutes. The resulting PCR products were purified with a DNA Clean & Concentrator™-5 Kit (Zymo Research) and submitted to the UCR Institute for Integrative Genome Biology for Sanger Sequencing with either 16S (bacteria) or ITS (fungi) primers.

Species-level identification of Cladosporium sp. and Epicoccum sp. In order to verify the species of the Cladosporium sp. and the Epicoccum sp. isolated to the species level, primers were designed that were specific to C. cladosporioides and E. nigrum using PRISE2, a program for designing species specific PCR primers and probes (Huang Y-T, et al. 2014. BMC Bioinformatics 15:317) using seed sequences selected from OTUs generated in the culture-independent microbiome analysis from citrus. DNA was extracted from the isolates using a Qiagen SA.DNeasy PowerSoil Kit (Qiagen, Valencia, Calif.), and PCR was performed using the specific primers as follows for E. nigrum Forward (EpicF2): 5′-CGAGCGTCATTTGTACCT-3′ (SEQ ID NO:1) and Reverse (EpicR2): 5′-TATGAGTGCAAAGCGCGA-3′ (SEQ ID NO:2) and for C. cladosporioides Forward (CladF3): 5′-CGGCTGGGTCTTCT-3′ (SEQ ID NO:3) and Reverse (CladR3): 5′-CTTAAGTTCAGCGGGTAT-3′ (SEQ ID NO:4). Thermal cycling parameters were 94° C. for 5 min; 40 cycles of 94° C. for 20 s, either 61.2° C. (for Cladosporium sp.) or 49.6° C. (for Epicoccum sp.) for 20 s, and 72° C. for 30 s; followed by 72° C. for 10 minutes and 26° C. for 20 minutes.

Amplified regions were purified with a Qiagen MinElute Gel Extraction Kit (Qiagen, Valencia, Calif.), cloned into the pGEM-T plasmid for sequence analysis (Promega, Madison, Wis.), and then submitted for Sanger Sequencing to the UCR Institute for Integrative Genome Biology.

Liberibacter crescens inhibition bioassays. Antagonism against L. crescens BT-1 (Fagen J R, et al. 2014. Int J Syst Evol Microbiol 64:2461-2466) (kindly provided by Prof E. Triplett) was assessed by an agar-diffusion assay that tested spent culture supernatants. Bacterial supernatant filtrates were taken from 3-day liquid cultures (propagated at 30° C., 180 rpm in bBM7+1.0 mβc liquid medium) and purified via SPE (elution with methanol) (Naranjo E, et al. 2018. PHYTOPATHOLOGY p. 126-126). Fungal extracts were prepared from three-week agar cultures: 1.56 cm² sections of agar were extracted in 5 mL of methanol and shaken for 24 hours at 180 rpm at room temperature. Fifty μl of either fungal extracts or bacterial supernatant filtrates were applied to sterile paper discs (Whatman) and allowed to dry in a biosafety cabinet. bBM7+1.0 mβc top agar (0.8% agar) was prepared and cooled to 60° C., and amended 10% v/v with a four-day L. crescens liquid culture (bBM7+1.0 mβc, 28° C., 180 rpm shaking). This amended top agar was then dispensed to evenly coat previously poured bBM7+1.0 mβc agar plates, after which supernatant-loaded filter discs were placed. Cultures were incubated for 6 days at 28° C. to allow for development of clear zones of inhibition, after which zone diameters were recorded. Isolates were tested in 3 independent experiments with three technical replicates for each isolate for each experiment.

Natural product fractionation and characterization. Agar plugs (1 cm²) of C. cladosporioides strain CF0052 were used to inoculate liquid cultures (12×250 ml PDB in 500 ml Erlenmeyer flasks). Cultures were incubated for 32 days at 20° C. with shaking at 180 rpm, extracted exhaustively with EtOAc (3×250 ml), and the resulting combined extracts were evaporated in vacuo to yield a dark brown residue. The crude extract was fractionated by flash silica-gel column chromatography (CombiFlashRf200, Teledyne Instruments, Inc.) at a flow rate of 30 ml/min with gradient elution (0%-100% EtOAc:hexanes over 20 minutes, followed by 0-20% MeOH:DCM over 9 minutes) to give 6 fractions. Cladosporols A (21) and C (22) were observed in fractions 3 (44.3 mg), 4 (10.6 mg) and 5 (25.4 mg) by LC-ESI-TOFMS (Agilent 1260 Infinity liquid chromatograph coupled to a 6530 Q-TOF mass spectrometer) as peaks at t_{R} 6.6 minutes with molecular ion peak m z 351.05 [M−H]⁻, and at t_{R} 7.2 minutes with molecular ion m z 337.08 [M−H]⁻, respectively. 21 and 22 were the major components in fraction 3, observed in roughly a 2.5:1 ratio by ¹H NMR. The ¹³C NMR spectrum (JEOL ECS 100 MHz, using CDCl₃ from Cambridge Isotope Laboratories, Inc.) of fraction 3 showed nearly identical peaks to those previously reported for 21 and 22.

Agar plugs (1 cm²) of E. nigrum strain CF0053 were used to inoculate liquid cultures (20×250 ml PDB in 500 ml Erlenmeyer flasks). Cultures were incubated for 15 (2.5 L) or 22 days (2.5 L) at 20° C. with shaking at 180 rpm, extracted exhaustively with EtOAc (3×250 ml), and the resulting combined extracts were evaporated in vacuo to yield a brown residue (878.9 mg). The crude extract was fractionated by flash silica-gel column chromatography at a flow rate of 30 ml/min with gradient elution (0%-100% EtOAc:hexanes over 20 minutes, followed by 0-20% MeOH:DCM over 9 minutes) to give 9 fractions. Fractions 1 (80 mg) and 2 (49 mg) showed strong activity against L. crescens BT-1, but NMR and LC-ESI-TOFMS of these fractions revealed them to be complex mixtures requiring further purification before any molecules can be identified. Fraction 8 (139 mg) contained a single peak at t_{R} 9.2 minutes with molecular ion m/z 556.28 [M−H]⁻ whose ¹H NMR spectrum was nearly identical to that previously reported for epicoccamide A (24).

TABLE 1
Relative abundance percentages of genera of the citrus bacteriome
Percent relative abundances in the citrus bacteriome in different citrus
tissue compartments

| | Leaf | Stem | Roots |
|---|---|---|---|
| Culture | Bacillus (37.4) | Bacillus (34.7) | Bacillus (28.5) |
| Dependent | Pantoea (12.3) | Pantoea (20.4) | Enterobacter (11.1) |
| | Tatumella (12) | Tatumella (12.5) | Pseudomonas (9.1) |
| | Paenibacillus (8.6) | Paenibacillus (5.6) | Lysinibacillus (7.6) |
| | Exiguobacterium (5.2) | Exiguobacterium (5.1) | Paenibacillus (7.1) |
| | Kosakonia (4.2) | Terribacillus (3.9) | Pantoea (6.4) |
| | Pseudomonas (2.5) | Kosakonia (3.3) | Tatumella (3.8) |
| | Lysinibacillus (1.3) | Lysinibacillus (2.4) | Cupriavidis (2.5) |
| | Brevibacillus (1.2) | Pseudomonas (1.5) | Achromobacter (1.) |
| | Terribacillus (1.1) | Psychrobacillus (1.1) | Citrobacter (1.0) |
| Culture | Liberibacter (12.2) | Liberibacter (11.0) | Streptomyces (24.4) |
| Independent | Streptomyces (11.8) | Spirosoma (8.7) | Weisella (15.5) |
| | Armalimonadele^{a} (8.6) | Methylobacterium (7.6) | Flavobacterialesa (6.7) |
| | Pantoea (5.4) | Hymenobacter (6.2) | Pseudonocardia (6.2) |
| | Massilia (5.3) | Massilia (5.7) | Bacillus (5.8) |
| | Hymenobacter (5.0) | Candidatus Walczuchella (5.2) | Micromonospora (2.6) |
| | Tatumella (4.4) | Bacillus (4.4) | Cupriavidis (1.9) |
| | Methylobacterium (3.5) | Kocuria (4.3) | Mycolicibacterium (1.9) |
| | Spiroplasma (2.7) | Pantoea (4.2) | Mycoplasma (1.7) |
| | Bacillus (2.3) | Streptomyces (4.1) | Mycobacterium (1.4) |

^{a}Indicates taxa that could not be identified to the Genus level

### Example 2. Synthesis of Deoxyradicinin, an Inhibitor of Xylella fastidiosa and Liberibacter crescens, a Culturable Surrogate for Candidatus Liberibacter Asiaticus

### Abstract

Pierce's disease of grapevine, and citrus huanglongbing, are caused by the bacterial pathogens Xylella fastidiosa (Xf) and Candidatus Liberibacter asiaticus (CLas), respectively. Both pathogens reside within the plant vascular system, occluding water and nutrient transport, leading to a decrease in productivity and fruit marketability, and ultimately death of their hosts. Developing and commercializing a potent antibacterial agent is desirable for both the citrus and grape industries in order to manage these diseases and maintain high production efficiency. Previously, we showed that the natural product radicinin from Cochliobolus sp. inhibits Xf Herein we describe a chemical synthesis of deoxyradicinin and establish it as a low micromolar inhibitor of Xf and a nanomolar inhibitor of Liberibacter crescens (L. crescens), a culturable surrogate for CLas. Key to this three-step route is a zinc-mediated enolate C-acylation, which allows for direct introduction of the propenyl side chain without recourse to protecting groups or extraneous redox manipulations. We also describe structure-activity relationships revealed by screening compounds related to deoxyradicinin.

### Introduction

Pierce's Disease of grapevine (PD) and citrus huanglongbing (HLB) (also known as citrus greening) are devastating plant diseases threatening important US agricultural industries. Both are caused by gram-negative bacterial pathogens, spread by way of insect vectors. PD, known in California since the 1800 s, is caused by the bacterium Xylella fastidiosa (Xf), which inhabits the xylem of the plant (Varela, L. G. et al., Pierce's Disease; Publication 21600; University of California Agricultural and Natural Resources: Oakland, Calif., 2001; Wells, J. M. et al., Int. J. Syst. Evol. Microbiol 1987, 37, 136-143; Hopkins, D. Annu. Rev. Phytopathol. 1989, 27, 271-290.) As bacteria levels increase, the xylem becomes blocked and the flow of water and nutrients from the roots to the leaves is impeded, resulting in discolored and dried leaves, shriveled fruit, stunted vine growth, ultimately leading to vine death (Hopkins, D. L. et al., Plant Dis. 2002, 86, 1056-1066; Thorne, E. T. et al., Am. J. Enol. Vitic. 2006, 57, 1-11; Choi, H.-K. et al., Mol. Plant-Microbe Interact. 2013, 26, 643-657.) Xf is transmitted by xylem-feeding insects commonly known as leafhoppers. Native leafhoppers are limited in their flight range and transmission efficiency, and until recently, PD outbreaks remained mostly isolated to small areas at a time. However, in 1989, an especially effective insect vector, the glassy-winged sharpshooter (GWSS), was introduced to Southern California. The GWSS has infested most of Southern California including the Malibu, Temecula Valley, and San Diego wine regions, and has made its way north into the Central Valley, posing an imminent threat to the California wine, raisin, and table grape industries.

HLB is caused by the unculturable bacterium Candidatus Liberibacter asiaticus (CLas) (Chen, J. et al., Phytopathol. 2010, 100, 567-572; Kunta, M. et al., Genome Announc. 2017, 5, e00170-17; Zheng, Z. et al., Phytopathol. 2017, 107, 662-668). Unlike Xf, CLas colonizes the phloem (food transport tissue) of citrus trees. HLB-infected trees experience root loss, dieback, starch buildup, and mottled yellow leaves (Graga, J. V. da. et al., J. Integrative Plant Biol. 2016, 58, 373-387; Bove, J. M. et al., J. Plant Pathol. 2006, 88, 7-37). Affected fruit are often green, stunted, and bitter, and may drop prematurely (Bassanezi, R. B. et al., Eur. J. Plant Pathol. 2009, 125, 565-572; Dagulo, L. et al., J. Food Sci. 2010, 75, C199-C207). HLB can drastically impact the yield productivity of a tree and can ultimately prove to be fatal. CLas and its vector, the Asian citrus psyllid (ACP), were both introduced to Florida in 2005 and spread rapidly, infecting virtually all Florida citrus trees, reducing production nearly 75% (Folimonova, S. Y. et al., Phytopathol 2009, 99, 1346-1354; Gottwald, T. R. et al., Crop Protection 2012, 36, 73-82). CLas and ACP have been making their way west. ACP were first detected in Southern California in 2008 and the first trees tested HLB positive in 2012. There are now over 1,700 trees that have tested positive for HLB (Karp, D. California Farmers and Scientists Race to Combat a Citrus Disease Infecting Trees. Los Angeles Times. Mar. 29, 2019). Notably, these HLB finds have been in backyard citrus trees and HLB has not yet been found in commercial citrus groves. There is no known cure for either PD or HLB that targets the bacterium itself. A variety of approaches are being evaluated to control infection, including insecticide treatments to reduce insect vector populations, developing disease-resistant vines and trees through either breeding or genetic engineering, targeting the bacteria with bacteriophages or other bacteria, or removing infected plants (Blaustein, R. A. et al., Phytopathol. 2018, 108, 424-435; Spraying Diseased Citrus Orchards with Antibiotics Could Backfire. Nature 2019, 567, 283; Kyrkou, I. et al., Front. Microbiol. 2018, 9, 2141). Several small molecule inhibitors of Liberibacter crescens (a culturable surrogate for CLas) have been identified. Tolfenamic acid inhibits a transcriptional accessory protein in the bacterium (Gardner, C. L. et al., Front. Microbiol. 2016, 7, 1630). Through structure based drug design, polycyclic compounds (with IC₅₀ values as low as 2.5 μM) were found to inhibit the protein translocase ATPase subunit SecA (Akula, N. et al., Eur. J. Med. Chem. 2012, 54, 919-924). In a drug repurposing approach, several tetracyclines (at 0.8-1.9 M), cefotaxime (at 0.7 μM), and penicillin V (at 0.1 μM) were found to provide nearly complete inhibition of L. crescens, (Turpen, T. Discussion of Penicillin, Antimicrobial R&D and Bactericide Now Initiative, 2014) and recently streptomycin and oxytetracycline have been approved for spraying on Florida citrus groves under Section 18 emergency registration, although a recent study indicates that oxytetracycline foliar sprays are ineffective at controlling HLB (Blaustein, R. A. et al., Phytopathol. 2018, 108, 424-435; Spraying Diseased Citrus Orchards with Antibiotics Could Backfire. Nature 2019, 567, 283; Belasque, J., Jr. et al., Citrus Res. & Technol. 2010, 31, 53-64; Li, J. et al., Phytopathology 2019, 109, 2046-2054).

An interesting phenomenon observed in vineyards and citrus groves infected with PD and HLB, respectively, suggested another possible avenue for fighting these diseases. It is not uncommon to see an apparently healthy plant growing among the sick ones in areas of high disease pressure. These “disease-escaped vines” (in the case of PD) (Darjean-Jones, D. Chemical and Biological Strategies for the Management of Xylella Fastidiosa, Causal Agent of Pierce's Disease of Grapevine. Ph.D., University of California, Davis, 2004; Aldrich, T. J. et al., Phytochemistry 2015, 116, 130-137) or “survivor trees” (in the case of HLB) (Wang, N. et al., Citrus Industry 2014, 16-17; Riera, N. et al., Front. Microbiol. 2017, 8, 2415) show no or significantly reduced disease symptoms, and slower progression of disease relative to their neighbors. Because both grapevines and citrus trees are clonally propagated, the mechanism behind these disease-escaped/survivor phenotypes are likely not attributed to resistance/tolerance encoded in the plant's genome, leading us to explore plant endophytes—and their natural products—as a potential source for suppressors of Xf and CLas (Aldrich, T. J. et al., Phytochemistry 2015, 116, 130-137; Deyett, E. et al., Phytobiomes J. 2017, 1, 138-149).

We previously reported the isolation of a Cochliobolus sp. from diseased-escape Chardonnay grapevines in Temecula, and identified its major metabolite radicinin (1) as an inhibitor of Xf in vitro (Aldrich, T. J. et al., Phytochemistry 2015, 116, 130-137). To the best of our knowledge, 1 has not yet been examined against CLas or its culturable surrogate, L. crescens.

In the search for antibacterials for use in agricultural settings, synthetic approaches often complement isolation from natural sources. The first chemical synthesis of 1 was reported in 1969. Beginning with 3-oxoglutaric acid (10), racemic 1 was obtained in twelve steps (Scheme 1) (Kato, K. et al., J. Chem. Soc. C 1969, 1997-2002). Recently, a synthesis of deoxyradicinin (2; biogenetic precursor to 1) was disclosed, in which the target compound was obtained in five steps from commercially available 9 (Suzuki, M. et al., Phytochemistry 2012, 75, 14-20). A caveat of this approach is the relatively high cost ($93.50 per gram) of this starting material. Moreover, these syntheses employ expensive and/or toxic (e.g., SeO₂, Pb(OAc)₄) reagents. Even the most recently reported synthesis of 2 suffers from non-ideal economies of synthesis, including the use of a protecting group and recourse to an extraneous redox manipulation. (Marsico, G. et al., Molecules 2019, 24, 3193). In order for an antibacterial agent to achieve widespread use in agricultural settings such as vineyards or citrus groves, an economical and environmentally benign synthesis is needed. One aim of our work was to develop just such a synthesis of 1 and 2 (Scheme 1).

### Scheme 1. Summary of Reported Syntheses of Radicinin (1), Deoxyradicinin (2), and Dihydrodeoxyradicinin (3)

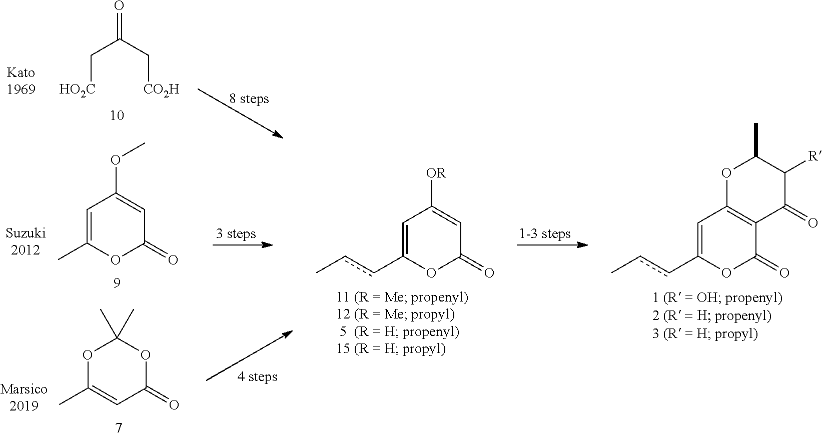

Our approach permits access to the common intermediate in two steps, and obtention of 2 or 3 in only one additional step.

Given the agricultural threats posed by Xf and CLas, antibacterial tactics are desperately needed. An ideal inhibitor of each bacterium (or both) would be cost-effective to produce, non-toxic to both flora and fauna, and easy to administer to infected plants. Secondary metabolites derived from endophytic fungi hold great appeal, because they are naturally endowed with many of these properties. Here, we further promote the radicinin family of natural products as useful antibacterials by demonstrating the antibacterial potencies of both natural 1 and synthetic 2, against Xf and L. crescens (a culturable surrogate for CLas). Additionally, with our array of compounds, we sought to identify structure-activity relationships that would further illuminate their possible mechanisms of action.

### Results and Discussion

Synthesis of dihydrodeoxyradicinin (3), deoxyradicinin (2), and related compounds. In 2001, Bach disclosed a means for securing 2-pyrones in three steps from dioxinone 7 (Bach, T. et al., Synlett 2001, 1974-1976). Very recently, this strategy was followed by Marsico for a synthesis of 2 (Marsico, G. et al., Molecules 2019, 24, 3193). However, this approach requires the preparation of a trimethylsilyl protected enol ether, followed by Mukaiyama aldol addition, and subsequent alcohol oxidation using Dess-Martin periodinane. To minimize step count, it is preferable to avoid the use of protecting groups and extraneous redox manipulations (Newhouse, T. et al., Chem. Soc. Rev. 2009, 38, 3010-3021). Furthermore, at the outset, the synthetic plan described herein emphasizes dihydrodeoxyradicinin (3) as the initial target (Scheme 2). It was reasoned that late-stage oxidation of the propyl side chain (i.e., conversion of 3 to 2) would permit easier passage through the earlier stage of the synthesis. Given these considerations, direct enolate C-acylation tactics, and Katritzky's N-acyl benzotriazole tactic was chosen among the array of options (Katritzky, A. R. et al., J. Org. Chem. 2005, 70, 4854-4856; Patel, B. H. et al., Organic Lett. 2011, 13, 5156-5159; McDonald, S. L. et al., Chem. Commun. 2014, 50, 2535-2538; Reber, K. P. et al., J. Nat. Prod. 2018, 81, 292-297; N-acylbenzotriazoles were commercially available (e.g., Sigma-Aldrich product #596361), their preparation details are also provided in the Experimental Section).

The three-step synthesis of dihydrodeoxyradicinin (3) described herein commenced with C-acylation of the lithium enolate of dioxinone 7 with N-acylbenzotriazole 13 (derived from butyric acid) (Scheme 2). After column chromatography, the keto-dioxinone 14 was refluxed in anhydrous toluene to elicit an electrocyclization cascade, ultimately affording pyrone 15. This intermediate precipitated out of the toluene solution, which provided for convenient isolation via filtration. Pyrone 15 was then treated with crotonic acid in the presence of ZnCl₂ and POCl₃ (Zehnder, L. R. et al., Tetrahedron Lett. 2000, 41, 1901-1905) to afford the desired annulation product 3. Although this sequence represents the most concise approach to 3, it was unsuccessful in oxidizing 3 to 2 via the limited screening effort undertaken. Thus, a three-step sequence for 2 that paralleled the synthesis of 3 was pursued.

Initially, a pitfall was encountered in the first step toward deoxyradicinin (2). Despite prior success in obtaining keto-dioxinone 14 en route to 3, it was unsuccessful in isolating desired keto-dioxinone 16 using the original protocol for C-acylation, possibly due to competing processes that preclude the formation of 16 from 7 and 6. The N-acylbenzotriazole 6 (derived from crotonic acid) bears acidic hydrogens, and it presents a further liability as a relatively unhindered α,β-unsaturated carbonyl moiety. Meanwhile, the lithium enolate of 7 is sufficiently basic to elicit undesired proton exchange with 6. Making matters worse, the desired product 16 also bears acidic α-hydrogens, further stifling the success of this transformation. A solution based on organozinc to aid in acylation of lithium enolates was then identified to proceed with the planned synthesis of 2. The presence of organozinc in the reaction of lithium enolates may suppress undesired α-proton exchange reaction and enhances the efficiency of enolate alkylation and acylation (Patel, B. H. et al., Organic Lett. 2011, 13, 5156-5159; McDonald, S. L. et al., Chem. Commun. 2014, 50, 2535-2538; Morita, Y. et al., J. Org. Chem. 1989, 54, 1785-1787; Arisawa, M. et al., J. Org. Chem. 1997, 62, 4327-4329; Hlavinka, M. L. et al., Organometallics 2007, 26, 4105-4108). In this case, it was found that an alkylzincate (or zinc enolate) species derived from 7 is sufficiently less basic than the lithium enolate of 7, permitting the formation and isolation of desired keto-dioxinone 16 to complete the three-step synthesis of deoxyradicinin (2) in a manner akin to that of 3.

Having secured a three-step synthetic route from 7 to 2, a few tactics were evaluated for a-hydroxylation (i.e., 2→1). In the pioneering 1969 synthesis, 2 was converted to 1 using super-stoichiometric Pb(OAc)₄ followed by acetate hydrolysis. Preferring to avoid the use of this toxic reagent, several iodine-based oxidation protocols were screened (Moriarty, R. M. et al., Tetrahedron Lett. 1981, 22, 1283-1286; Moriarty, R. M. et al., Tetrahedron Lett. 1992, 33, 6065-6068; Liu, W. et al., J. Org. Chem. 2017, 82, 2219-2222; Yang, J. et al., Org. Chem. Front. 2018, 5, 1325-1329). In all instances, unchanged 2 was recovered to some extent. Exposure of 2 to PIDA in methanolic KOH afforded side-product 4, a consequence of ring-opening of 2 (Scheme 2). Exposure of 2 to PIFA in refluxing TFA/H₂O/CH₃CN afforded ca. 25% conversion of 2 to 3-epi-radicinin.

To complement these synthetic efforts, conditions were evaluated for chiral supercritical fluid chromatographic separation of the enantiomers of the synthetic racemic 3 as well as the synthetic racemic 2. In lieu of synthetic radicinin (1), natural radicinin ((−)-1) was isolated from Alternaria radicina (vide infra). With all of these compounds in hand, it was possible to perform antibacterial assays.

### Scheme 2. Details for Our Syntheses of 3, 2, and 4

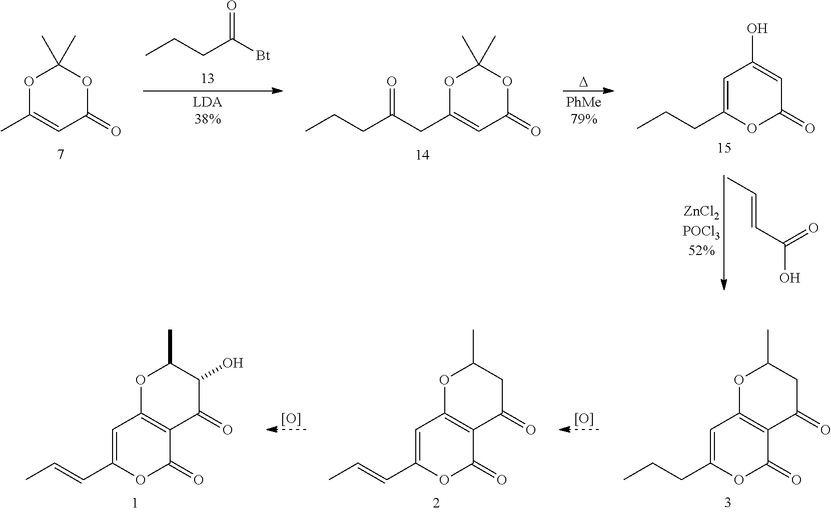

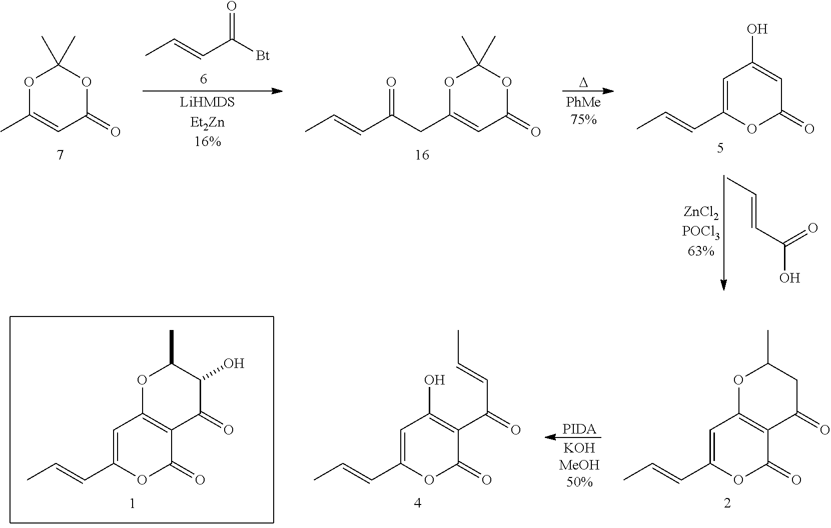

Bt=benzotriazol-1-yl; LDA=lithium diisopropylamide; LiHMDS=lithium hexamethyldisilazide; PIDA=phenyliodine(III) diacetate

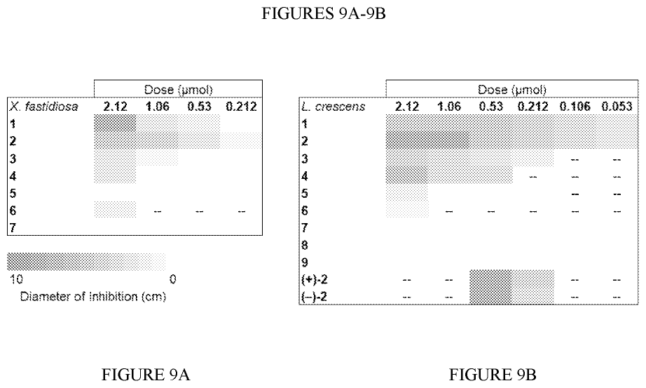

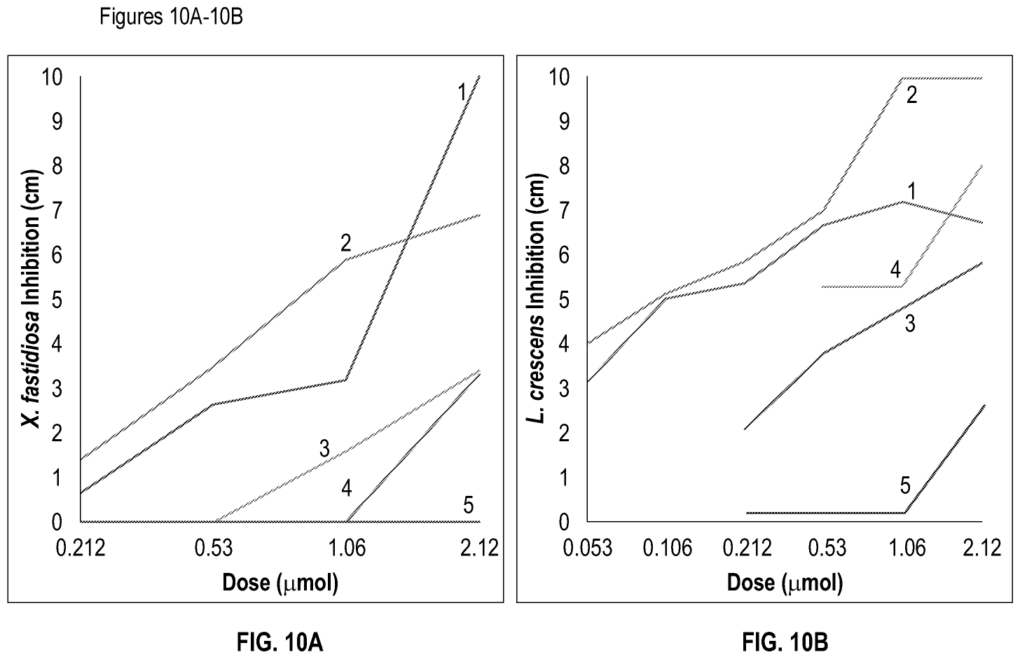

Bioassay against X. fastidiosa and L. crescens. Compounds for antibacterial assay (FIG. 8) were selected based on a variety of factors. Compound 1 is known to inhibit Xf in a dose-dependent fashion, (Aldrich, T. J. et al., Phytochemistry 2015, 116, 130-137) and we decided to test several of its synthetic analogs: deoxyradicinin (2), dihydrodeoxyradicinin (3), a ring-opened derivative of deoxyradicinin (4), and a monocyclic synthetic intermediate (5). Crotonyl benzotriazole (6) and 2,2,6-trimethyl-4H-1,3-dioxin-4-one (7), building blocks in our three-step synthesis of 2 (and hence a formal five-step synthesis of 1), were selected for assay because they each possess an α,β-unsaturated carbonyl, albeit not the precise structural feature present in 1 and 2 that is responsible for their antibacterial potency. Likewise, dehydroacetic acid (8) and 4-methoxy-6-methyl-2H-pyran-2-one (9) were selected because they possess a pyrone core in common with 1 and 2 but lack the putatively vital propenyl side chain. We therefore expected to observe a lack of antibacterial potency when 8 and 9 were assayed. Having observed high potency of racemic 2 against L. crescens (vide infra), we performed chiral SFC to obtain enantioenriched (−)-2 and (+)-2 for follow-up evaluation. Bioassay results are shown in FIGS. 9 and 10.

Against Xf, 1 and 2 exhibit a consistent, somewhat linear relationship between compound dose and antibacterial response (FIG. 10a). While 2 (racemic, synthetic in origin) is more potent than 1 (enantiopure, isolated from A. radicina) at lower doses, 1 provides complete inhibition (diameter=10 cm) at the highest dose tested (2.12 μmol). Notably, 3 shows activity only at doses greater than 0.53 μmol, and even at the highest dose tested (2.12 μmol), it affords only a modest (diameter=3.4 cm) level of inhibition. Thus, it appears that the propenyl side chain (serving as a conjugate acceptor) is vital for maintaining potency. However, 5 is inactive against Xf, indicating that the conjugate acceptor motif is insufficient per se.

Against L. crescens, 1, 2, 3, and 4 exhibit notable linear relationships between compound dose and antibacterial response (FIG. 4b). Compound 2 is the most potent inhibitor of L. crescens tested in our laboratories, with respectable inhibition (diameter=4.0 cm) at the lowest tested dose of 0.053 μmol. As the dose of 2 increased to 1.06 μmol and higher, complete inhibition of L. crescens was observed. Compound 5 showed negligible antibacterial activity at lower doses (diameter=0.2 cm), with the highest dose showing modest inhibition (diameter=2.6 cm).

While 1 and its analogs have previously been reported to possess antibacterial activity against Xf(Aldrich, T. J. et al., Phytochemistry 2015, 116, 130-137), to the best of our knowledge, the capacity of compounds 1-5 to inhibit L. crescens has not been detailed until now. As a note, the sample of 1 tested here was (−)-radicinin isolated from Alternaria radicina, whereas compounds 2 and 3 were synthesized as racemates. Racemic 2 as well as enantioenriched (−)-2 and (+)-2 were found to potently inhibit L. crescens (FIG. 9).

Identification of structure-activity relationships. Compounds 1, 2, 4, 5 and 6 each possess a sterically unhindered electrophilic conjugate acceptor. We previously demonstrated this functional group's capacity to deactivate Xf proteases by enzymatic nucleophilic addition to 1 (Aldrich, T. J. et al., Phytochemistry 2015, 116, 130-137). Thus, conjugate acceptors related to 1 were expected to inhibit Xf Our bioassay data confirm this in Xf and expose a similar vulnerability in L. crescens (FIG. 9). Interestingly, comparable degrees of inhibition of L. crescens by enantioenriched samples of (−)- and (+)-deoxyradicinin (Chiral SFC separation of synthetic racemic deoxyradicinin (2) was performed by Pfizer Inc.) suggests that enzyme inactivation is not stereospecific (Masi, M. et al., J. Nat. Prod. 2017, 80, 1241-1247), a finding that bodes well from a developmental perspective.

The progressive decrease in antibacterial potency when moving from 2 to 4 to 5 can be rationalized by another key structural feature. In 2, we find a rigid bicyclic scaffold bearing a bidentate 1,3-dicarbonyl. In 4, we witness a conformationally more flexible monocyclic scaffold bearing the 1,3-dicarbonyl. In 5, we observe a conspicuous absence of any 1,3-dicarbonyl. Our previously published work on radicinin suggested an antibacterial mode of action involving enzyme (e.g., protease) inhibition (Aldrich, T. J. et al., Phytochemistry 2015, 116, 130-137). It is well known that protease kinetics can be significantly altered by using divalent metal cations (e.g., Zn²⁺) or zinc-metal binding small molecules (Katz, B. A. et al., Nature 1998, 391, 608-612). Given our observed potency trend of 2>4>5 and the aforementioned structural differences, it seems reasonable to speculate that a Lewis acidic species (e.g., divalent metal cation such as Zn²⁺) may be involved at the site where these compounds are binding. If so, metal coordination to the Lewis basic 1,3-dicarbonyl moiety would draw electron density out of the pyrone ring and propenyl side chain, rendering it more electrophilic more susceptible to nucleophilic attack. Alternatively, metal-dependent enzyme (e.g., a zinc metalloenzyme such as bacterial phosphotriesterase) activity may be diminished when a metal chelator (e.g., 1,3-dicarbonyl) is present (Omburo, G. A. et al., J. Biol. Chem. 1992, 267, 13278-13283). Interestingly, radicinin was recently studied in the context of Alzheimer's disease as a natural scaffold with multi-target activity; at least two of the targets are perturbed by molecules with metal chelating capacity (Piemontese, L. et al., Molecules 2018, 23, 2182). Finally, antibacterial itaconic acid derivatives isolated from the fungus Aspergillus niger possess a conjugate acceptor motif with a bidentate chelator (in this case, a 1,4-dicarbonyl) that may help explain their antibacterial potency in a manner akin to that suggested here for deoxyradicinin (Ding, L. et al., J. Antibiot. 2018, 71, 902-904).

In summary, plant pathogenic bacteria pose a great threat to the viability of grapevines and citrus trees, two crops of tremendous agricultural and economic significance. In order to fight these devastating agricultural diseases, we developed a three-step synthesis of deoxyradicinin (2). We began with cost-effective, commercially available starting materials, and we exercised strict step economy while avoiding the use of toxic reagents, protecting groups, and extraneous redox manipulations. Our bioassay results demonstrate that synthetic deoxyradicinin (2) is a potent inhibitor of both Xf and L. crescens, making this compound a very attractive entity for further development. Furthermore, our assay data suggest that while the 3-hydroxy substituent (in 1 but not in 2) is expendable for antibacterial potency, both the conjugate acceptor motif and the 1,3-dicarbonyl appear to make deoxyradicinin (2) uniquely well-suited for inhibition of these pathogenic bacteria.

### Experimental Section

General Experimental Procedures. All reactions were carried out in flame-dried glassware with magnetic stirring under argon atmosphere, unless noted otherwise. ACS reagent grade or anhydrous dichloromethane (CH₂Cl₂), tetrahydrofuran (THF), and toluene were used without further purification. Compound 7 was obtained from Acros Organics (Morris Plains, N.J., USA). Compound 8 was obtained from Sigma-Aldrich (St. Louis, Mo., USA). Compound 9 was prepared in two steps from 8 according to published methods (Soldi, et al., Eur. J. Org. Chem. 2012, 3607-3616). Melting points were measured on an Electrothermal 1101D Mel-Temp Digital Melting Point Apparatus. Optical rotations were measured on an Atago Polax-2 L Polarimeter. Infrared spectra were recorded on a Thermo Scientific Nicolet iS10 FTIR Spectrometer. ¹H and ¹³C NMR spectra were recorded in CDCl₃ (Cambridge Isotope Laboratories, Inc., Tewksbury, Mass., USA) or DMSO-d₆ (Sigma-Aldrich, St. Louis, Mo., USA) at 400 MHz and 100 MHz, respectively, on a JEOL JNM-ECZ400S NMR spectrometer (JEOL, Ltd., Akishima, Tokyo, Japan). All spectra were referenced to residual solvent: 7.26 ppm and 77.06 ppm for ¹H and ¹³C NMR in CDCl₃; 2.50 ppm and 39.53 ppm for ¹H and ¹³C NMR in DMSO-d₆. HRMS analysis was carried out on an Agilent Technologies 1200 Series system with a diode-array detector coupled to an Agilent Technologies 6530 Accurate-Mass Q-TOF mass spectrometer (Santa Clara, Calif., USA) operated in positive ionization mode. Data was analyzed with Agilent MassHunter software. Analytical and preparative thin layer chromatography (TLC) were performed on glass-backed silica gel plates. TLC plates were visualized by exposure to ultraviolet light and subsequently stained with p-anisaldehyde solution followed by heating. Flash column chromatography was performed on silica gel (0.040-0.063 mm, 230-400 mesh). Chiral supercritical fluid chromatography was performed on an SFC-PICLab HT with Open Bed fraction collection (PIC Solution SAS, Avignon, France). Dimethyl sulfoxide (DMSO), ethyl acetate (EtOAc), and methanol (MeOH) were used as solvents for filter disc preparation.

Preparation of 13. (Katritzky, A. R. et al., Synthesis 2003, 2795-2798.) To a solution of benzotriazole (28.6 g, 240.4 mmol) in CH₂Cl₂ (300 mL) was added SOCl₂ (7.1 g, 60.1 mmol) at 25° C. After 30 min, butyric acid (5.3 g, 60.1 mmol) was added in one portion. After 2 h, the white precipitate was removed via filtration and rinsed with CH₂Cl₂ (2×50 mL). The filtrate was washed with 2 M NaOH (3×360 mL), dried over Na₂SO₄, filtered, and concentrated in vacuo. The residue was purified by flash column chromatography (silica gel; 4:1 hexanes-EtOAc) to yield 1-(1H-benzo[d][1,2,3]triazol-1-yl)butan-1-one (13) as an off-white solid (10.01 g, 88%). m.p. 59-60° C. (2-propanol). ¹H NMR (400 MHz, CDCl₃) δ 8.30 (d, J=8.2 Hz, 1H), 8.11 (d, J=8.2 Hz, 1H), 7.65 (t, J=7.8 Hz, 1H), 7.50 (t, J=7.8 Hz, 1H), 3.40 (t, J=7.3 Hz, 2H), 1.94 (m, 2H), 1.10 (t, J=7.5 Hz, 3H). ¹³C NMR (100 MHz, CDCl₃) δ 172.6, 146.2, 130.4, 126.1, 120.2, 114.5, 100.0, 37.4, 18.0, 13.7. ¹H NMR and ¹³C NMR data are consistent with those found in the literature (Katritzky, A. R. et al., J. Org. Chem. 2000, 65, 8069-8073).

Preparation of 14. (Katritzky, A. R. et al., J. Org. Chem. 2005, 70, 4854-4856; Patel, B. H. et al., Organic Lett. 2011, 13, 5156-5159.) To a solution of N,N-diisopropylamine (3.2 mL, 22.5 mmol) in anhydrous THE (60 mL) was added n-butyllithium (2.5 M in hexanes, 9.9 mL, 24.8 mmol) dropwise over 20 min at −78° C. To this LDA solution was added a solution of 7 (2.4 mL, 17 mmol) in THE (60 mL) dropwise over 15 min at −78° C. After 1.5 h, a solution of 13 (2.9 g, 15 mmol) in THE (60 mL) was added, and the reaction was warmed to room temperature overnight. The reaction was quenched with saturated aqueous NH₄Cl (6 mL) and concentrated in vacuo to afford a golden-brown syrup. Water (300 mL) was added to the syrup, and it was transferred to a separatory funnel for extraction with EtOAc (3×150 mL). The organic layers were combined, washed with saturated aqueous Na₂CO₃ (300 mL), dried over MgSO₄, filtered, and concentrated in vacuo. The residue was purified by flash column chromatography (silica gel; 1:1 hexanes-EtOAc; R_{f}=0.5) to yield 2,2-dimethyl-6-(2-oxopentyl)-4H-1,3-dioxin-4-one (14) as a colorless oil (1.21 g, 38%). ¹H NMR (400 MHz, CDCl₃) δ 5.34 (s, 1H), 3.31 (s, 2H), 2.48 (t, J=7.2 Hz, 2H), 1.71 (s, 6H), 1.67-1.61 (m, 2H), 0.93 (t, J=7.4 Hz, 3H). ¹³C NMR (100 MHz, CDCl₃) δ 203.3, 164.7, 160.8, 107.2, 96.6, 47.1, 45.0, 25.0, 16.9, 13.5.

Preparation of 15. (Kato, K. et al., J. Chem. Soc. C 1969, 1997-2002). A 0.1 M solution of 14 (1.11 g, 5.23 mmol) in anhydrous toluene (52.3 mL) was stirred under reflux for 1 h. The white precipitate was collected via filtration and washed with toluene (2×20 mL), yielding 4-hydroxy-6-propyl-2H-pyran-2-one (15) as an off-white solid (0.637 g, 79%). ¹H NMR (400 MHz, CDCl₃) δ 6.00 (s, 1H), 5.58 (s, 1H), 2.44 (t, J=7.5 Hz, 2H), 1.70-1.61 (m, 2H), 0.94 (t, J=7.4 Hz, 3H). ¹³C NMR (100 MHz, CDCl₃) δ 172.6, 168.4, 167.1, 101.5, 89.8, 35.5, 20.1, 13.4. ¹H NMR and ¹³C NMR data are consistent with those found in the literature (Hsung, R. et al., Synthesis 2007, 749-753).

Preparation of dihydrodeoxyradicinin (3). (Zehnder, L. R. et al., Tetrahedron Lett. 2000, 41, 1901-1905; Shah, V. et al., J. Org. Chem. 1960, 25, 677-678). To a solution of POCl₃ (2.4 g, 15.3 mmol) and ZnCl₂ (1.2 g, 8.8 mmol) was added crotonic acid (0.2 g, 2.19 mmol) and 15 (0.3 g, 2.2 mmol) at 85° C. with stirring for 4 h. The reaction was quenched with a small handful of ice and Na₂CO₃ (10% aq w/v %, 50 mL). The product was extracted with CH₂Cl₂ (2×100 mL). The organic layers were combined, dried over Na₂SO₄, filtered, and concentrated in vacuo. The residue was purified by flash column chromatography (silica gel; CH₂Cl₂ followed by 10:1 CH₂Cl₂-MeOH; R_{f}=0.4) to afford 2-methyl-7-propyl-2,3-dihydropyrano[4,3-b]pyran-4,5-dione (3) as a light brown solid (0.253 g, 52%). ¹H NMR (400 MHz, CDCl₃) δ 5.88 (s, 1H), 4.79-4.72 (m, 1H), 2.71-2.58 (m, 2H), 2.47 (t, J=7.5 Hz, 2H), 1.71 (sextet, J=7.2 Hz, 2H), 1.54 (d, J=6.3 Hz, 3H), 0.98 (t, J=7.3 Hz, 3H). ¹³C NMR (100 MHz, CDCl₃) δ 186.6, 176.0, 172.3, 158.1, 100.0, 99.1, 43.8, 36.4, 20.4, 19.9, 13.5. ¹H NMR and ¹³C NMR data are consistent with those found in the literature (Kato, K. et al., J. Chem. Soc. C 1969, 1997-2002; Kato, K. et al., Chem. Commun. (London) 1968, 319). HRMS (+) m z 223.02730 [M+H]⁺ (calcd for C₁₂H₁₅O₄ 223.09703). Analytical chiral SFC method screening identified a suitable means for separating (−)-3 and (+)-3. Method conditions: Chiralpak AD-3, 4.6×100 mm, 3 pm; 10% isocratic in 5 min; 20 mM ammonium formate in MeOH; 3.5 mL/min; 160 bar; 25° C.; APCI (+); 1.0 μL injection. Preparative-scale separation was not done for 3.

Preparation of 6. (Katritzky, A. R. et al., Synthesis 2003, 2795-2798). To a solution of benzotriazole (28.6 g, 240.4 mmol) in CH₂Cl₂ (300 mL) was added SOCl₂ (7.1 g, 60.1 mmol) at 25° C. After 30 min, crotonic acid (5.2 g, 60.1 mmol) was added in one portion. After 2 h, the white precipitate was removed via filtration and rinsed with CH₂Cl₂ (2×50 mL). The filtrate was washed with 2 M NaOH (3×360 mL), dried over Na₂SO₄, filtered, and concentrated in vacuo. The residue was purified by flash column chromatography (silica gel; 4:1 hexanes-EtOAc) to yield (E)-1-(1H-benzo[d][1,2,3]triazol-1-yl)but-2-en-1-one (6) as an off-white solid (9.96 g, 89%). m.p. 91-93° C. (2-propanol). ¹H NMR (400 MHz, CDCl₃) δ 8.35 (d, J=8.2 Hz, 1H), 8.12 (d, J=8.5 Hz, 1H), 7.73-7.59 (m, 1H), 7.57-7.43 (m, 3H), 2.12 (d, J=5.5 Hz, 3H). ¹³C NMR (100 MHz, CDCl₃) δ 163.6, 150.0, 146.3, 131.4, 130.2, 126.2, 121.4, 120.1, 114.8, 19.9. ¹H NMR and ¹³C NMR data are consistent with those found in the literature (Katritzky, A. R. et al., Synthesis 2003, 2795-2798).

Preparation of 16. (Katritzky, A. R. et al., J. Org. Chem. 2005, 70, 4854-4856; Patel, B. H. et al., Organic Lett. 2011, 13, 5156-5159). To anhydrous THF (84 mL) was added hexamethyldisilazane (8.8 mL, 42 mmol) at −78° C. n-Butyllithium (16.8 mL, 42 mmol, 2.5 M in hexanes) was added dropwise over 10 min. After 20 min, a solution of 7 (4 mL, 30 mmol) in THE (12 mL) was added dropwise over 10 min. After 1 h, diethylzinc (42 mL, 42 mmol, 1.0 M in hexanes) was slowly added. After 20 min, the mixture was warmed to −20° C. A solution of 6 (6.75 g, 36 mmol) in THE (18 mL) was added and stirring was continued for 2 h. The reaction was quenched with 1 M HCl (240 mL), and the aqueous layer was acidified to pH 1-2 using 1 M HCl. The product was extracted with EtOAc (2×300 mL). The organic layers were combined, dried over MgSO₄, filtered, and concentrated in vacuo. The residue was purified by flash column chromatography (silica gel; 3:1 hexanes-EtOAc) to yield 2,2-dimethyl-6-[(3E)-2-oxopent-3-en-1-yl]-2,4-dihydro-1,3-dioxin-4-one (16) as a colorless oil (1.016 g, 16%). ¹H NMR (400 MHz, CDCl₃) δ 6.92 (dq, J=15.6, 6.9 Hz, 1H), 6.16 (m, 1H), 5.36 (s, 1H), 3.44 (s, 2H), 1.94 (m, 3H), 1.69 (s, 6H). ¹³C NMR (100 MHz, CDCl₃) δ 192.5, 165.2, 161.0, 145.6, 130.9, 107.4, 96.8, 44.7, 25.1, 18.5. ¹H NMR and ¹³C NMR data are consistent with those found in the literature.³³

Preparation of 5. (Kato, K. et al., J. Chem. Soc. C 1969, 1997-2002). A 0.1 M solution of 16 (0.228 g, 1.09 mmol) in anhydrous toluene (10.9 mL) was stirred under reflux for 10 min. The white precipitate was collected via filtration and washed with toluene (2×10 mL), yielding (E)-4-hydroxy-6-(prop-1-en-1-yl)-2H-pyran-2-one (5) as an off-white solid (0.124 g, 75%). m.p. 183-185° C. ¹H NMR (400 MHz, DMSO-d₆) δ 11.63 (s, 1H), 6.46 (dq, J=15.6, 6.9 Hz, 1H), 6.15 (dd, J=15.6, 1.4 Hz, 1H), 5.98 (d, J=1.8 Hz, 1H), 5.22 (d, J=1.8 Hz, 1H), 1.82 (dd, J=6.9, 1.4 Hz, 3H). ¹³C NMR (100 MHz, DMSO-d₆) δ 170.4, 163.1, 159.0, 133.8, 123.4, 99.8, 89.4, 18.1. ¹H NMR and ¹³C NMR data are consistent with those found in the literature (Bach, T. et al., Synlett 2001, 1974-1976; Suzuki, E, et al., Synthesis 1975, 192-194).

Preparation of deoxyradicinin (2). (Zehnder, L. R. et al., Tetrahedron Lett. 2000, 41, 1901-1905; Shah, V. et al., J. Org. Chem. 1960, 25, 677-678). To a solution of POCl₃ (0.7 g, 4.4 mmol) and ZnCl₂ (0.3 g, 2.5 mmol) was added crotonic acid (0.1 g, 0.6 mmol) and 5 (0.097 g, 0.6 mmol) at 85° C. with stirring for 4 h. The reaction was quenched with a small handful of ice and Na₂CO₃ (10% aq w/v %, 15 mL). The product was extracted with CH₂Cl₂ (2×40 mL). The organic layers were combined, dried over Na₂SO₄, filtered, and concentrated in vacuo. The residue was purified by flash column chromatography (silica gel; CH₂Cl₂ followed by 10:1 CH₂Cl₂-MeOH) to afford (E)-2-methyl-7-(prop-1-en-1-yl)-2,3-dihydropyrano[4,3-b]pyran-4,5-dione (2) as a dark brown solid (0.091 g, 63%). ¹H NMR (400 MHz, CDCl₃) δ 6.99-6.87 (m, 1H), 6.02 (dd, J=15.4, 1.6 Hz, 1H), 5.83 (s, 1H), 4.80-4.69 (m, 1H), 2.70-2.58 (m, 2H), 1.95 (dd, J=7.0, 1.6 Hz, 3H), 1.53 (d, J=6.4 Hz, 3H). ¹H NMR data are consistent with those found in the literature (Kato, K. et al., J. Chem. Soc. C 1969, 1997-2002; Kato, K. et al., J. Chem. Soc. D 1969, 95). Preparative chiral SFC furnished separate samples of enantioenriched (−)-2 and (+)-2. Method conditions: Chiralpak AS-3, 4.6×100 mm, 3 μm; 20% isocratic in 2.0 min; 20 mM ammonium formate in MeOH; 3.5 mL/min; 160 bar; 25° C.; APCI (+); 3.0 μL injection.

Preparation of 4. (Moriarty, R. M. et al., Tetrahedron Lett. 1981, 22, 1283-1286). To a solution of KOH (0.056 g, 1.0 mmol) in MeOH (2 mL) at 0° C. was added 2 (0.022 g, 0.10 mmol) over 10 min. (Diacetoxyiodo)benzene (0.064 g, 0.20 mmol) was added over 10 min, and the reaction allowed to warm to room temperature overnight. The reaction was quenched with 0.1 M HCl (0.2 mL). The product was extracted with CH₂Cl₂ (2×10 mL). The organic layers were combined, dried over Na₂SO₄, filtered, and concentrated in vacuo. The residue was purified by flash column chromatography (1:1 hexanes-acetone) to afford 3-((E)-but-2-enoyl)-4-hydroxy-6-((E)-prop-1-en-1-yl)-2H-pyran-2-one (4) as an off-white solid (11 mg, 50%). ¹H NMR (400 MHz, CDCl₃) δ 7.64 (d, J=15.3 Hz, 1H), 7.34-7.23 (m, 1H), 6.92 (dq, J=15.2, 7.0 Hz, 1H), 6.03 (d, J=15.5 Hz, 1H), 5.88 (s, 1H), 2.02 (d, J=6.9 Hz, 3H), 1.96 (d, J=6.9 Hz, 3H). ¹³C NMR (100 MHz, CDCl₃) δ 193.0, 183.2, 163.4, 160.8, 147.4, 140.2, 128.3, 122.9, 100.8, 99.6, 19.1, 18.9.

Isolation of (−)-radicinin (1). (−)-Radicinin was obtained from the fermentation of Alternaria radicina (ATCC 96831) shaken at 190 rpm in potato dextrose broth for 24 days. ¹H NMR data are consistent with those found in the literature (Aldrich, T. J. et al., Phytochemistry 2015, 116, 130-137; Kato, K. et al., J. Chem. Soc. C 1969, 1997-2002; Kato, K. et al., J. Chem. Soc. D 1969, 95). Analytical chiral SFC confirmed the enantiopurity of (−)-1. Method conditions: Chiralpak AD-3, 4.6×100 mm, 3 μm; 40% isocratic in 5 min; 20 mM ammonium formate in MeOH; 3.5 mL/min; 160 bar; 25° C.; APCI (+); 1.0 μL injection.

Antibacterial assays. Compounds were evaluated using an in vitro assay of their ability to inhibit Xf or L. crescens growth. Compounds were dissolved in DMSO, EtOAc, or MeOH and applied to sterile filter discs (Difco) to achieve desired doses. Culture techniques for each bacterium are described below. After incubation with compound-loaded filter discs at 28° C. for 5 to 7 days, the diameters of clear zones of inhibition were measured and recorded. Each assay was performed in triplicate, and the average diameter of inhibition is reported herein. Compounds that afforded significant inhibition at higher doses were tested at lower doses to further characterize dose response.

Xylella fastidiosa inhibition assay. Pierce's Disease medium (PD3) (Davis, M. J. et al., Curr. Microbiol. 1981, 6, 309-314) top agar (0.8% agar) was prepared, cooled to 60° C., and amended 10% v/v with six-day-old Xf liquid culture (PD3, 28° C., 180 rpm shaking). and the OD₆₀₀ was adjusted to 0.1. This amended top agar was then dispensed to evenly coat previously poured PD3 agar plates. After two days of incubation at 28° C., compound-loaded filter discs were placed in the center of the plates.

Liberibacter crescens inhibition assay. bBM7+1.0 mβc top agar (0.8% agar) (Naranjo, E. et al., Sci. Rep. 2019, 9, 5150) was prepared, cooled to 60° C., and amended 10% v/v with four-day-old L. crescens liquid culture (mBM7, 28° C., 180 rpm shaking). This amended top agar was then dispensed to evenly coat previously poured mBM7 agar plates, and compound-loaded filter discs were placed in the center of the plates.

### ABBREVIATIONS

ATCC, American Type Culture Collection; CLas, Candidatus Liberibacter asiaticus; DMSO, dimethyl sulfoxide; HLB, huanglongbing; LDA, lithium diisopropylamide; LiHMDS, lithium hexamethyldisilazide; LiTMP, Lithium 2,2,6,6-tetramethylpiperidide; Zn(HMDS)₂, Zinc bis[bis(trimethylsilyl)amide]; Zn(TMP)₂, Bis(2,2,6,6-tetramethylpiperidinyl)zinc; NMR, nuclear magnetic resonance; PD, Pierce's Disease; PIDA, phenyliodine(III) diacetate; SFC, supercritical fluid chromatography; THF, tetrahydrofuran; Xf, Xylella fastidiosa

All publications, patents, and patent documents are incorporated by reference herein, as though individually incorporated by reference. The invention has been described with reference to various specific and preferred embodiments and techniques. However, it should be understood that many variations and modifications may be made while remaining within the spirit and scope of the invention.

What is claimed is:

1. A method of inhibiting Candidatus Liberibacter asiaticus (CLas) growth in a plant, comprising introducing to the plant at least one compound selected from the group consisting of: 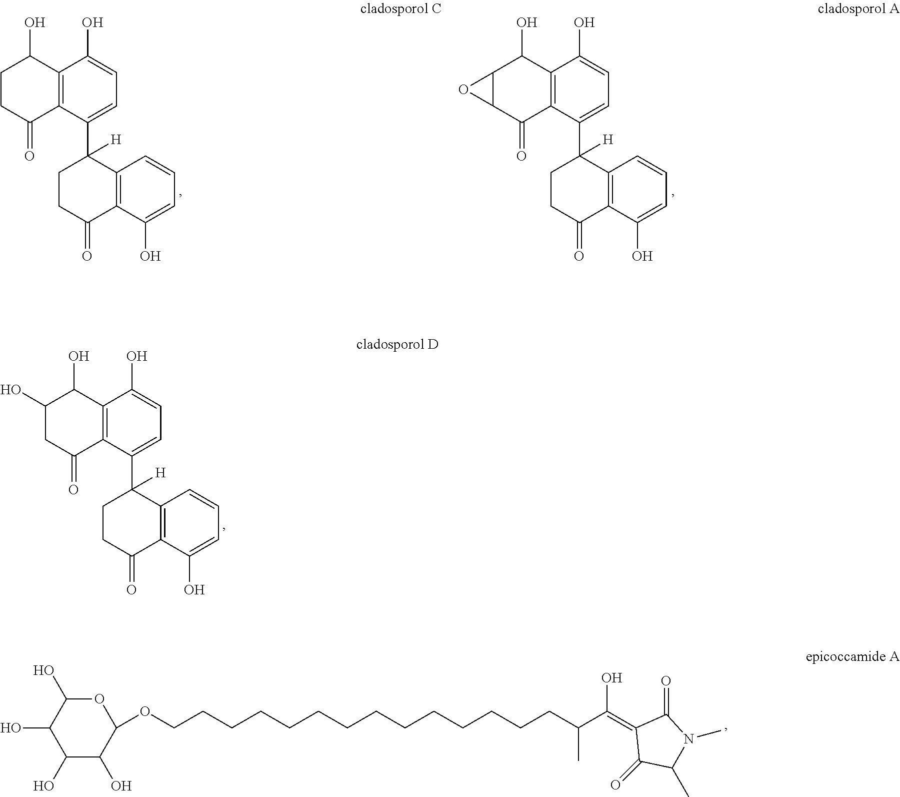 [SMILES: O=C1CCC(c2ccc(O)c3c2C(=O)CCC3O)c2cccc(O)c21 ; O=C1CCC(c2ccc(O)c3c2C(=O)C2OC2C3O)c2cccc(O)c21 ; O=C1CCC(c2ccc(O)c3c2C(=O)CC(O)C3O)c2cccc(O)c21 ; CC(CCCCCCCCCCCCCCOC1OC(O)C(O)C(O)C1O)/C(O)=C1\C(=O)C(C)N(C)C1=O]
and a compound of formula I,
or a salt thereof,
wherein the compound of formula I is 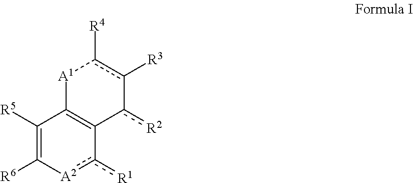
wherein,
A¹ is O, S, NH, OH, SH or NH₂;
A² is CH, O, S, or NH,
R¹ and R² are each individually selected from the group consisting of halo, CN, O, OH, NH, NH₂, S, SH, and CH₂;
R³-R⁵ are each individually selected from the group consisting of H, halo, hydroxyl, cyano, thiol, amino, aryl, (C₁-C₆)alkyl, and (C₂-C₆)alkenyl, wherein each hydroxyl, thiol, amino, aryl, alkyl and alkenyl are optionally and independently substituted; and
R⁶ is selected from the group consisting of H, hydroxyl, (C₁-C₆)alkyl, (C₂-C₆)alkenyl and heterocycle, wherein each hydroxyl, alkyl, alkenyl and heterocycle are optionally substituted.

2. A method of treating a Candidatus Liberibacter asiaticus (CLas) infection in a plant and/or treating Huanglongbing (HLB) in a plant, comprising introducing to the plant at least one compound selected from the group consisting of: 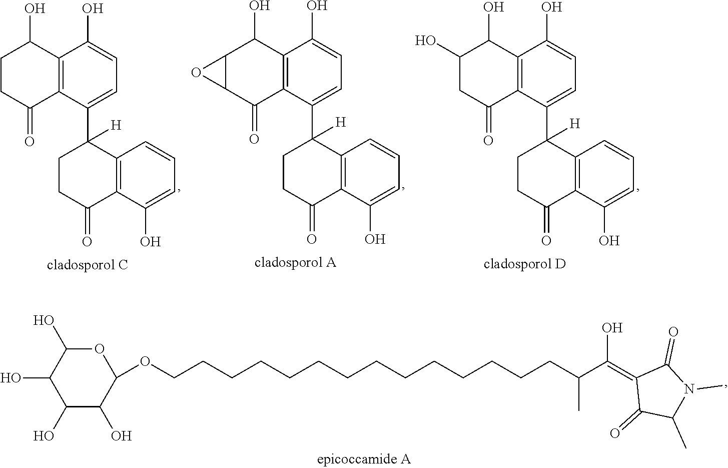 [SMILES: O=C1CCC(c2ccc(O)c3c2C(=O)CCC3O)c2cccc(O)c21 ; O=C1CCC(c2ccc(O)c3c2C(=O)C2OC2C3O)c2cccc(O)c21 ; O=C1CCC(c2ccc(O)c3c2C(=O)CC(O)C3O)c2cccc(O)c21 ; CC(CCCCCCCCCCCCCCOC1OC(O)C(O)C(O)C1O)/C(O)=C1\C(=O)C(C)N(C)C1=O]
and a compound of formula I,
or a salt thereof,
wherein the compound of formula I is: 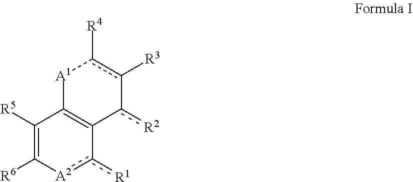
wherein,
A¹ is O, S, NH, OH, SH or NH₂,
A² is CH, O, S, or NH;
R¹ and R² are each individually selected from the group consisting of halo, CN, O, OH, NH, NH₂, S, SH, and CH₂,
R³-R⁵ are each individually selected from the group consisting of H, halo, hydroxyl, cyano, thiol, amino, aryl, (C₁-C₆)alkyl, and (C₂-C₆)alkenyl, wherein each hydroxyl, thiol, amino, aryl, alkyl and alkenyl are optionally and independently substituted; and
R⁶ is selected from the group consisting of H, hydroxyl, (C₁-C₆)alkyl, (C₂-C₆)alkenyl and heterocycle, wherein each hydroxyl, alkyl, alkenyl and heterocycle are optionally substituted.

3. The method of any one of claims 1-2, wherein the at least one compound or salt is selected from the group consisting of: 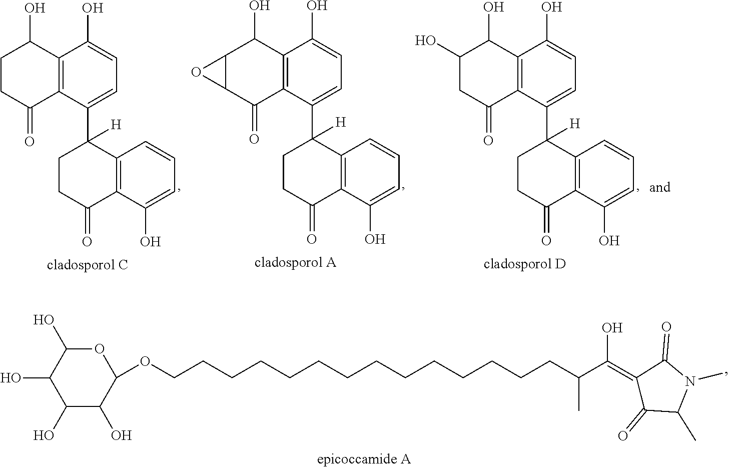 [SMILES: O=C1CCC(c2ccc(O)c3c2C(=O)CCC3O)c2cccc(O)c21 ; O=C1CCC(c2ccc(O)c3c2C(=O)C2OC2C3O)c2cccc(O)c21 ; O=C1CCC(c2ccc(O)c3c2C(=O)CC(O)C3O)c2cccc(O)c21 ; CC(CCCCCCCCCCCCCCOC1OC(O)C(O)C(O)C1O)/C(O)=C1\C(=O)C(C)N(C)C1=O]
or a salt thereof.

4. The method of any one of claims 1-3, wherein the at least one compound or salt is: 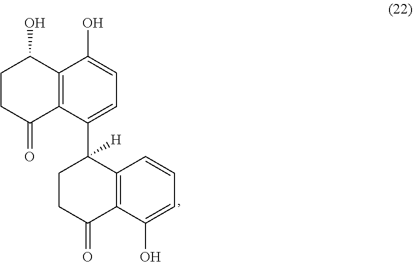 [SMILES: O=C1CC[C@@H](c2ccc(O)c3c2C(=O)CC[C@@H]3O)c2cccc(O)c21]
or a salt thereof.

5. The method of any one of claims 1-3, wherein the at least one compound or salt is: 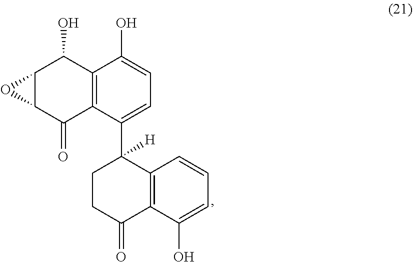 [SMILES: O=C1CC[C@@H](c2ccc(O)c3c2C(=O)[C@@H]2O[C@@H]2[C@@H]3O)c2cccc(O)c21]
or a salt thereof.

6. The method of any one of claims 1-3, wherein the at least one compound or salt is: 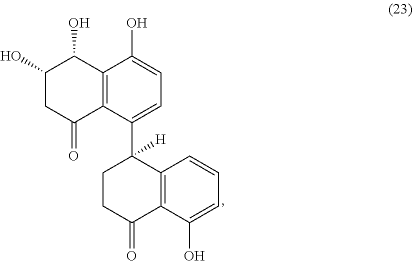 [SMILES: O=C1CC[C@@H](c2ccc(O)c3c2C(=O)C[C@H](O)[C@@H]3O)c2cccc(O)c21]
or a salt thereof.

7. The method of any one of claims 1-3, wherein the at least one compound or salt is: 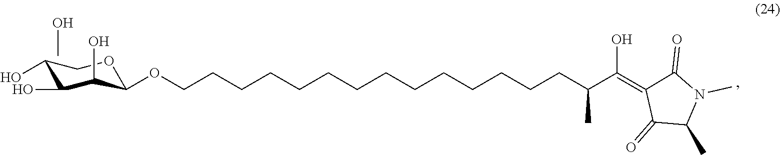
or a salt thereof.

8. The method of any one of claims 1-2, wherein the at least one compound or salt is a compound of formula I: 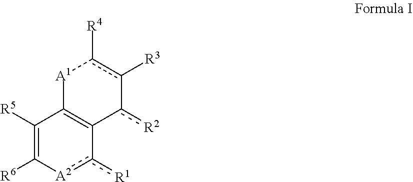
wherein,
A¹ is O, S, NH, OH, SH or NH₂;
A² is CH, O, S, or NH;
R¹ and R² are each individually selected from the group consisting of halo, CN, O, OH, NH, NH₂, S, SH, and CH₂;
R³-R⁵ are each individually selected from the group consisting of H, halo, hydroxyl, cyano, thiol, amino, aryl, (C₁-C₆)alkyl, and (C₂-C₆)alkenyl, wherein each hydroxyl, thiol, amino, aryl, alkyl and alkenyl are optionally and independently substituted; and
R⁶ is selected from the group consisting of H, hydroxyl, (C₁-C₆)alkyl, (C₂-C₆)alkenyl and heterocycle, wherein each hydroxyl, alkyl, alkenyl and heterocycle are optionally substituted,
or a salt thereof.

9. The method claim 8, wherein the at least one compound or salt is a compound of formula Ia: 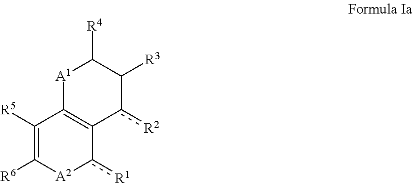
wherein,
A¹ and A² are each independently O, S, or NH;
R¹ and R² are each individually selected from the group consisting, of halo, CN, O, OH NH, NH₂, S, SH, and CH₂;
R²-R⁵ are each individually selected from the group consisting of H, halo, hydroxyl, cyano, thiol, amino, aryl, (C₁-C₆)alkyl, and (C₂-C₆)alkenyl, wherein each hydroxyl, thiol, amino, aryl, alkyl and alkenyl are optionally and independently substituted; and
R⁶ is selected from the group consisting of H, hydroxyl, (C₁-C₆)alkyl, (C₂-C₆)alkenyl and heterocycle, wherein each hydroxyl, alkyl alkenyl and heterocycle are optionally substituted.

10. The method of any one of claims 8-9, wherein the at least one compound or salt is selected from the group consisting of: 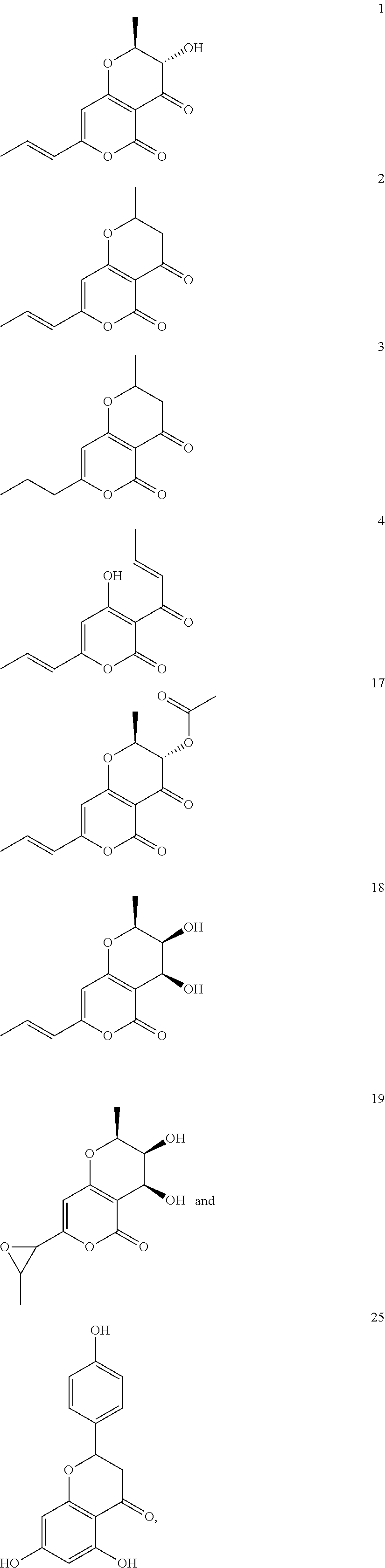
or a salt thereof.

11. The method of any one of claims 8-10, wherein the at least one compound or salt is radicinin (compound 1): 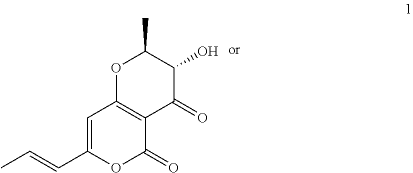 [SMILES: C/C=C/c1cc2c(c(=O)o1)C(=O)[C@@H](O)[C@H](C)O2]
deoxyradicinin (compound 2): 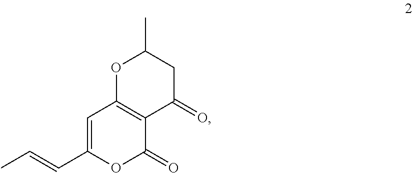 [SMILES: C/C=C/c1cc2c(c(=O)o1)C(=O)CC(C)O2]
or a salt thereof.

12. The method of any one of claims 8-10, wherein the at least one compound or salt is dihydrodeoxyradicinin (compound 3) or compound 4.

13. A method of inhibiting Candidatus Liberibacter asiaticus (CLas) growth in a plant, comprising introducing to the plant at least one microbial isolate(s) selected from the group consisting of Cladosporium cladosporioides, Epicoccum nigrum, Pantoea agglomerans, Pantoea vagans, Bacillus sp., Curtobacterium sp., Alternaria radicina and Cochliobolus sp., or an extract thereof.

14. A method of treating a Candidatus Liberibacter asiaticus (CLas) infection in a plant and/or treating Huanglongbing (HLB) in a plant, comprising introducing to the plant at least one microbial isolate(s) selected from the group consisting of Cladosporium cladosporioides, Epicoccum nigrum, Pantoea agglomerans, Pantoea vagans, Bacillus sp., Curtobacterium sp., Alternaria radicina and Cochliobolus sp., or an extract thereof.

15. The method of any one of claims 13-14, wherein the microbial isolate(s) is selected from a group consisting of Cladosporium cladosporioides, Epicoccum nigrum, Pantoea agglomerans, Pantoea vagans, Bacillus sp and Curtobacterium sp, or an extract thereof.

16. The method of any one of claims 13-14, wherein Cladosporium cladosporioides, or an extract thereof, is introduced to the plant.

17. The method of any one of claims 13-14, wherein Epicoccum nigrum, or an extract thereof, is introduced to the plant.

18. The method of any one of claims 13-14, wherein Pantoea agglomerans, or an extract thereof, is introduced to the plant.

19. The method of any one of claims 13-14, wherein Pantoea vagans, or an extract thereof, is introduced to the plant.

20. The method of any one of claims 13-14, wherein Alternaria radicina or Cochliobolus sp., or an extract thereof, is introduced to the plant.

21. The method of any one of claims 13-20, wherein the microbial isolate(s) is inactivated.

22. The method of any one of claims 13-21, wherein the microbial isolate(s), or an extract thereof, is present in a composition, and wherein the composition further comprises a carrier.

23. The method of claim 22, wherein an additional therapeutic agent is present in the composition.

24. The method of any one of claims 1-22, wherein the method further comprises introducing an additional therapeutic agent to the plant.

25. The method of claim 23 or 24, wherein the additional therapeutic agent is an antibiotic agent.

26. The method of any one of claims 1-25, wherein the plant is a citrus plant.

27. The method of claim 26, wherein the citrus plant is an orange tree.

28. A kit comprising:
1) at least one compound selected from the group consisting of: 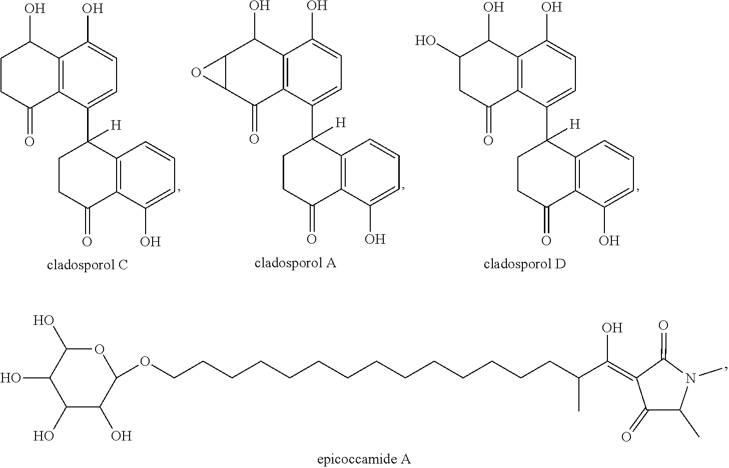 [SMILES: O=C1CCC(c2ccc(O)c3c2C(=O)CCC3O)c2cccc(O)c21 ; O=C1CCC(c2ccc(O)c3c2C(=O)C2OC2C3O)c2cccc(O)c21 ; O=C1CCC(c2ccc(O)c3c2C(=O)CC(O)C3O)c2cccc(O)c21 ; CC(CCCCCCCCCCCCCCOC1OC(O)C(O)C(O)C1O)/C(O)=C1\C(=O)C(C)N(C)C1=O]
and a compound of formula I,
or a salt thereof,
wherein the compound of formula I is: 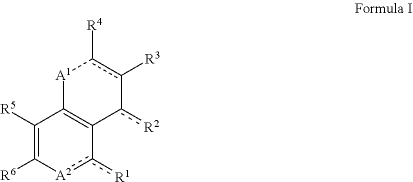
wherein,
A¹ is O, S, NH, OH, SH or NH₂;
A² is CH, O, S, or NH;
R¹ and R² are each individually selected from the group consisting of halo, CN, O, OH, NH, NH₂, S, SH, and CH₂;
R³-R⁵ are each individually selected from the group consisting of H, halo, hydroxyl, cyano, thiol, amino, aryl, (C₁-C₆)alkyl, and (C₂-C₆)alkenyl, wherein each hydroxyl, thiol, amino, aryl, alkyl and alkenyl are optionally and independently substituted; and
R⁶ is selected from the group consisting of H, hydroxyl, (C₁-C₆)alkyl, (C₂-C₆)alkenyl and heterocycle, wherein each hydroxyl, alkyl, alkenyl and heterocycle are optionally substituted;
2) packaging material; and
3) instructions to introduce to a plant the compound to treat a Candidatus Liberibacter asiaticus (CLas) infection in the plant or to treat Huanglongbing (HLB) in the plant.

29. A kit comprising:
1) a microbial isolate, or an extract thereof, wherein the microbial isolate comprises Cladosporium cladosporioides, Epicoccum nigrum, Pantoea agglomerans, Pantoea vagans, Bacillus sp., Curtobacterium sp., Alternaria radicina and/or Cochliobolus sp, or an extract thereof,
2) packaging material; and
3) instructions to introduce to a plant the microbial isolate/extract to treat a Candidatus Liberibacter asiaticus (CLas) infection in the plant or to treat Huanglongbing (HLB) in the plant.

30. A method of identifying an agent that inhibits Candidatus Liberibacter asiaticus (CLas), comprising:
1) culturing Liberibacter crescens bacteria;
2) contacting the cultured Liberibacter crescens bacteria with a test agent to provide a test culture sample, wherein the test agent is derived from a plant microbiome;
3) measuring the amount of Liberibacter crescens growth in the test culture sample;
4) identifying the test agent as inhibitory when the amount of Liberibacter crescens growth is less than the growth of a corresponding control Liberibacter crescens culture sample that was not contacted with the test agent.

31. The method of claim 30, wherein the culturing step comprises culturing Liberibacter crescens bacteria on an agar layer.

32. The method of claim 30, wherein a test agent is loaded on an overlayer and the contacting step comprises placing the overlayer above the agar layer.

33. The method of any one of claims 30-32, wherein the plant microbiome is derived from a citrus tree.

34. The method of any one of claims 30-33, wherein the plant microbiome is derived from a citrus tree infected with CLas.

35. A method of preparing compound 16, comprising: converting 2,2,6-trimethyl-4H-1,3-dioxin-4-one (compound 7) to 2,2-dimethyl-6-[(3E)-2-oxopent-3-en-1-yl]-2,4-dihydro-1,3-dioxin-4-one (compound 16) in a one-step reaction.

36. The method of claim 35, wherein the one-step reaction is C-acylation of compound 7 or a metal enolate of compound 7.

37. The method of claim 36, wherein the metal enolate of compound 7 is lithium enolate of compound 7 or zinc enolate of compound 7.

38. The method of any one of claims 36-37, wherein the converting comprises reacting compound 7 or the metal enolate of compound 7 with a C₄ alkenoyl (CH₃CHCHC(═O)) donor compound.

39. The method of claim 38, wherein the C₄ alkenoyl (CH₃CHCHC(═O)) donor compound is (E)-1-(1H-benzo[d][1,2,3]triazol-1-yl)but-2-en-1-one (compound 6).

40. The method of any one of claims 35-39, wherein the converting proceeds in the presence of lithium.

41. The method of any one of claims 35-40, wherein the converting proceeds in the presence of lithium bis(trimethylsilyl)amide (LiHMDS).

42. The method of any one of claims 35-41, wherein the converting proceeds in the presence of zinc.

43. The method of any one of claims 35-42, wherein the converting proceeds in the presence of alkylzinc.

44. The method of claim 43, wherein the alkylzinc is dimethylzinc or diethylzinc.

45. The method of any one of claims 35-44, further comprising:
(b) converting compound 16 to (E)-4-hydroxy-6-(prop-1-en-1-yl)-2H-pyran-2-one (compound 5) and,
(c) converting compound 5 to deoxyradicinin (compound 2).

46. The method of claim 45, wherein step (b) proceeds in a non-polar solvent (e.g., toluene) under reflux.

47. The method of any one of claims 45-46, wherein step (c) comprises reacting compound 5 with a C₄ alkenoyl (CH₃CHCHC(═O)) donor compound.

48. The method of claim 47, wherein the C₄ alkenoyl (CH₃CHCHC(═O)) donor compound is crotonic acid or a crotonoyl halide.

49. A compound of formula (4): 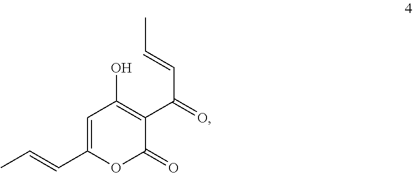 [SMILES: C/C=C/C(=O)c1c(O)cc(/C=C/C)oc1=O]
or a salt thereof.
